(19) United States
(12) Patent Application Publication
(10) Pub. No.: US 2017/0066962 A1
(43) Pub. Date: Mar. 9, 2017

(54) PROPPANT BEAD FORMING METHODS

(71) Applicants: CALIFORNIA INSTITUTE OF TECHNOLOGY, Pasadena, CA (US); STATOIL GULF SERVICES, LLC, Houston, TX (US)

(72) Inventors: Vilupanur A. Ravi, Claremont, CA (US); Samad A. Firdosy, La Crescenta, CA (US); Sabah K. Bux, Chino Hills, CA (US); Jean-Pierre Fleurial, Altadena, CA (US); Shiao-Pin S. Yen, Monterey Park, CA (US); Andrew Kindler, San Marino, CA (US); Su C. Chi, Pasadena, CA (US); Margie L. Homer, Pasadena, CA (US); Bryan W. McEnerney, Pasadena, CA (US); Pandurang Kulkarni, Houston, TX (US); Desikan Sundararajan, Houston, TX (US)

(21) Appl. No.: 15/261,764

(22) Filed: Sep. 9, 2016

Related U.S. Application Data
(60) Provisional application No. 62/216,223, filed on Sep. 9, 2015.
(60) Provisional application No. 62/220,027, filed on Sep. 17, 2015.

(51) Int. Cl. C09K 8/80; B01J 2/00; B01J 2/04; B28B 11/24

(52) U.S. Cl. CPC C09K 8/80; C09K 8/805; B28B 11/24; B01J 2/003; B01J 2/04

(57) ABSTRACT

The disclosure herein includes methods of preparing ceramic beads, useful as proppant materials, by mixing ceramic precursors, such as slag, fly ash, or aluminum dross, forming bead precursors from the mixture, and heating the bead precursors to drive a chemical reaction between the ceramic precursors to form the ceramic beads. The resultant ceramic beads may be generally spherical particles that are characterized by diameters of about 0.1 to 2 mm, a diametral strength of at least about 100 MPa, and a specific gravity of about 1.0 to 3.0. A coating process may optionally be used to increase a diametral strength of a proppant material. A sieving process may optionally be used to obtain a smaller range of sizes of proppant materials.

### CROSS-REFERENCES TO RELATED APPLICATIONS

This application claims the benefit of and priority to U.S. Provisional Application No. 62/216,223, filed on Sep. 9, 2015 and U.S. Provisional Application No. 62/220,027, filed Sep. 17, 2015, which are hereby incorporated in their entireties for all purposes. U.S. application Ser. No. 14/712,888, filed on May 14, 2015, and U.S. Provisional Application No. 61/993,187, filed on May 14, 2014, are also hereby incorporated in their entireties for all purposes.

### STATEMENT AS TO RIGHTS TO INVENTIONS MADE UNDER FEDERALLY SPONSORED RESEARCH OR DEVELOPMENT

The invention described herein was made in the performance of work under a NASA contract, and is subject to the provisions of Public Law 96-517 (35 U.S.C. §202) in which the Contractor has elected to retain title.

### BACKGROUND

Induced hydraulic fracturing is a technique used to release oil and natural gas by creating and maintaining open fractures from a wellbore drilled into reservoir rock formations. A hydraulically pressurized liquid (i.e., a “fracking fluid”) comprising water, chemicals, and a particulate proppant material is injected into the wellbore to create cracks in the deep-rock formations through which oil and natural gas can flow more freely. When the hydraulic pressure is removed from the well, the proppant material prevents the induced fractures from closing.

The physical characteristics of the proppant material (e.g., particle size, particle size distribution, specific gravity, surface friction, strength, etc.) have a significant impact on hydraulic fracturing operations and hydrocarbon recovery. Currently available proppants comprised of sand, ceramic, glass, or sintered bauxite are significantly denser than the fracking fluid. This results in non-optimal distributions of the proppant particles within the well. Moreover, existing proppants demonstrate a degraded performance over time due to the production of “fines” (crushed fine particulates). The fines settle after removal of the fracking fluids, and greatly reduce permeability to oil and natural gas.

What is needed are proppant materials, and methods of preparing proppant materials, having a low density close to that of water while maintaining a high strength to withstand closure stresses, thereby resulting in increased oil and natural gas well productivity. Surprisingly, the present invention meets this and other needs.

### SUMMARY

In some embodiments, described are methods of preparing a proppant material. For example, in some embodiments, a method includes heating a reaction mixture comprising a plurality of oxides. The reaction mixture is heated in a reactive atmosphere to a temperature above the melting point of the reaction mixture to form a melt. The melt is allowed to solidify in a mold, the solidified melt being in the form of spherical particles characterized by a specific gravity of about 1.5 to 3.0 and a diametral strength of at least about 10,000 psi.

In some embodiments, described are methods of preparing a proppant material. For example, in some embodiments, a method including heating a reaction mixture comprising a plurality of oxides and one or more additives. The reaction mixture is heated in a reactive atmosphere to a temperature below the melting point of the reaction mixture to form a powder comprising one or more reaction products. The powder is processed to form spherical particles characterized by a specific gravity of about 1.0 to 1.7 and a diametral strength of at least about 10,000 psi.

In some embodiments, described are proppant materials. The proppant material may include spherical particles comprising a material selected from oxides, nitrides, oxynitrides, borides, and carbides. The spherical particles are characterized by a specific gravity of about 1.0 to 3.0 and a diametral strength of at least about 10,000 psi.

In some embodiments, described are proppant materials prepared by a method including heating a reaction mixture comprising a plurality of oxides. The reaction mixture is heated in a reactive atmosphere to a temperature above the melting point of the reaction mixture to form a melt. The melt is allowed to solidify in a mold, the solidified melt being in the form of spherical particles comprising one or more of the plurality of oxides, the spherical particles being characterized by a specific gravity of about 1.5 to 3.0 and a diametral strength of at least about 10,000 psi.

In some embodiments, described are proppants material prepared by a method, such as a method that includes heating a reaction mixture comprising a plurality of oxides and one or more additives. The reaction mixture is heated in a reactive atmosphere to a temperature below the melting point of the reaction mixture to form a powder comprising one or more reaction products. The powder is processed to form spherical particles comprising an oxide, nitride, oxynitride, boride, or carbide, the spherical particles being characterized by a specific gravity of about 1.0 to 1.7 and a diametral strength of at least about 10,000 psi.

In some embodiments, provided are ceramic beads, which may be formed by a method comprising mixing a plurality of ceramic precursors to form a mixture comprising particles of the ceramic precursors, such as particles having sizes of about 30 μm to about 500 forming a plurality of bead precursors each comprising the mixture, such as where the bead precursors each have cross-sectional dimensions of about 0.1 mm to about 2.5 mm; and heating the bead precursors to an elevated temperature sufficient to initiate a chemical reaction between the ceramic precursors, such as a chemical reaction that transforms the bead precursors into the ceramic beads. Optionally, the ceramic precursors include two or more of fly ash, slag, carbon black, pumice, and aluminum dross. Optionally, heating raises a temperature of the bead precursors to a temperature greater than about 1200° C. Optionally, the ceramic beads are each characterized by one or more of a diameter of about 0.03 mm to about 2.0 mm, a diametral strength greater than about 100 MPa, and a specific gravity of about 1.0 to about 3.0. In some embodiments, the ceramic beads comprise or are useful as a proppant material.

### BRIEF DESCRIPTION OF THE DRAWINGS

FIG. 1A shows an optical photograph of a spherical particle comprising 80% (w/w) air-cooled slag and 20% (w/w) fly ash with low CaO concentrations (“low-Ca fly ash”). The spherical particle was formed via direct melt processing using RF heating. FIG. 1B shows x-ray diffraction (XRD) data for the imaged particle.

FIG. 2A shows X-ray fluorescence (XRF) elemental analysis, FIG. 2B shows calculated oxide compositions, FIG. 2C shows XRD data, and FIG. 2D shows an optical photograph, for air-cooled metallurgical slag samples.

FIG. 3A shows XRF elemental analysis, FIG. 3B shows calculated oxide compositions, FIG. 3C shows XRD data, and FIG. 3D shows an optical photograph, for pelletized metallurgical slag samples.

FIG. 4A shows XRF elemental analysis, FIG. 4B shows calculated oxide compositions, FIG. 4C shows XRD data, and FIG. 4D shows an optical photograph, for granulated metallurgical slag samples.

FIG. 5A shows XRF elemental analysis, FIG. 5B shows calculated oxide compositions, FIG. 5C shows XRD data, and FIG. 5D shows an optical photograph, for low-Ca fly ash samples.

FIG. 6 shows a plot of predicted crush strength as a function of specific gravity for a number of non-limiting examples of proppant materials that can be formed according to some embodiments, including Si_{6-z}Al_{z}O_{z}N_{8-z}, Si₃N₄, YSZ, MgB₂, and a glass silicate ceramic. The calculations used to generate the crush strength values in FIG. 6 assume: (i) a 0.74 packing factor with 12 contact points for each particle; (ii) Poisson's ratio being maintained for all porosities; (iii) reference volumes fixed at 160 mm³; and (iv) a proppant radius of 0.292 mm, and the following formula was used:

$$P = {\{ \frac{4.46 {( 2.150 {v}_{0} )}^{α}}{( 1 - 2 v )} \frac{{σ}_{0}}{β} {( \frac{( 1 - {v}^{2} )}{E} )}^{\frac{2 - 3 α}{3}} \frac{1}{{r}^{3 α}} \}}^{\frac{3}{1 + 3 α}} ,$$

where P=stress at which proppant fractures, Vₒ=reference volume, ν=Poisson's ratio, E=Young's modulus, σ₀=flexural strength, and r=proppant radius.

FIG. 7 shows a plot of specific gravity as a function of porosity for the Si_{6-z}Al_{z}O_{z}N_{8-z}, Si₃N₄, YSZ, and MgB₂ materials shown in FIG. 6.

FIG. 8A and FIG. 8B show exemplary powder samples before and after melting. FIG. 8A shows a graphite crucible (i.e., a mold) with round bottom holes in which powders are loaded before melting, and FIG. 8B shows spherical particles (i.e., beads) in the graphite crucible holes after melting.

FIG. 9A, FIG. 9B, FIG. 9C, FIG. 9D, FIG. 9E, and FIG. 9F show exemplary molten beads. FIG. 9A shows an optical photograph of a single molten bead comprising 80% (w/w) air-cooled slag and 20% (w/w) low-Ca fly ash, FIG. 9B shows an scanning electron micrograph (SEM) cross-sectional image of the molten bead, and FIG. 9C shows a close-up SEM cross-sectional image of the molten bead. FIGS. 9D-9E show optical photographs of molten beads comprising 100% (w/w) pelletized slag, and FIG. 9F shows a cross-sectional SEM image of a molten bead comprising 100% (w/w) pelletized slag.

FIG. 10 shows a table of spherical bead compositions, diameters, and strength measurements for the tested samples formed from waste stream materials. Commercially available silica, ceramic, and glass proppants were also tested, and the resulting data for these materials is shown in FIG. 10 for purposes of comparison.

FIG. 11A shows an optical photograph of a hollow spherical bead comprising 95% (w/w) air-cooled slag and 5% (w/w) low-Ca fly ash, and FIG. 11B shows a cross-sectional SEM image of the same hollow spherical bead.

FIG. 12 shows optical photographs of beads comprising Si_{6-z}Al_{z}O_{z}N_{8-z} precursors formed by vacuum drying and templating.

FIG. 13A, FIG. 13B, and FIG. 13C show optical photographs of beads comprising Si_{6-z}Al_{z}O_{z}N_{8-z} precursors formed by controlled thermal treatments and templating.

FIG. 14A, FIG. 14B and FIG. 14C show optical photographs of beads comprising Si_{6-z}Al_{z}O_{z}N_{8-z} formed by annealing and templating.

FIG. 15A and FIG. 15B show optical photographs of beads comprising Si_{6-z}Al_{z}O_{z}N_{8-z} formed by rapid freezing in liquid nitrogen.

FIG. 16A shows a hot press profile used to form a proppant material comprising MgSiN₂ from a mixture of low-Ca fly ash (containing SiO₂) and Mg₃N₂. FIG. 16B shows XRD data indicating the presence of MgSiN₂ in the formed material.

FIG. 17 shows a schematic illustration of the structure of orthorhombic Mg(Ca)SiN₂ with infinite corner sharing SiN₄ and MgN₄ tetrahedra.

FIG. 18 shows a flow diagram for synthesis of alkaline/alkali nitride precursors using gaseous nitrogen.

FIG. 19 shows a process flow diagram of Alkaline Earth silicon nitrides via solid state metathesis reactions.

FIG. 20A shows powder XRD data for reactions reaction between SiO₂ and Mg₃N₂ and

FIG. 20B shows powder XRD data for reactions reaction between SiO₂ and Ca₃N₂. The oxide salts are indexed.

FIG. 21A shows XRD data for oxy-hydrogen flame initiation of SiO₂ and Mg₃N₂ and FIG. 21B shows XRD data for oxy-hydrogen flame initiation of SiO₂ and Ca₃N₂, indicating that both reactions yielded the desired AE silicon nitride product. The desired AE silicon nitrides are indexed.

FIG. 22A shows XRD for RF initiation reactions of SiO₂ and Mg₃N₂ and FIG. 22B shows XRD for RF initiation reactions of SiO₂ and Ca₃N₂, indicating that the AESiN₂ products were successfully synthesized.

FIG. 23A shows stacked diffraction patterns of reactions at 1400° C., 1600° C., 1800° C. showing the increase in the secondary phase MgSiO₄ at temperatures above 1400° C.

FIG. 23B shows powder XRD pattern of reaction initiated at 1400° C., relatively single phase MgSiN₂ was obtained.

FIG. 24 shows a flow diagram for the synthesis of AE silicon nitrides using waste stream precursors.

FIG. 25 shows a comparison of pumice starting material and pumice based product from reaction with Mg₃N₂ indicating that the waste stream has been transformed.

FIG. 26 shows XRD of pumice waste stream product indicating that the desired MgSiN₂ was obtained as well as some iron silicide impurities.

FIG. 27 shows XRD of MgSiN₂ reaction with Slag with Si added as an internal reference, indicating that the reaction did not result in the formation of MgSiN₂.

FIG. 28 shows XRD of MgSiN₂ synthesized from fly ash. Products include MgSiN₂, AlN and NaSi₂N₃. Si was added as an internal standard.

FIG. 29 shows XRD of CaCO₃ product, where mainly silicates are identified.

FIG. 30 shows XRD diffraction pattern for reaction labeled CaCN₂ PM1-2C. The product has some CaSiN₂ product and as well as some Ca—Si—O—N

FIG. 31A shows a process flow diagram for SiAlON synthesis using high purity reagent-grade oxide reactants.

FIG. 31B shows photographs of a mixture of SiAlON precursors before reaction (left) and formed SiAlON after reaction (right).

FIG. 31C shows electron micrograph images of different batches of SiAlON powder.

FIG. 32A and FIG. 32B shows powder XRD of SiAlON for two different reaction products, indicating some evidence of SiAlON, AlN and Si₃N₄.

FIG. 33 shows a process flow diagram for SiAlON synthesis via waste streams.

FIG. 34 shows XRD of Boral low Ca fly ash, indicating that the main crystalline phases are SiO₂ and mullite (SiO₂:Al2O₃ solid solution). Other impurities may exist and may not be crystalline.

FIG. 35A shows XRD for a fly ash synthesized SiAlON reacted for 8 hours and FIG. 35B shows XRD for a fly ash synthesized SiAlON reacted for 2 hours. Silicon was added as an internal standard.

FIG. 36 shows XRD of pumice, indicating a composition of mainly SiO₂ and mica silicate.

FIG. 37A shows XRD providing a comparison of waste stream product with pumice precursor and FIG. 37B shows XRD data for SiAlON synthesized from waste stream.

FIG. 38 shows XRD for slag, indicating that no crystalline phases are discernable.

FIG. 39 shows XRD of product produced from slag, with Si added as an internal reference.

FIG. 40 shows XRD data for the product of the reaction identified as JPLSiAlON6-1. The main product are silicates, Ca—SiAlON, and Si₃N₄, AlN.

FIG. 41 shows XRD data for the product of the reaction identified as JPLSiAlON7-1 using waste stream materials and indicating successful formation of SiAlON product.

FIG. 42 shows a photograph of fine granulated and sieved slag (left) and coarse granulated material left behind after sieving (right).

FIG. 43 shows a schematic overview of the formation of hollow spheres via walnut shell scaffolds.

FIG. 44 shows thermogravimetric analysis (TGA)/differential thermal analysis (DTA) of bare walnut shells in Ar, indicating a large mass loss (70%) at 300° C., an endothermic event at 500° C., and an exothermic event at 600° C.

FIG. 45 shows a sample TGA/DTA of fly ash/alumina coated walnut shell using methyl cellulose binder.

FIG. 46 shows photographs of coated walnut shells at 25° C. (left) and 300° C. (right),

FIG. 47 shows a macro photograph sequence showing pre-treated walnut shells, ceramic coated walnut shells, single coated walnut shell particle after firing at 1450° C., fractured single coated walnut shell bead showing walnut shell core particle.

FIG. 48 shows a schematic illustration of the creation of beads in a freeze drying process.

FIG. 49A, FIG. 49B, and FIG. 49C show photographs of beads at different stages of production through the freeze drying process; FIG. 49A shows polymer spheres after 24 hours in vacuum oven; FIG. 49B shows beads after annealing at 350° C. for 30 min; FIG. 49C shows beads after annealing at 1750° C. for 30 min.

FIG. 50 shows a schematic overview of a spray drying process.

FIG. 51 shows a micrograph of as-spray dried Al₂O₃-fly-ash-carbon black material.

FIG. 52 shows micrographs of as-spray dried Al₂O₃—SiO₂ at various magnifications.

FIG. 53 shows higher magnification micrographs of as-spray dried Al2O₃—SiO₂ showing green bead porosity and some low level of agglomeration.

FIG. 54 shows macro photographs of 99/5 beads with distributed pores (left) and hollow pore (right).

FIG. 55 shows cross-section micrographs of 99/5 beads with distributed pores (left) and hollow pore (right).

FIG. 56 shows macro photographs of un-coated (top) and phenolic coated (bottom) melt beads.

FIG. 57 shows macro photographs providing a comparison of pelletized slag/SiAlON composite beads for various slag to SiAlON ratios ranging from 100% pelletized slag to 25 wt. % slag/75 wt. % SiAlON.

FIG. 58 shows an optical microscopy comparison of pelletized slag/SiAlON composite beads for various slag to SiAlON ratios ranging from 100% pelletized slag to 50 wt. % slag/50 wt. % SiAlON.

FIG. 59 shows scanning electron images showing various slag/SiAlON ratios from pure pelletized slag to 50 wt. % slag/50 wt. % SiAlON.

FIG. 60 shows macro images providing a comparison of pelletized slag and 80-20 slag to Al Dross beads.

FIG. 61 shows a schematic illustration of a plasma spheroidization process.

FIG. 62 shows macro images of granulated slag beads post spheroidization.

FIG. 63 shows a macro image of a granulated and sintered bead and FIG. 64 shows an XRD diffractogram indicating presence of Ca—SiAlON.

FIG. 65 shows diametral strength data for various bead compositions and bead diameters.

FIG. 66 shows a macro image comparison of 95/5 beads (A.C. slag/Low CaO fly ash), commercial silica sand, and Econoprop.

FIG. 67 shows a macro image comparison of ceramic beads of different densities.

FIG. 68 shows scanning electron images of bead cross-sections showing commercial ceramic proppant, 95-5 air cooled slag to fly ash ratio melt bead, 80-20 air cooled slag to fly ash ratio melt bead, and pelletized slag melt bead.

FIG. 69 shows XRF results pre- and post-acid dissolution testing for SiAlON, Carbo Econoprop and glass beads.

### DETAILED DESCRIPTION

### I. General

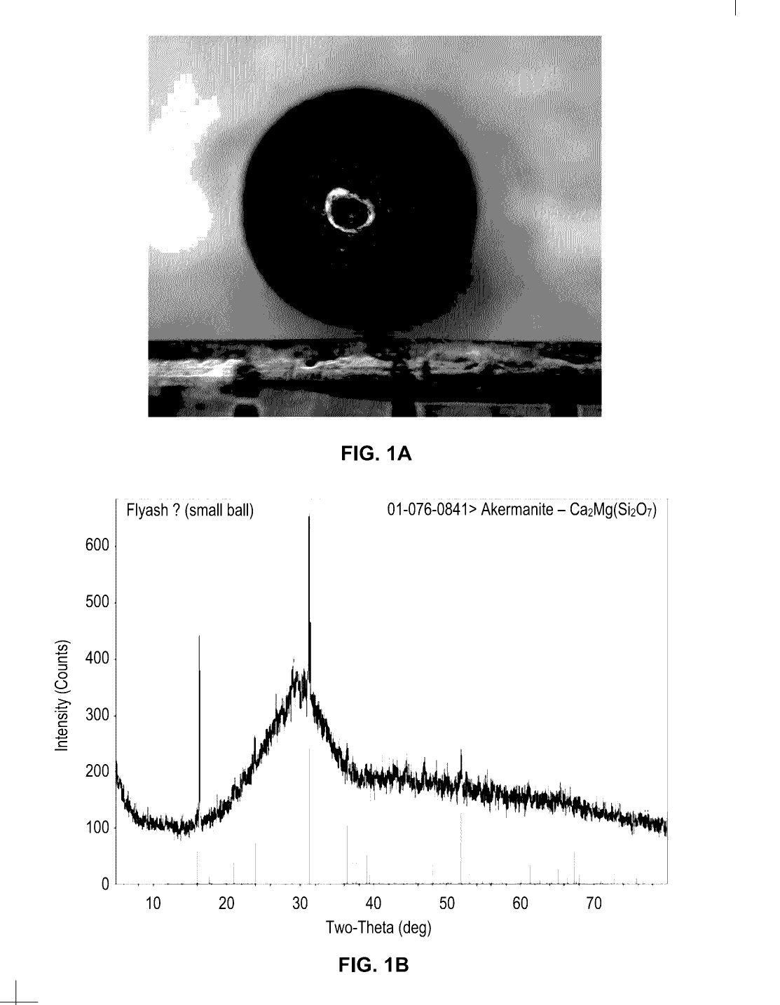

Described herein are proppant materials, and methods of preparing proppant materials, including ultra-strong and ultra-light proppants. The proppant materials of some embodiments can be in the form of spherical particles (i.e., beads) as shown in FIG. 1A, and can have a density close to that of water, thereby promoting optimal distribution and localization of proppant particles in hydraulic fractures. Despite the low density, the proppant materials retain a very high diametral strength which inhibits the formation of fines that adversely impact oil and gas permeability.

A variety of techniques may be used for forming the proppant materials, including melting techniques, spraying techniques, granulation techniques, coating techniques, and templating techniques, for example. The techniques useful with aspects of the some embodiments may utilize common chemistries for creation of the resultant proppant materials. The useful chemistries may include forming ceramic materials from a variety of starting materials, such as ceramic precursors, in which the resultant ceramic material exhibits a surface tension when molten sufficient for the molten material to obtain in a spherical or roughly spherical shape. Heating processes, including melting, annealing, or sintering processes, may drive the formation, reaction, and/or densification of the ceramic precursors into the resultant ceramic material. In some embodiments, the reaction between ceramic precursors may be exothermic and the reaction may be self-propagating, following an initiation step in which the temperature of the precursor materials is elevated to or above an initiation temperature.

Moreover, the proppant materials of some embodiments can be prepared using readily available, low cost, and high volume waste stream materials such as metallurgical slag and fly ash. The use of such waste stream sources not only reduces the cost of manufacturing the proppants, it also provides the benefit of recycling the undesirable waste products that presently have utility in only a small number of niche applications.

For example, the claimed techniques may advantageously make use of waste stream materials that otherwise find limited use and may otherwise be destined for a landfill. In some embodiments, multiple ceramic precursors or additives may be obtained and used from different waste streams or may be obtained and used in pure or refined forms if no suitable waste stream source is available. For example, if carbon or silicon dioxide is not readily available from a waste stream source, pure or refined carbon or silicon dioxide may be used to supplement other waste stream ceramic precursors if carbon or silicon dioxide is needed for generation of a desired ceramic.

In some embodiments, the desired ceramic is SiAlON, for example, which may be useful for obtaining desired characteristics for the proppant materials, as this material exhibits high strength and low density compared to other commercial proppant materials. Formation of beads of this particular composition may be achieved using pure waste streams or using waste streams in tandem with some refined components to provide an overall suitable chemical composition.

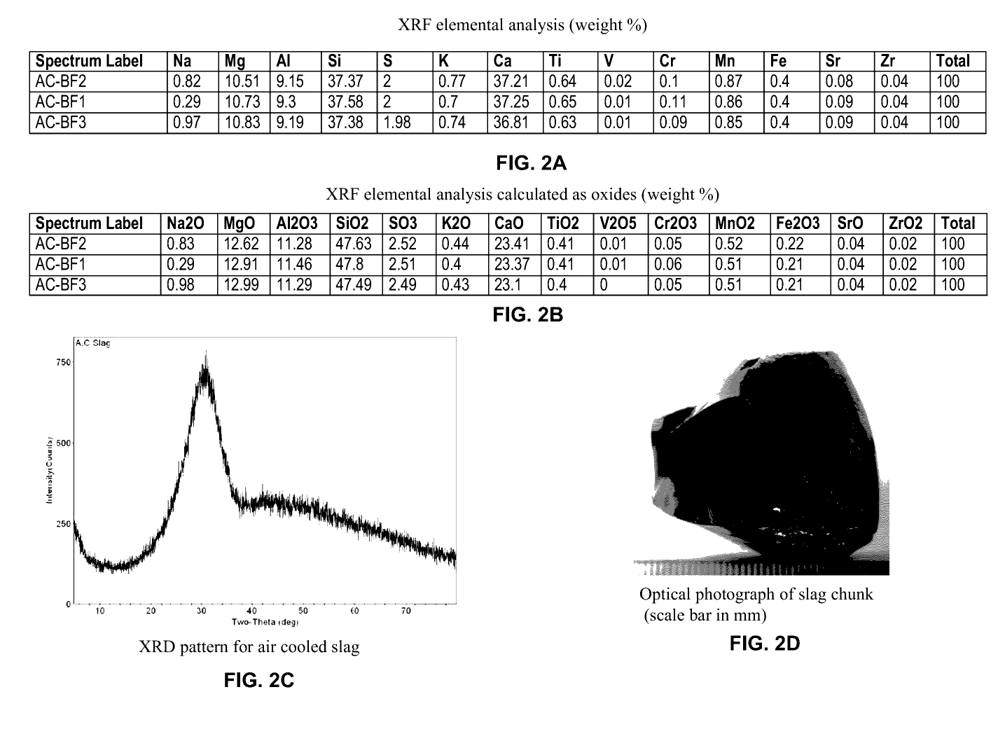

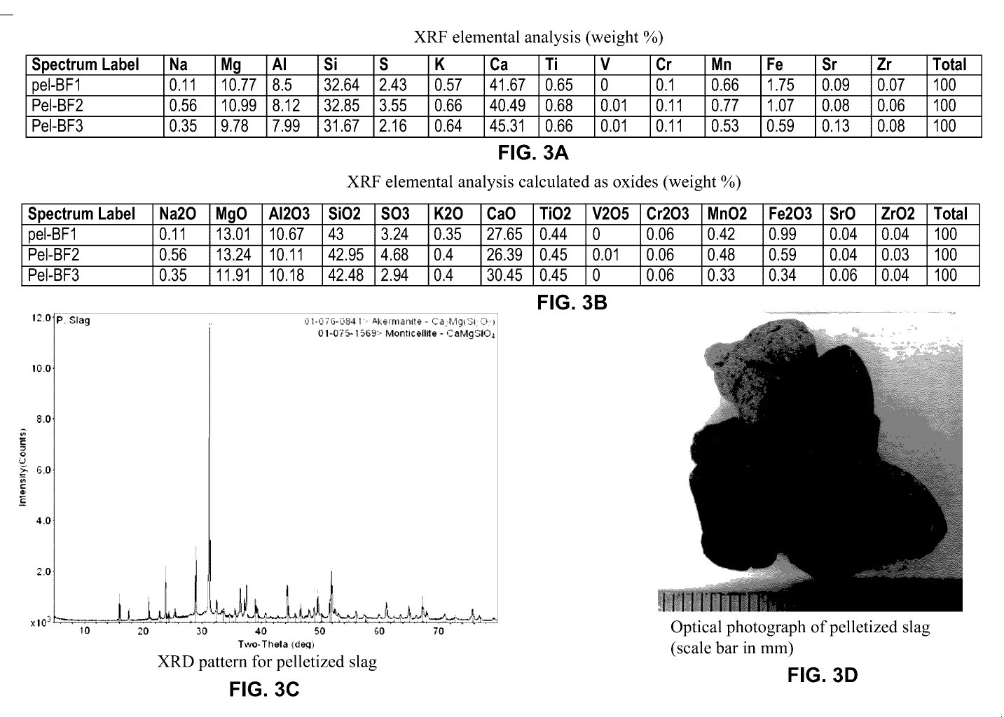

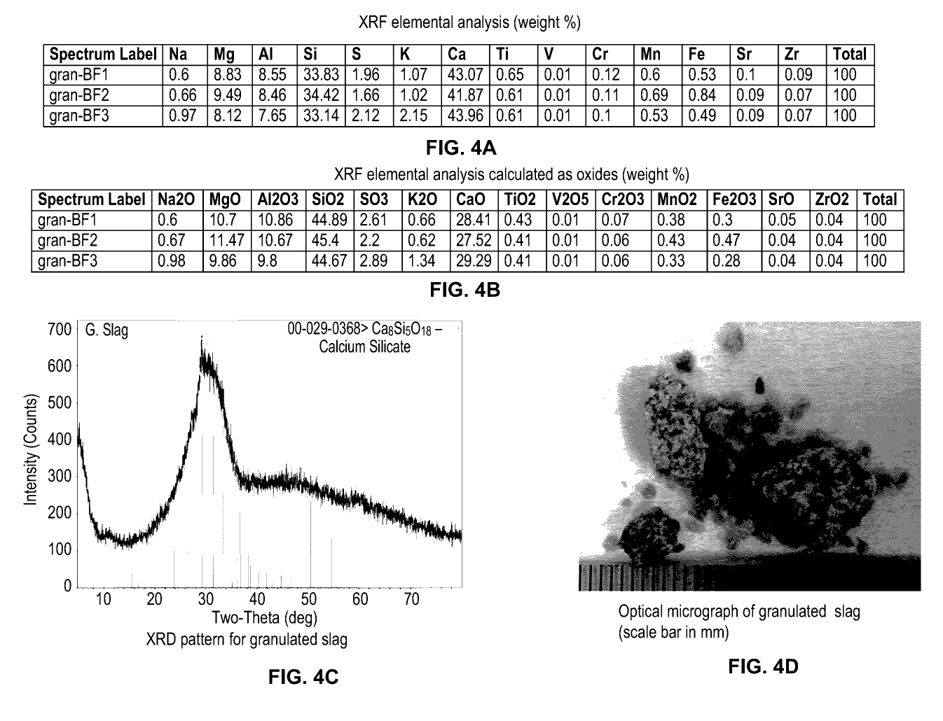

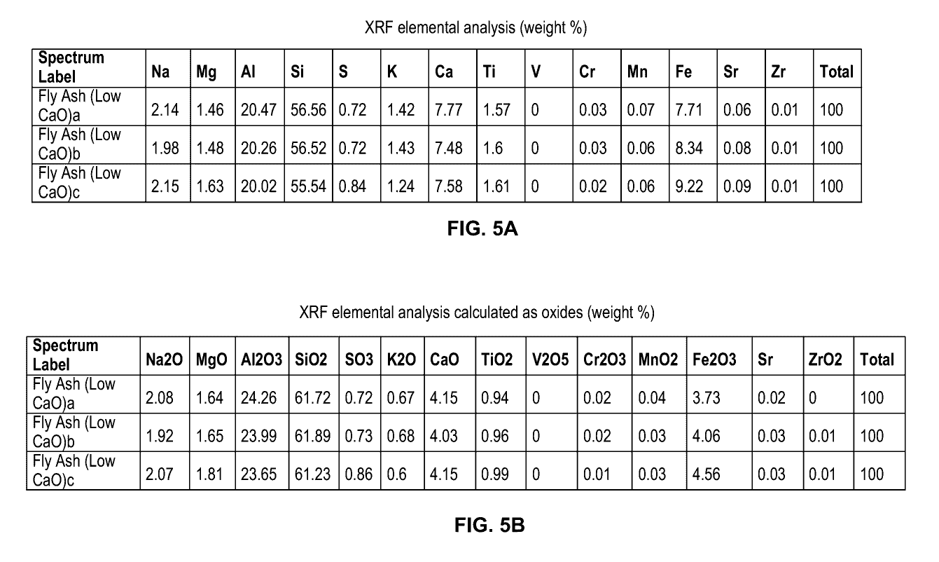

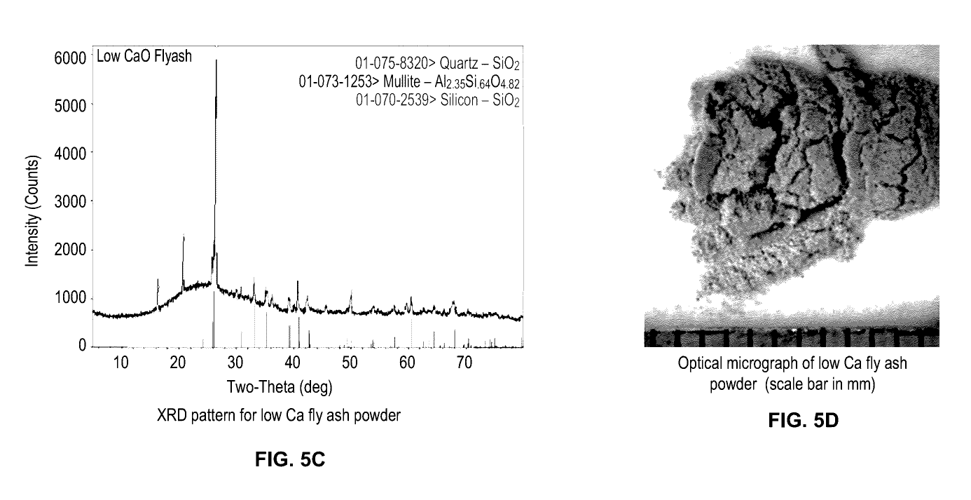

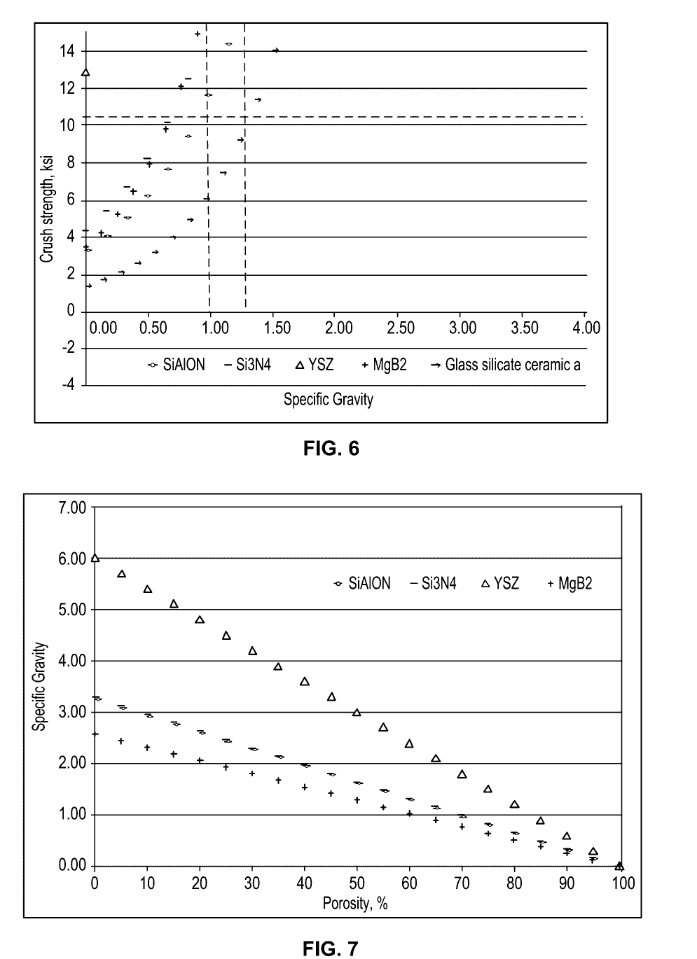

As shown in FIGS. 2A-5D, waste stream materials such as metallurgical slag and fly ash can contain a number of different oxide materials in different concentrations. The proppant materials of some embodiments can be formed by direct melt processing of a reaction mixture comprising oxide-rich waste stream material in a reactive atmosphere such as nitrogen. In such methods, the mixture can be melted and then solidified in the form the spherical proppant material using a mold. This can be a low cost, rapid, and streamlined approach to forming proppant materials having high strength and low density.

In some embodiments, the resulting proppant material phases can be formed by way of reaction product initiation. In such methods, the reaction mixture can include one or more precursor additives, with the combination of additives and oxide-rich waste stream material being heated in a reactive atmosphere to form a bulk powder comprising reaction products such as nitrides, oxynitrides, borides, carbides, and the like. Ratios of selected waste stream sources and additives can be adjusted to produce targeted reaction products. These engineered powder materials can then be processed by melting, hot pressing, sintering, etching, spraying, templating, etc., to form spherical proppant particles having a desired composition, specific gravity, crush strength, diametral strength, porosity, and morphology.

In some embodiments, the reaction initiation process may take the form of a multiple step initiation process in which a first reaction is initiated to form intermediate precursors from initial precursors. Such a technique may be advantageous when starting precursors may react in unexpected or undesired ways if placed under the final reaction conditions without an initial processing under different reaction conditions and/or addition of particular precursors after the initial processing. For example, in some embodiments, one or more nitrides may be initially formed in a first reaction process and the nitrides may react with other precursor materials and/or one another, in a second reaction process to form the desired reaction product.

In addition to forming ceramic proppant materials, the present application also provides techniques for increasing the strength of proppant materials, such as by one or more coating processes. The coating processes may significantly increase a diametral strength by a factor of 2 or more or 3 or more, in some embodiments, as compared to uncoated proppant material.

### II. Definitions

“Proppant material” refers to a material suitable for keeping an induced hydraulic fracture open during or following a fracturing treatment. In some embodiments, proppant material takes the form of small beads spherical or roughly spherical in shape.

“Bead” refers to a small object that may be spherical in or roughly spherical shape. For example, beads may be spherical and may have diameters as small as or smaller than 0.03 mm and as large as or larger than 2.0 mm. For example, beads may exhibit a sphericity of between 0.5 and 1.0. In some embodiments, beads may include a hollow core. In some embodiments, beads may be porous.

“Bead precursor” refers to an object or collection of material used to form a bead. In some embodiments, bead precursors may be exposed to reactive conditions, such as elevated temperature conditions, to initiate a chemical reaction between components of the bead precursor to form a bead. In some embodiments, a bead precursor may be composed of an amount of precursor material that is used to form a bead. In some embodiments, a bead precursor may itself correspond to a small object that may be spherical or roughly spherical in shape.

“Ceramic” refers to an inorganic solid structure of metal and nonmetal atoms in a crystalline, semi-crystalline, or amorphous configuration. Ceramics useful with some embodiments include, but are not limited to, oxide ceramics, nitride ceramics, oxynitride ceramics, and SiAlON ceramics. “Ceramic precursor” refers to a material used in tandem with other materials to form a ceramic upon completion of a chemical reaction between the materials.

“Green body” refers to an object that is composed of ceramic precursors that have not yet reacted with one another or that has not been sintered or annealed to react and/or densify the ceramic precursors into a ceramic material.

“Waste stream material” refers to a material that is a waste produced by industrial activity of factories, mills, power plants, and the like. Waste stream materials useful in some embodiments include, but are not limited to, metallurgical slag such as air-cooled slag, pelletized slag, and granulated slag, and fly ash. “Metallurgical slag” refers to a glass-like by-product left over from smelting a desired metal from its raw ore. “Fly ash” refers to fine residual particles generated in the combustion of materials such as coal.

“Oxide” refers to a chemical compound that contains at least one oxygen atom and one other element. Oxides useful in some embodiments include, but are not limited to, SiO₂, Al₂O₃, Fe₂O₃, FeO, Fe₃O₄, CaO, MgO, MnO₂, MnO, Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, yttria-stabilized zirconia (YSZ), and CaCO₃. Some or all of these oxides can be present in various ratios in metallurgical slag and fly ash.

“Nitride” refers to a chemical compound that contains at least one nitrogen atom and one other element. Nitrides useful in some embodiments include, but are not limited to, Li₂SiN₂, CaSiN₂, MgSiN₂, and Si₃N₄.

“Oxynitride” refers to a chemical compound that contains at least one oxygen atom, one nitrogen atom, and one other element. Oxynitrides useful in some embodiments include, but are not limited to, Si_{6-z}Al_{z}O_{z}N_{8-z} where 0<z<5.

“Boride” refers to a chemical compound that contains at least one boron atom and one other less electronegative element. Borides useful in some embodiments include, but are not limited to, MgB₂.

“Carbide” refers to a chemical compound that contains at least one carbon atom and one other less electronegative element. Carbides useful in some embodiments include, but are not limited to, SiC.

“Binder” refers to a material or composition that is used to hold other materials together to form a cohesive structure. Binders useful with some embodiments include, but are not limited to, silicate binders, polymer binder, and resin-based binders.

“Additive” refers to a substance that is added. Additives useful in some embodiments include, but are not limited to, C, Al, Si, Mg, K, Fe, Na, B, O, N, ZrO₂, Y₂O₃, and compounds thereof, volcanic ash, and aluminum dross. “Volcanic ash” refers to particles of pulverized rock, minerals, and volcanic glass created during volcanic eruptions. “Aluminum dross” refers to a by-product of the aluminum smelting process, and typically contains Al₂O₃, residual Al metal, and other species.

“Reactive atmosphere” refers to a gas including one or more reactive elements, molecules, or ions. Reactive atmospheres useful in some embodiments include, but are not limited to, N₂, O₂, air, CO₂, and combinations thereof.

“Sintering” refers to a process in which a solid is exposed to heat and/or pressure, such as to join or densify particles of the solid, to crystallize particles of the solid, or to alloy elements of the solid without melting the solid. Example sintering conditions include exposing the solid to a temperature of about 1200° C. or more.

“Annealing” refers to a process in which a solid is exposed to heat in order to reduce or eliminate crystal defects in the solid without melting the solid. Example annealing conditions include exposing the solid to a temperature of about 300° C. or more, 500° C. or more, 1200° C. or more, or even higher temperatures. In some embodiments, annealing conditions may include temperatures elevated beyond ambient but less than a melting temperature of a particular material that is being annealed, such as a ceramic.

“Etchant” refers to a corrosive substance used to dissolve a solid material. Etchants useful in some embodiments include, but are not limited to, hydrochloric acid, hydrofluoric acid, sodium hydroxide, phosphoric acid, nitric acid, and ammonium fluoride.

A “slurry,” a “suspension,” and an “emulsion” refers to mixtures of a liquid and solid particles that are floating or otherwise held in the solvent without dissolving. In some embodiments, a “slurry” refers to a semiliquid mixture containing at least a particulate solid material and water (or other liquid).

“Templating particle” refers to a particulate material on which another material can be coated such that, when the templating particle is removed (e.g., via a calcining process), the other material retains the shape of the templating particle. Templating particles may also be referred to herein as scaffold beads. Templating particle materials useful in some embodiments include, but are not limited to, glass, polystyrene, and cellulose. One example of a cellulose material is walnut shell.

“Coating” refers to a layer of material deposited over another object or the process of forming a layer of material over another object. In some embodiments, templating particles are provided with a coating of a ceramic or ceramic precursors. In some embodiments, ceramic beads or proppants are coated with another material, such as an organic material (e.g., a phenolic resin).

“Homogenized” refers to a process in which the components of the mixture are uniformly distributed.

“Grinding” refers to a process in which larger pieces of material are broken into smaller pieces of material.

“Milling” refers to a process in which larger pieces of material are broken into smaller pieces of material using a mill. In some embodiments, a mill corresponds to a ball mill, in which balls of material are used to crush or otherwise fracture the material being milled.

“Granulation” refers to a process in which smaller particles are combined to form larger particles.

“Freeze drying” refers to a process in which materials are exposed to sub-zero ° C. conditions to facilitate removal of water or other liquids in the material, such as by exposing the sub-zero ° C. material to vacuum conditions.

“Spray drying” refers to a process in which a slurry, suspension, or emulsion is forced through a small opening to form small droplets of liquid containing suspended solid material and evaporating the liquid from the droplets to form dried particles of the solid material.

“Plasma spheroidization” refers to a process in which a powdered material is formed into aggregates in the presence of a heat source, such as a plasma flame, in order to heat the aggregates to near or above the melting temperature of the powdered material or a reaction product of components of the powdered material.

A “hollow core” refers to a central vacancy within an object, which is completely surrounded by the material of the object, and which may occupy a majority of the volume of the object. A “pore” refers to a vacancy within an object that may reach a surface of an object or may be located completely within an object, and which may only occupy a minority fraction of the volume of the object. A hollow core may be distinguished form a pore in an object in that multiple pores may be present in an object, while only a single hollow core may be present within an object. In some embodiments, a hollow core is located at or has a position coinciding with a center of an object, such as a volumetric center or a center of mass.

“Crush strength” refers to a proppant pack level crush resistance measured by a testing procedure in accordance with ISO 135032. In this test, a specified volume of proppant material is crushed in a test cell and the amount of fines produced are quantified for a given applied stress. Crush strength is then defined as the stress level at which an acceptable amount of fines are produces (typically less than 5 to 10% fines).

“Diametral strength” refers to a measure of a fracture strength of an individual proppant particle, such as a ceramic bead, under compressive loading of the individual particle. In some embodiments, a diametral strength of a particle is obtained using the following equation.

$$\frac{Failure Load \times 1.4}{2 \times π \times bead {radius}^{2}}$$

“Specific gravity” refers to the ratio of the density of a substance to the density of water having the same volume as the substance.

“Porosity” refers to the measure of void space in a material, and is represented as a percentage of the volume of voids in the total volume of the material. A material with 0% porosity has no voids and a material with a porosity of 60%, for example, has one or more void spaces comprising 60% of the total volume of the material.

“Sphericity” refers to how close a proppant particle approaches the shape of a sphere. Sphericity is calculated as the ratio of the surface area of a sphere (with the same volume as the given particle) to the surface area of the particle.

“Reaction product” refers to a species formed from a chemical reaction.

“Mold” refers to a hollowed-out refractory material in which another molten material can solidify. Mold materials useful in some embodiments include, but are not limited to, graphite and molybdenum.

### III. Methods of Preparing Proppant Materials

In some embodiments, methods of preparing ceramic beads are described. The ceramic beads may exhibit characteristics, such as sizes, densities, diametral strengths, and crush strengths, for example, that make them useful as proppant materials. In some embodiments, a method of preparing a plurality of ceramic beads comprises forming a plurality of bead precursors each comprising a mixture of ceramic precursors; and heating the bead precursors to a temperature greater than about 1200° C. to initiate a chemical reaction between the ceramic precursors and transform the bead precursors into ceramic beads. In some embodiments, the method may further comprise mixing the plurality of ceramic precursors together to form the mixture. In some embodiments, the ceramic precursors have sizes of about 30 μm to about 500 μm. In some embodiments, the mixture may be referred to as a reaction mixture, since, for example, the ceramic precursors in the mixture may react with one another if placed under suitable conditions.

In some embodiments, the mixture comprises a plurality of ceramic precursors including two or more of fly ash, slag, carbon black, pumice, and aluminum dross. In some embodiments, the ceramic precursors are in the form of particles characterized by a size of about 30 μm to about μm. In some embodiments, the bead precursors each have cross-sectional dimensions of about 0.1 mm to about 2.5 mm. In some embodiments, the ceramic beads are each characterized by one or more of a diameter of about 0.03 mm to about 2.0 mm, a diametral strength greater than about 100 MPa, and a specific gravity of about 1.0 to about 3.0. In some embodiments, the ceramic beads are each characterized by one or more of a diameter of about 0.1 mm to about 1.8 mm.

### A. Mixture Components

A variety of components are useful with the mixtures or reaction mixtures described herein. For example, in some embodiments, the mixture comprises one or more of a suspension, an emulsion, or a slurry comprising the plurality of ceramic precursors suspended in a solvent. In some embodiments, the mixture comprises homogenized ceramic precursors. In some embodiments, the mixture comprises ground or milled ceramic precursors, such as a ground or milled mixture of dry ceramic precursors (i.e., not suspended in a solvent). It will be appreciated that a variety of grinding or milling techniques may be useful for grinding or mixing ceramic precursors. In some embodiments, the ceramic precursors are added to a ball mill and milled until the ceramic precursors are formed into particles having sizes of about 30 μm to about 500 μm and mixed.

In some embodiments the mixture comprises one or more waste stream materials, such as slag and fly ash. For example, the slag may optionally comprise about 20% to about 99% of the mixture by weight, such as about 20%, 25%, 30%, 35%, 40%, 45%, 50%, 55%, 60%, 65%, 70%, 75%, 80%, 85%, 90%, 95%, or 99% by weight. Optionally, the fly ash comprises about 1% to about 80% of the mixture by weight, such as about 1%, 5%, 10%, 15%, 20%, 25%, 30%, 35%, 40%, 45%, 50%, 55%, 60%, 65%, 70%, 75%, or 80% by weight. Optionally, carbon black comprises 0% to about 50% of the mixture by weight, such as about 5%, 10%, 15%, 20%, 25%, 30%, 35%, 40%, 45%, or 50% by weight or 0% by weight. Optionally, pumice comprises 0% to about 60% of the mixture by weight, such as about 5%, 10%, 15%, 20%, 25%, 30%, 35%, 40%, 45%, 50%, 55%, or 60% by weight or 0% by weight. Optionally, aluminum dross comprises 0% to about 50% of the mixture by weight, such as about 5%, 10%, 15%, 20%, 25%, 30%, 35%, 40%, 45%, or 50% by weight or 0% by weight.

In some embodiments, the mixture further comprises one or more of a binder, a reactive additive, cellulose, a polymer, or a solvent. The use of a binder may aid in densification of the ceramic beads. The use of a binder may also impact the strength of the ceramic beads. Optionally, the binder comprises one or more of a silicate binder or a polyvinyl alcohol (PVA) binder.

In some embodiments, reactive additives are used to provide additional chemical species which may be present in low or minute amounts, or absent, in the ceramic precursors, but which may be useful or desirable for forming a ceramic of a particular composition. Optionally, the reactive additive comprises one or more of AlN, Si₃N₄, and SiO₂. Optionally, the reactive additive comprises one or more of C, Al, Si, Mg, K, Fe, Na, B, O, N, ZrO₂, Y₂O₃, and compounds thereof, volcanic ash, and aluminum dross.

In some embodiments, the inclusion of a solvent in a mixture may aid in the flowing of the mixture and/or may be used to provide chemical species that take part in a chemical reaction. Optionally, the solvent comprises one or more of water, methanol, or ethanol.

### B. Bead Precursor Formation

It will be appreciated that different bead precursor formation processes are useful with the methods of preparing a proppant material described herein. In some embodiments, forming the plurality of bead precursors comprises forming the particles of ceramic precursors in the mixture into aggregated particles by a granulation process, such as aggregated particles that correspond to the bead precursors.

In some embodiments, forming the plurality of bead precursors comprises coating a plurality of organic scaffold beads with the mixture, such as organic scaffold beads that comprise walnut shell and/or polystyrene beads. In some embodiments, the organic scaffold material may be removed from the bead precursors during a heating process to generate hollow ceramic beads.

In some embodiments, forming the plurality of bead precursors comprises depositing the mixture into a plurality of mold forms, such as mold forms that comprise graphite, molybdenum, a non-reactive metal, and/or a non-reactive ceramic.

In some embodiments forming the plurality of bead precursors comprises forming droplets from the mixture, such as a mixture that comprises a suspension, an emulsion, or a slurry comprising the ceramic precursors suspended in a solvent, and processing the droplets using a freeze drying process, such that the freeze dried droplets correspond to the bead precursors.

In some embodiments forming the plurality of bead precursors comprises forming droplets from the mixture, such as a mixture that comprises a suspension, an emulsion, or a slurry comprising ceramic precursors suspended in a solvent, and processing the droplets using a spray drying process, wherein the spray dried droplets correspond to the bead precursors.

In some embodiments, forming the plurality of bead precursors comprises forming aggregates of the mixture in a plasma source, such as aggregates of the mixture that correspond to the bead precursors. Optionally, the plasma source may heat the reaction mixture to initiate the chemical reaction.

As with the mixture, the bead precursors may comprise various compositions, in some embodiments. For example, in some embodiments, the bead precursors comprise slag and fly ash. Optionally, the bead precursors comprise about 20% to about 99% slag by weight. Optionally, the bead precursors comprise about 1 to about 80% fly ash by weight. Optionally, the bead precursors comprise 0% to about 50% organic materials by weight, such as one or more organic materials including cellulose, walnut shells, or polystyrene.

In some embodiments, the bead precursors comprise green bodies of ceramic precursors. For example, in some embodiments, the ceramic precursors in the green bodies chemically react during the heating to form a ceramic material.

### C. Chemical Reaction

A variety of different reaction conditions are useful with the methods for forming ceramic beads. For example, the reaction conditions useful for initiating the chemical reaction may be dependent upon which ceramic precursor materials and optional additives are included in the reaction mixture.

For example, in some embodiments, heating the bead precursors comprises heating the bead precursors in a reactive atmosphere, such as a reactive atmosphere that comprises one or more of N₂, O₂, air, and CO₂. Heating the bead precursors in a reactive atmosphere may be useful when a source or an additional source of nitrogen or oxygen is needed for the desired chemical reaction. For example, in some embodiments, the chemical reaction forms a nitride-based ceramic and the reactive atmosphere may comprise N₂. In some embodiments, the chemical reaction forms an oxide-based ceramic and the reactive atmosphere may comprise O₂.

Optionally, nitrides may be formed in a first reactive process, such as by heating the bead precursors to a first temperature in a N₂ atmosphere. One or more additives may be optionally added to the bead precursors after the first reactive process. During the second reactive process, the bead precursors may be heated to a second temperature. Such a multiple-step method may be useful for forming particular ceramic materials such as SiAlON, depending on the starting materials.

Different temperature regimes may be useful, depending on the starting ceramic precursor materials and the chosen formation process. For example, heating the bead precursors may include heating the bead precursors to between about 1200° C. and about 1750° C. Heating the bead precursors may optionally include heating the bead precursors to about 1450° C. for about 8 to about 24 hours. In some embodiments, heating the bead precursors includes heating the bead precursors to between about 250° C. and about 350° C., such as for a particular time period, prior to heating the bead precursors to greater than about 1200° C. Optionally, heating the bead precursors comprises sintering the bead precursors. Optionally, heating the bead precursors comprises annealing the bead precursors. Optionally, heating the bead precursors comprises melting the bead precursors. Optionally, heating the bead precursors comprises exposing the bead precursors to a heated plasma.

In some embodiments, heating the bead precursors above a melting temperature of the mixture generates molten beads that exhibit a surface tension sufficient to cause the molten beads to form into or take on spherical shapes. This property may be advantageous for techniques, such as melt processing, where the initial bead precursors may not have spherical shapes, but the resultant ceramic beads have spherical or generally spherical shapes.

A variety of heating techniques may be useful with the methods for forming ceramic beads. For example, in some embodiments, heating the bead precursors includes heating the bead precursors using an inductive heating technique. In some embodiments, heating the bead precursors includes heating the bead precursors using a conductive heating technique. In some embodiments heating the bead precursors includes heating the bead precursors using a radiative heating technique. In some embodiments, these techniques may be combined. For example, an inductive heating method, such as RF induction, may be useful for heating a crucible or mold containing the bead precursors, and the heat generated within the crucible or mold may be transferred to the bead precursors by conduction.

### D. Ceramic Bead Characteristics

Beads of different properties may be formed using the methods described herein. For example, beads of different porosity amounts may be formed. In some embodiments, the ceramic beads are characterized by a porosity of about 1% to about 99%. By generating ceramic beads of different porous characters, the density of the ceramic beads may be modified or otherwise tuned for a particular application. Further, it will be appreciated that certain reaction mixture processing conditions may impact the amount of porosity of the ceramic beads. A variety of bead porosities may be achieved including, but not limited to, about 1% to about 99% porous, about 2% to about 99% porous, about 5% to about 99% porous, about 10% to about 99% porous, about 25% to about 99% porous, about 50% to about 99% porous, about 1% to about 90% porous, about 5% to about 99% porous, about 10% to about 90% porous, about 25% to about 90% porous, or about 50% to about 90% porous. In some embodiments, the ceramic beads have a uniform or narrow porosity range, such as a porosity range spanning only about 1%, about 5%, or about 10%. In some embodiments, the ceramic beads have a wide porosity range, such as a porosity range spanning only about 40%, about 50%, about 60%, or about 70% or more.

Additionally or alternatively, the ceramic beads may exhibit a hollow core. Inclusion of a hollow core may be useful for impacting the density and/or strength of the ceramic beads. For example, in some embodiments, the ceramic beads are characterized by a hollow core characterized by a diameter of about 0.01 mm to about 1 mm. The hollow core may occupy a particular percentage of the volume of the ceramic bead, such as between about 50% and about 99%. In some embodiments, the ceramic beads have a uniform or narrow hollow core volume fraction, such as a fraction spanning only about 1%, about 5%, or about 10%. In some embodiments, the ceramic beads have a wide hollow core volume fraction, such as a porosity range spanning about 30% or more, about 40% or more, or about 50%.

Although it may be desirable to form beads that are perfectly spherical, in some embodiments, beads that are less than spherical are useful for some applications. It will be appreciated that different reaction mixture processing conditions and techniques may generate beads of different sphericities. In addition, subsequent processing, such as a subsequent annealing, sintering, or melting process may impact bead sphericity. In some embodiments, the ceramic beads have a sphericity of about 0.5 to about 1.0, about 0.6 to about 1.0, about 0.7 to about 1.0, 0.8 to about 1.0, or about 0.9 to about 1.0.

It will be appreciated that beads of different densities may be useful in particular applications. For example, depending on a carrier fluid, different ceramic bead densities may be useful as proppant materials. In some embodiments, it may be desirable to use as light a ceramic bead as possible. In other embodiments, it may be desirable to use heavier ceramic beads. In some embodiments, the ceramic beads have specific gravities of about 1.0 to about 1.5, about 1.0 to about 2.0, about 1.0 to about 2.5, about 1.0 to about 2.5, about 1.5 to about 2.0, about 1.5 to about 2.5, about 1.5 to about 3.0, about 2.0 to about 2.5, about 2.0 to about 3.0, or about 2.5 to about 3.0. It will be appreciated, that, in some embodiments, the specific gravities of ceramic beads may be tuned by adjusting a porosity level of the beads. For example, in some embodiments, beads with a higher porosity percentage may have a lower specific gravity, while beads with a lower porosity percentage may have a higher specific gravity.

Depending on the particular structure and composition of the ceramic beads, the beads may exhibit a variety of diametral strengths. For example, various coating and densification processes and amounts may impact the diametral strength of the ceramic beads, in some embodiments. In some embodiments, the ceramic beads are characterized by a diametral strength greater than about 150 MPa, greater than about 200 MPa, or greater than about 300 MPa.

In some embodiments, the ceramic beads are characterized by a uniform size distribution or a narrow size distribution. For example, in some embodiments, the ceramic beads exhibit a size distribution that corresponds to a standard deviation of diameters of the ceramic beads being less than 10% of an average or median diameter of the ceramic beads. Formation of a uniform size distribution of beads is advantageous in that, when used as proppants, beads that are too large may block cracks and fissures from being penetrated by smaller beads. In addition, beads that are too small may fill cracks and fissures too much and prevent fluid from efficiently flowing through the cracks and fissures.

In some embodiments, the ceramic beads are characterized by a non-uniform size distribution. For example, the ceramic beads may exhibit a variety of different cross-sectional dimensions (e.g., diameter), such that beads of non-desired sizes may be separated, such as by sieving, to obtain beads of a narrow size distribution.

Various compositions for the ceramic beads may also be achieved using the disclosed methods. For example, in some embodiments, the ceramic beads comprise one or more of a SiAlON ceramic, an oxide ceramic, a nitride ceramic, or an oxynitride ceramic. It will be appreciated that the above advantageous properties may be achieved by use of these materials. For example, the inventors have identified SiAlON as a particularly desirable ceramic for some embodiments, due to its stable and low- or non-reactive character, its strength, its density, its surface tension while molten, and its ability to form porous or hollow beads.

### E. Coating Techniques

Methods of preparing ceramic beads or proppant materials described herein may include additional steps. For example, in some embodiments, methods of preparing proppant materials or ceramic beads may include coating the proppant material, such as ceramic beads, with a coating, so as to form a plurality of coated proppant materials or a plurality of coated ceramic beads. Addition of a coating may provide a significant increase to the crush strength or diametral strength of a proppant material or a ceramic bead and may alternatively or additionally provide a degree of chemical robustness to the proppant material or a ceramic bead. For example, in some embodiments, a coating may provide the proppant material or ceramic bead with an increased ability to withstand exposure to corrosive conditions, such as acidic or basic conditions. In some embodiments, the coating comprises an organic coating. Specific coating materials include, but are not limited to, a phenolic polymer and a polyurethane polymer.

In some embodiments, a coating may increase the diametral strength of the proppant material or a ceramic bead by a factor of 1.1 to 3.0 over the non-coated proppant material or ceramic bead. For example, in some embodiments the coated proppant material or ceramic bead may be characterized by a diametral strength greater than about 150 MPa, by a diametral strength greater than about 200 MPa, by a diametral strength greater than about 250 MPa, by a diametral strength greater than about 300 MPa, or by a diametral strength greater than about 350 MPa.

### F. Proppant Sieving

In some embodiments, the ceramic beads may exhibit a non-uniform size distribution, such that it would be useful to sort the beads by size to obtain a narrow size distribution, if desired. In some embodiments, such a sorting may be achieved by sieving. For example, in some embodiments, a method of preparing ceramic beads further comprises passing portions of the ceramic beads through one or more sieves each characterized by a different mesh size to sort the ceramic beads by diameter. It will be appreciated that a sieve of a particular mesh size will allow material smaller than the sieve opening to pass through, while retaining material of a size larger than the sieve opening. For example, in some embodiments, a first sieve has a mesh size of about 10 to about 100, such as a mesh size of about 20, and a second sieve has a mesh size of about 20 to about 140, such as a mesh size of about 40. In this way, two sieves may be used to obtain material having a size distribution between the sieve openings. Useful mesh sizes include, but are not limited to, those having openings of about 2.0 mm to about 0.1 mm, which may correspond to mesh sizes of about 10 and about 140, respectively. Useful mesh sizes for each the one or more sieves may include those corresponding to a mesh size of 10, 12, 14, 16, 18, 20, 25, 30, 35, 40, 45, 50, 60, 70, 80, 100, 120, or 140. It will be appreciated that the phrase mesh size, as used herein, may also be referred to as mesh number.

### IV. Methods of Preparing Proppant Material from Direct Melt Processing

In some embodiments, methods of preparing a proppant material are described. In some embodiments, the method includes heating a reaction mixture comprising a plurality of oxides. The reaction mixture can be heated in a reactive atmosphere to a temperature above the melting point of the reaction mixture to form a melt. The melt can be allowed to solidify in a mold. The solidified melt can be in the form of spherical particles characterized by a specific gravity of about 1.5 to 3.0 and a diametral strength of at least about 10,000 psi.

The plurality of oxides included in the reaction mixture can be any oxides that form proppant materials having the desired specific gravity and diametral strength upon solidification. Suitable oxides include, but are not limited to, SiO₂, Al₂O₃, Fe₂O₃, FeO, Fe₃O₄, CaO, MgO, MnO₂, MnO, Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, and CaCO₃. In some embodiments, each of the plurality of oxides can be SiO₂, Al₂O₃, Fe₂O₃, FeO, Fe₃O₄, CaO, MgO, MnO₂, or MnO.

In some embodiments, the reaction mixture can further include one or more additives. Any additives suitable for forming proppant particles of the desired composition can be used. Suitable additives include, but are not limited to, C, Al, Si, Mg, K, Fe, Na, B, O, N, ZrO₂, Y₂O₃, and compounds thereof, volcanic ash, and aluminum dross.

The reactive atmosphere in which the reaction mixture is heated can include any reactive gas suitable for forming proppant particles of the desired composition and morphology. Suitable reactive atmospheres include, but are not limited to, N₂, O₂, air, CO₂, and combinations thereof. In some embodiments, the reactive atmosphere can be N₂.

The reaction mixture can be heated to any temperature above the melting point of the reaction mixture to form the melt. In some embodiments, the reaction mixture can be heated to a temperature of about 800 to 2,500° C. In other embodiments, the reaction mixture can be heated to a temperature of about 850 to 2,450° C., 900 to 2,400° C., 950 to 2,350° C., 1,000 to 2,300° C., 1,050 to 2,250° C., 1,100 to 2,200° C., 1,150 to 2,150° C., 1,200 to 2,100° C., 1,250 to 2,050° C., 1,300 to 2,000° C., 1,350 to 1,950° C., 1,400 to 1,900° C., 1,450 to 1,850° C., 1,500 to 1,800° C., 1,550 to 1,750° C., or about 1,600 to 1,700° C. In other embodiments, the reaction mixture can be heated to a temperature of about 1,200 to 2,000° C.

The mold can comprise any suitable material on which spherical particles form upon solidification. In some embodiments, the mold can comprise graphite or molybdenum. In other embodiments, the mold can comprise graphite. In yet other embodiments, the mold can comprise a refractory material (e.g., alumina) coated with graphite or molybdenum. The mold can have any suitable dimensions. In some embodiments, the mold can comprise cylindrical holes in which the melt solidifies to form the spherical particles. In some embodiments, the melt can be introduced into the mold and then allowed to solidify. For example, the melt can be prepared in a separate crucible and then dripped into cylindrical holes of the mold where the melt cools and solidifies to form the spherical particles. In other embodiments, the reaction mixture comprising the plurality of oxides can be introduced into the mold in solid form and then heated. For example, a powder comprising the reaction mixture can be loaded into cylindrical holes of the mold where the powder is then heated to form a melt, cooled, and solidified to form the spherical particles.

In some embodiments, the plurality of oxides included in the reaction mixture are present in the form of waste stream material. Any waste stream material suitable for forming spherical particles of the desired composition and morphology can be used. Suitable waste stream materials include, but are not limited to, metallurgical slag such as air-cooled slag, pelletized slag, and granulated slag, and fly ash. In some embodiments, the waste stream material can be air-cooled slag. In other embodiments, the waste stream material can be pelletized slag. In still other embodiments, the waste stream material can be granulated slag. In yet other embodiments, the waste stream material can be fly ash. In some embodiments, the waste stream material can be aluminum dross. In some embodiments, the proppants of some embodiments are formed using only waste stream material such as metallurgical slag and/or fly ash.

In some embodiments, the waste stream material comprises metallurgical slag and fly ash. Any ratio of metallurgical slag and fly ash suitable for forming spherical particles having the desired composition and morphology can be used. In some embodiments, the metallurgical slag and fly ash can comprise about 50-99% (w/w) and 1-50% (w/w), respectively, of the reaction mixture. In other embodiments, the metallurgical slag and fly ash can comprise about 1-50% (w/w) and 50-99% (w/w), respectively, of the reaction mixture. In yet other embodiments, the metallurgical slag and fly ash can comprise about 20-99% (w/w) and 1-80% (w/w), respectively, of the reaction mixture. In still other embodiments, the metallurgical slag and fly ash can comprise about 1-80% (w/w) and 20-99% (w/w), respectively, of the reaction mixture. In some embodiments, the metallurgical slag can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In other embodiments, the metallurgical slag can comprise about 5-50% (w/w), 10-50% (w/w), 15-50% (w/w), 20-50% (w/w), 25-50% (w/w), 30-50% (w/w), 35-50% (w/w), or about 40-50% (w/w) of the reaction mixture. In some embodiments, the fly ash can comprise about 5-50% (w/w), 10-50% (w/w), 15-50% (w/w), 20-50% (w/w), 50% (w/w), 30-50% (w/w), 35-50% (w/w), or about 40-50% (w/w) of the reaction mixture. In other embodiments, the fly ash can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In still other embodiments, the metallurgical slag and fly ash can comprise about 95% (w/w) and 5% (w/w), respectively, of the reaction mixture. In yet other embodiments, the metallurgical slag and fly ash can comprise about 80% (w/w) and 20% (w/w), respectively, of the reaction mixture.

The spherical particles formed upon solidification can have any suitable composition. In some embodiments, the spherical particles can comprise one or more oxides. For example, in some embodiments, the one or more oxides can be from the plurality of oxides included in the reaction mixture. In other embodiments, the one or more oxides can instead be formed as a result of heating the reaction mixture in the reactive atmosphere. Suitable oxides include, but are not limited to, SiO₂, Al₂O₃, Fe₂O₃, CaO, MgO, FeO, Fe₃O₄, MnO, yttria-stabilized zirconia (YSZ), and CaCO₃. In some embodiments, the spherical particles can be characterized by magnetic properties.

In some embodiments, the method can further include coating the spherical particles with a material that can be an organic, nitride, or ceramic material. The coating may promote containment of fines formed as the result of fracture stresses crushing the spherical particles in operation. Suitable organics include, but are not limited to, phenolic polymers and polyurethane.

The spherical particles can have any specific gravity suitable for induced hydraulic fracturing applications. Suitable specific gravities can be close to that of water, (i.e., “1”). In some embodiments, the spherical particles can be characterized by a specific gravity of about 1.5 to 2.9, 1.6 to 2.8, 1.7 to 2.7, 1.8 to 2.6, 1.9 to 2.5, 2.0 to 2.4, or about 2.1 to 2.3. In other embodiments, the spherical particles can be characterized by a specific gravity of about 2.0 to 3.0.

The spherical particles can have any diametral strength suitable for induced hydraulic fracturing applications. In some embodiments, the spherical particles can have a diametral strength of at least about 10,250 psi, 10,500 psi, 10,750 psi, 11,000 psi, 11,250 psi, 11,500 psi, 11,750 psi, 12,000 psi, 12,250 psi, 12,500 psi, 12,750 psi, 13,000 psi, 13,250 psi, 13,500 psi, 13,750 psi, or at least about 14,000 psi.

The spherical particles can have any porosity suitable to attain the desired diametral strength and specific gravity. In some embodiments, the spherical particles are characterized by a porosity of about 10 to 60%. In other embodiments, the spherical particles can be characterized by a porosity of about 13 to 57%, 16 to 54%, 19 to 51%, 22 to 48%, 25 to 45%, 28 to 42%, 31 to 39%, or about 34 to 36%. In some embodiments, the spherical particles can comprise a hollow core.

The spherical particles can have any size suitable to attain the desired diametral strength, specific gravity, and fracture particle distribution. In some embodiments, the spherical particles are characterized by a diameter of about 0.1 to 1.7 mm. In other embodiments, the spherical particles are characterized by a diameter of about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles are characterized by a diameter of about 0.3 to 0.7 mm. In some embodiments, at least about 80% of the spherical particles are characterized by a diameter within 20% of the average diameter of the spherical particles. In some embodiments, the spherical particles are characterized by a sphericity of about 0.7 to 1.0. In other embodiments, the spherical particles are characterized by a sphericity of about 0.8 to 1.0. In yet other embodiments, the spherical particles are characterized by a sphericity of about 0.9 and 1.0.

In some embodiments, the method can include heating a reaction mixture comprising a plurality of oxides and one or more additives, wherein the reaction mixture can be heated in a reactive atmosphere to a temperature above the melting point of the reaction mixture to form a melt. Each of the plurality of oxides can be SiO₂, Al₂O₃, Fe₂O₃, FeO, Fe₃O₄, CaO, MgO, MnO₂, MnO, Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, or CaCO₃. The one or more additives can be C, Al, Si, Mg, K, Fe, Na, B, O, N, ZrO₂, Y₂O₃, compounds thereof, volcanic ash, or aluminum dross, and the reactive atmosphere can comprise N₂, O₂, air, CO₂, or combinations thereof. The reaction mixture can be heated to a temperature of about 800 to 2,500° C., and the plurality of oxides can be present in the form of waste stream material, wherein the waste stream material can comprise metallurgical slag and fly ash, and wherein the metallurgical slag and fly ash can comprise about 20-99% (w/w) and 1-80% (w/w), respectively, of the reaction mixture. The melt can be allowed to solidify in a mold comprising graphite, and the solidified melt can be in the form of spherical particles characterized by a specific gravity of about 1.5 to 3.0, a diametral strength of at least about 10,000 psi, a sphericity of about 0.7 to 1.0, a porosity of about 10 to 60%, and a diameter of about 0.1 to 1.7 mm. The spherical particles can be coated with a coating material that can be an organic, ceramic, or nitride material.

### V. Methods of Preparing Proppant Material from Reaction Product Initiation

In some embodiments, methods of preparing a proppant material are described. In some embodiments, the method can include heating a reaction mixture comprising a plurality of oxides and one or more additives. The reaction mixture can be heated in a reactive atmosphere to a temperature below the melting point of the reaction mixture to form a powder comprising one or more reaction products. The powder can be processed to form spherical particles characterized by a specific gravity of about 1.0 to 1.7 and a diametral strength of at least about 10,000 psi.

The plurality of oxides included in the reaction mixture can be any oxides that react to form the desired reaction products. Suitable oxides include, but are not limited to, SiO₂, Al₂O₃, Fe₂O₃, FeO, Fe₃O₄, CaO, MgO, MnO₂, MnO. Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, and CaCO₃. In some embodiments, each of the plurality of oxides can be SiO₂, Al₂O₃, Fe₂O₃, FeO, Fe₃O₄, CaO, MgO, MnO₂, or MnO.

The reaction mixture can include any additives suitable for forming proppant particles of the desired composition. Suitable additives include, but are not limited to, C, Al, Si, Mg, K, Fe, Na, B, O, N, ZrO₂, Y₂O₃, and compounds thereof, volcanic ash, and aluminum dross.

The reactive atmosphere in which the reaction mixture is heated can include any reactive gas suitable for forming proppant particles of the desired composition. Suitable reactive atmospheres include, but are not limited to, N₂, O₂, air, CO₂, and combinations thereof. In some embodiments, the reactive atmosphere can be N₂.

The one or more reaction products included in the powder formed by heating the reaction mixture in the reactive atmosphere can have any suitable composition. In some embodiments, the one or more reaction products can be an oxide, a nitride, an oxynitride, a boride, or a carbide. In other embodiments, the one or more reaction products can be Si_{6-z}Al_{z}O_{z}N_{8-z} where 0<z<5, Li₂SiN₂, CaSiN₂, MgSiN₂, MgB₂, Si₃N₄, or yttria-stabilized zirconia (YSZ). In some embodiments, the spherical particles can be characterized by magnetic properties.

The reaction mixture can be heated to any temperature below the melting point of the reaction mixture suitable for forming the desired one or more reaction products. In some embodiments, the reaction mixture is heated to a temperature of about 700 to 1,800° C. In other embodiments, the reaction mixture can be heated to a temperature of about 800 to 1,700° C., 900 to 1,600° C., 1,000 to 1,500° C., 1,100 to 1,400° C., or about 1,200 to 1,300° C.

In some embodiments, the plurality of oxides included in the reaction mixture are present in the form of waste stream material. Any waste stream material suitable for forming spherical particles of the desired composition can be used. Suitable waste stream materials include, but are not limited to, metallurgical slag such as air-cooled slag, pelletized slag, and granulated slag, and fly ash. In some embodiments, the waste stream material can be air-cooled slag. In other embodiments, the waste stream material can be pelletized slag. In still other embodiments, the waste stream material can be granulated slag. In yet other embodiments, the waste stream material can be fly ash. In still other embodiments, the waste stream material can be aluminum dross.

In some embodiments, the waste stream material comprises metallurgical slag and fly ash. Any ratio of metallurgical slag and fly ash suitable for forming spherical particles having the desired composition and morphology can be used. In some embodiments, the metallurgical slag and fly ash can comprise about 50-99% (w/w) and 1-50% (w/w), respectively, of the reaction mixture. In other embodiments, the metallurgical slag and fly ash can comprise about 1-50% (w/w) and 50-99% (w/w), respectively, of the reaction mixture. In yet other embodiments, the metallurgical slag and fly ash can comprise about 20-99% (w/w) and 1-80% (w/w), respectively, of the reaction mixture. In still other embodiments, the metallurgical slag and fly ash can comprise about 1-80% (w/w) and 20-99% (w/w), respectively, of the reaction mixture. In some embodiments, the metallurgical slag can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In other embodiments, the metallurgical slag can comprise about 5-50% (w/w), 10-50% (w/w), 15-50% (w/w), 20-50% (w/w), 25-50% (w/w), 30-50% (w/w), 35-50% (w/w), or about 40-50% (w/w) of the reaction mixture. In some embodiments, the fly ash can comprise about 5-50% (w/w), 10-50% (w/w), 15-50% (w/w), 20-50% (w/w), 50% (w/w), 30-50% (w/w), 35-50% (w/w), or about 40-50% (w/w) of the reaction mixture. In other embodiments, the fly ash can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In still other embodiments, the metallurgical slag and fly ash can comprise about 95% (w/w) and 5% (w/w), respectively, of the reaction mixture. In yet other embodiments, the metallurgical slag and fly ash can comprise about 80% (w/w) and 20% (w/w), respectively, of the reaction mixture.

In some embodiments, the one or more reaction products can comprise an oxide, and processing the powder can include contacting the one or more reaction products with an etchant to remove the oxide. For example, in some embodiments, the reaction mixture can include SiO₂ and a nitride additive such as Li₃N, Ca₃N₂, or Mg₃N₂. When heated in an N₂ reactive atmosphere, reaction products including silicon nitrides (e.g., LiₓSi_{y}N₂, CaSiN₂, or MgSiN₂) and oxides (e.g., Li₂O, CaO, or MgO) can be formed. If the silicon nitride is the desired material, the oxide reaction product can be removed using an etchant. In some embodiments, etchants can be used to remove non-oxide reaction products, in addition to any remaining oxides and other materials that were present in the reaction mixture prior to heating. Any etchant suitable for removing undesired material in the formed powder while preserving the desired material can be used in some embodiments. Suitable etchants include, but are not limited to, hydrochloric acid, hydrofluoric acid, sodium hydroxide, phosphoric acid, nitric acid, and ammonium fluoride.

In some embodiments, processing the powder can include heating the powder in a non-reactive atmosphere to a temperature above the melting point of the powder to form a melt, and allowing the melt to solidify in a mold, the solidified melt being in the form of the spherical particles.

The mold can comprise any suitable material on which spherical particles form upon solidification. In some embodiments, the mold can comprise graphite or molybdenum. In other embodiments, the mold can comprise graphite. In yet other embodiments, the mold can comprise a refractory material (e.g., alumina) coated with graphite or molybdenum. The mold can have any suitable dimensions. In some embodiments, the mold can comprise cylindrical holes in which the melt solidifies to form the spherical particles. In some embodiments, the melt can be introduced into the mold and then allowed to solidify. For example, the melt can be prepared in a separate crucible and then dripped into cylindrical holes of the mold where the melt cools and solidifies to form the spherical particles. In other embodiments, the formed powder comprising the one or more reaction products can be introduced into the mold in solid form and then heated. For example, the powder can be loaded into cylindrical holes of the mold where the powder is then heated to form a melt, cooled, and solidified to form the spherical particles.

In some embodiments, processing the powder can include forming a slurry comprising the powder, coating templating particles with the slurry, and heating the coated templating particles to consume the templating particles and form the spherical particles. Any suitable templating particle material and heating temperature can be used. In some embodiments, the templating particles can comprise a material that is glass, polystyrene, or cellulose, and the coated templating particles can be heated to a temperature of about 60 to 500° C. to form the spherical particles comprising a hollow core. In some embodiments, the templating particles can comprise glass. In some embodiments, the templating particles can comprise polystyrene. In some embodiments, the templating particles can comprise cellulose. In some embodiments, the cellulose can be present in the form of walnut shell material. For example, the templating particles can comprise walnut shell. In some embodiments, the coated templating particles can be heated to a temperature of about 100 to 450° C., 150 to 400° C., 200 to 350° C., or about 250 to 300° C. to form the spherical particles comprising the hollow core. In other embodiments, the coated templating particles can be heated to a temperature of about 60° C. to form the spherical particles comprising the hollow core. In still other embodiments, the coated templating particles can be heated to a temperature of about 300° C. to form the spherical particles comprising a hollow core. In yet other embodiments, the coated templating particles can be heated to a temperature of about 500° C. to form the spherical particles comprising the hollow core. In some embodiments, the spherical particles comprising the hollow core can be sintered at a temperature of about 500 to 2,000° C. in a reactive atmosphere comprising N₂, O₂, air, CO₂, or combinations thereof. In some embodiments, the spherical particles comprising the hollow core can be sintered at a temperature of about 600 to 1,900° C., 700 to 1,800° C., 800 to 1,700° C., 900 to 1,600° C., 1,000 to 1,500° C., 1,100 to 1,400° C., or about 1,200 to 1,300° C.

In some embodiments, the method can further include coating the spherical particles with a material that can be an organic, nitride, or ceramic material. The coating may promote containment of fines formed as the result of fracture stresses crushing the spherical particles in operation. Suitable organics include, but are not limited to, phenolic polymers and polyurethane.

The spherical particles can have any specific gravity suitable for induced hydraulic fracturing applications. Suitable specific gravities can be close to that of water (i.e., “1”). In some embodiments, the spherical particles can be characterized by a specific gravity of about 1.1 to 1.6, 1.2 to 1.5, or about 1.3 to 1.4. In other embodiments, the spherical particles can be characterized by a specific gravity of about 1.0 to 1.3.

The spherical particles can have any diametral strength suitable for induced hydraulic fracturing applications. In some embodiments, the spherical particles can have a diametral strength of at least about 10,250 psi, 10,500 psi, 10,750 psi, 11,000 psi, 11,250 psi, 11,500 psi, 11,750 psi, 12,000 psi, 12,250 psi, 12,500 psi, 12,750 psi, 13,000 psi, 13,250 psi, 13,500 psi, 13,750 psi, or at least about 14,000 psi.

The spherical particles can have any porosity suitable to attain the desired diametral strength and specific gravity. In some embodiments, the spherical particles are characterized by a porosity of about 10 to 60%. In other embodiments, the spherical particles are characterized by a porosity of about 13 to 57%, 16 to 54%, 19 to 51%, 22 to 48%, 25 to 45%, 28 to 42%, 31 to 39%, or about 34 to 36%. In some embodiments, the spherical particles can comprise a hollow core.

The spherical particles can have any size suitable to attain the desired diametral strength, specific gravity, and fracture particle distribution. In some embodiments, the spherical particles are characterized by a diameter of about 0.1 to 1.7 mm. In other embodiments, the spherical particles are characterized by a diameter of about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles are characterized by a diameter of about 0.3 to 0.7 mm. In some embodiments, at least about 80% of the spherical particles are characterized by a diameter within 20% of the average diameter of the spherical particles. In some embodiments, the spherical particles are characterized by a sphericity of about 0.7 to 1.0. In other embodiments, the spherical particles are characterized by a sphericity of about 0.8 to 1.0. In yet other embodiments, the spherical particles are characterized by a sphericity of about 0.9 and 1.0.

In some embodiments, the method can include heating a reaction mixture comprising a plurality of oxides and one or more additives, wherein the reaction mixture can be heated in a reactive atmosphere to a temperature below the melting point of the reaction mixture to form a powder comprising one or more reaction products. Each of the plurality of oxides can be SiO₂, Al₂O₃, Fe₂O₃, FeO, Fe₃O₄, CaO, MgO, MnO₂, MnO. Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, or CaCO₃. In some embodiments, each of the plurality of oxides can be SiO₂, Al₂O₃, Fe₂O₃, FeO, Fe₃O₄, CaO, MgO, MnO₂, or MnO, and the one or more additives can be C, Al, Si, Mg, K, Fe, Na, B, O, N, ZrO₂, Y₂O₃, compounds thereof, volcanic ash, or aluminum dross. The reactive atmosphere can comprise N₂, O₂, air, CO₂, or combinations thereof, and the reaction mixture can be heated to a temperature of about 700 to 1,800° C. The one or more reaction products can be Si_{6-z}Al_{z}O_{z}N_{8-z} where 0<z<5, Li₂SiN₂, CaSiN₂, MgSiN₂, MgB₂, Si₃N₄, or yttria-stabilized zirconia (YSZ). The plurality of oxides can be present in the form of waste stream material, wherein the waste stream material can comprise metallurgical slag and fly ash, and wherein the metallurgical slag and fly ash can comprise about 20-99% (w/w) and 1-80% (w/w), respectively, of the reaction mixture. The powder can be processed to form spherical particles characterized by a specific gravity of about 1.5 to 3.0, a diametral strength of at least about 10,000 psi, a sphericity of about 0.7 to 1.0, a porosity of about 10 to 60%, and a diameter of about 0.1 to 1.7 mm. The spherical particles can be coated with a coating material that can be an organic, ceramic, or nitride material.

### VI. Proppant Materials

In some embodiments, proppant materials are described. In some embodiments, the proppant material includes spherical particles comprising a material selected from oxides, nitrides, oxynitrides, borides, and carbides. The spherical particles can be characterized by a specific gravity of about 1.0 to 3.0 and a diametral strength of at least about 10,000 psi.

The spherical particles can have any specific gravity suitable for induced hydraulic fracturing applications. Suitable specific gravities can be close to that of water (i.e., “1”). In some embodiments, the spherical particles can be characterized by a specific gravity of about 1.0 to 2.9, 1.0 to 2.8, 1.0 to 2.7, 1.0 to 2.6, 1.0 to 2.5, 1.0 to 2.4, 1.0 to 2.3, 1.0 to 2.2, 1.0 to 2.1, 1.0 to 2.0, 1.0 to 1.9, 1.0 to 1.8, 1.0 to 1.0.7, 1.0 to 1.6, 1.0 to 1.5, 1.0 to 1.4, 1.0 to 1.3, 1.0 to 1.2, or about 1.0 to 1.1. In other embodiments, the spherical particles can be characterized by a specific gravity of about 1.5 to 3.0. In still other embodiments, the spherical particles can be characterized by a specific gravity of about 1.0 to 1.7. In still other embodiments, the spherical particles can be characterized by a specific gravity of about 1.0 to 1.3 or about 2.0 to 3.0. In yet other embodiments, the spherical particles can be characterized by a specific gravity of about 1.0.

The spherical particles can have any diametral strength suitable for induced hydraulic fracturing applications. In some embodiments, the spherical particles can have a diametral strength of at least about 10,250 psi, 10,500 psi, 10,750 psi, 11,000 psi, 11,250 psi, 11,500 psi, 11,750 psi, 12,000 psi, 12,250 psi, 12,500 psi, 12,750 psi, 13,000 psi, 13,250 psi, 13,500 psi, 13,750 psi, or at least about 14,000 psi.

The spherical particles can have any porosity suitable to attain the desired diametral strength and specific gravity. In some embodiments, the spherical particles are characterized by a porosity of about 10 to 60%. In other embodiments, the spherical particles are characterized by a porosity of about 13 to 57%, 16 to 54%, 19 to 51%, 22 to 48%, 25 to 45%, 28 to 42%, 31 to 39%, or about 34 to 36%. In some embodiments, the spherical particles can comprise a hollow core.

The spherical particles can have any size suitable to attain the desired diametral strength, specific gravity, and fracture particle distribution. In some embodiments, the spherical particles are characterized by a diameter of about 0.1 to 1.7 mm. In other embodiments, the spherical particles are characterized by a diameter of about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles are characterized by a diameter of about 0.3 to 0.7 mm. In some embodiments, at least about 80% of the spherical particles are characterized by a diameter within 20% of the average diameter of the spherical particles. In some embodiments, the spherical particles are characterized by a sphericity of about 0.7 to 1.0. In other embodiments, the spherical particles are characterized by a sphericity of about 0.8 to 1.0. In yet other embodiments, the spherical particles are characterized by a sphericity of about 0.9 and 1.0.

The spherical particles can also have any suitable composition. In some embodiments, the oxides can include SiO₂, Al₂O₃, Fe₂O₃, CaO, MgO, FeO, Fe₃O₄, MnO, yttria-stabilized zirconia (YSZ), and CaCO₃, the nitrides can include Li₂SiN₂, CaSiN₂, MgSiN₂, and Si₃N₄, the oxynitrides can include Si_{6-z}Al_{z}O_{z}N_{8-z} where 0<z<5, the borides can include MgB₂, and the carbides can include SiC. In some embodiments, the spherical particles can include a plurality of oxides, nitrides, oxynitrides, borides, or carbides. In some embodiments, the spherical particles can include a combination of one or more of oxides, nitrides, oxynitrides, borides, and carbides. In some embodiments, the spherical particles can be characterized by magnetic properties.

In some embodiments, the proppant material further comprises a coating on the spherical particles comprising a material that can be an organic, ceramic, or nitride material. The coating may promote containment of fines formed as the result of fracture stresses crushing the spherical particles in operation. Suitable organics include, but are not limited to, phenolic polymers and polyurethane.

In some embodiments, the proppant material can include spherical particles comprising a material that can be an oxide, nitride, oxynitride, boride, or carbide. The spherical particles can be characterized by a specific gravity of about 1.0 to 3.0, a diametral strength of at least about 10,000 psi, a porosity of about 10 to 60%, a diameter of about 0.1 to 1.7 mm, and a sphericity of about 0.7 to 1.0. The oxide can be SiO₂, Al₂O₃, Fe₂O₃, CaO, MgO, FeO, Fe₃O₄, MnO, yttria-stabilized zirconia (YSZ), or CaCO₃, the nitride can be of Li₂SiN₂, CaSiN₂, MgSiN₂, or Si₃N₄, the oxynitride can be Si_{6-z}Al_{z}O_{z}N_{8-z} where 0<z<5, the borides can be MgB₂, and the carbide can be SiC. The spherical particles can include a coating comprising a material that can be an organic, ceramic, or nitride material.

### VII. Proppant Materials Prepared by Direct Melt Processing Method

In some embodiments, proppant materials prepared by a method are described. In some embodiments, the method can include heating a reaction mixture comprising a plurality of oxides. The reaction mixture can be heated in a reactive atmosphere to a temperature above the melting point of the reaction mixture to form a melt. The melt can be allowed to solidify in a mold, the solidified melt being in the form of spherical particles comprising one or more of the plurality of oxides, the spherical particles being characterized by a specific gravity of about 1.5 to 3.0 and a diametral strength of at least about 10,000 psi.

The plurality of oxides included in the reaction mixture can be any oxides that form proppant materials having the desired specific gravity and diametral strength upon solidification. Suitable oxides include, but are not limited to, SiO₂, Al₂O₃, Fe₂O₃, FeO, Fe₃O₄, CaO, MgO, MnO₂, MnO, Na₂O, SO₃, K₂O, TiO₂, V₂O₅, Cr₂O₃, SrO, ZrO₂, 3Al₂O₃2 SiO₂, 2Al₂O₃SiO₂, Ca₂Mg(Si₂O₇), Ca₂SiO₄, and CaCO₃. In some embodiments, each of the plurality of oxides can be SiO₂, Al₂O₃, Fe₂O₃, FeO, Fe₃O₄, CaO, MgO, MnO₂, or MnO.

In some embodiments, the reaction mixture can further include one or more additives. Any additives suitable for forming proppant particles of the desired composition can be used. Suitable additives include, but are not limited to, C, Al, Si, Mg, K, Fe, Na, B, O, N, ZrO₂, Y₂O₃, and compounds thereof, volcanic ash, and aluminum dross.

The reactive atmosphere in which the reaction mixture is heated can include any reactive gas suitable for forming proppant particles of the desired composition and morphology. Suitable reactive atmospheres include, but are not limited to, N₂, O₂, air, CO₂, and combinations thereof. In some embodiments, the reactive atmosphere can be N₂.

The reaction mixture can be heated to any temperature above the melting point of the reaction mixture to form the melt. In some embodiments, the reaction mixture can be heated to a temperature of about 800 to 2,500° C. In other embodiments, the reaction mixture can be heated to a temperature of about 850 to 2,450° C., 900 to 2,400° C., 950 to 2,350° C., 1,000 to 2,300° C., 1,050 to 2,250° C., 1,100 to 2,200° C., 1,150 to 2,150° C., 1,200 to 2,100° C., 1,250 to 2,050° C., 1,300 to 2,000° C., 1,350 to 1,950° C., 1,400 to 1,900° C., 1,450 to 1,850° C., 1,500 to 1,800° C., 1,550 to 1,750° C., or about 1,600 to 1,700° C. In other embodiments, the reaction mixture can be heated to a temperature of about 1,200 to 2,000° C.

The mold can comprise any suitable material on which spherical particles form upon solidification. In some embodiments, the mold can comprise graphite or molybdenum. In other embodiments, the mold can comprise graphite. In yet other embodiments, the mold can comprise a refractory material (e.g., alumina) coated with graphite or molybdenum. The mold can have any suitable dimensions. In some embodiments, the mold can comprise cylindrical holes in which the melt solidifies to form the spherical particles. In some embodiments, the melt can be introduced into the mold and then allowed to solidify. For example, the melt can be prepared in a separate crucible and then dripped into cylindrical holes of the mold where the melt cools and solidifies to form the spherical particles. In other embodiments, the reaction mixture comprising the plurality of oxides can be introduced into the mold in solid form and then heated. For example, a powder comprising the reaction mixture can be loaded into cylindrical holes of the mold where the powder is then heated to form a melt, cooled, and solidified to form the spherical particles.

In some embodiments, the plurality of oxides included in the reaction mixture are present in the form of waste stream material. Any waste stream material suitable for forming spherical particles of the desired composition and morphology can be used. Suitable waste stream materials include, but are not limited to, metallurgical slag such as air-cooled slag, pelletized slag, and granulated slag, and fly ash. In some embodiments, the waste stream material can be air-cooled slag. In other embodiments, the waste stream material can be pelletized slag. In still other embodiments, the waste stream material can be granulated slag. In yet other embodiments, the waste stream material can be fly ash. In some embodiments, the waste stream material can be aluminum dross. In some embodiments, the proppants of some embodiments are formed using only waste stream material such as metallurgical slag and/or fly ash.

In some embodiments, the waste stream material comprises metallurgical slag and fly ash. Any ratio of metallurgical slag and fly ash suitable for forming spherical particles having the desired composition and morphology can be used. In some embodiments, the metallurgical slag and fly ash can comprise about 50-99% (w/w) and 1-50% (w/w), respectively, of the reaction mixture. In other embodiments, the metallurgical slag and fly ash can comprise about 1-50% (w/w) and 50-99% (w/w), respectively, of the reaction mixture. In yet other embodiments, the metallurgical slag and fly ash can comprise about 20-99% (w/w) and 1-80% (w/w), respectively, of the reaction mixture. In still other embodiments, the metallurgical slag and fly ash can comprise about 1-80% (w/w) and 20-99% (w/w), respectively, of the reaction mixture. In some embodiments, the metallurgical slag can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In other embodiments, the metallurgical slag can comprise about 5-50% (w/w), 10-50% (w/w), 15-50% (w/w), 20-50% (w/w), 25-50% (w/w), 30-50% (w/w), 35-50% (w/w), or about 40-50% (w/w) of the reaction mixture. In some embodiments, the fly ash can comprise about 5-50% (w/w), 10-50% (w/w), 15-50% (w/w), 20-50% (w/w), 50% (w/w), 30-50% (w/w), 35-50% (w/w), or about 40-50% (w/w) of the reaction mixture. In other embodiments, the fly ash can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In still other embodiments, the metallurgical slag and fly ash can comprise about 95% (w/w) and 5% (w/w), respectively, of the reaction mixture. In yet other embodiments, the metallurgical slag and fly ash can comprise about 80% (w/w) and 20% (w/w), respectively, of the reaction mixture.

The spherical particles formed upon solidification can have any suitable composition. In some embodiments, the spherical particles can comprise one or more oxides. For example, in some embodiments, the one or more oxides can be from the plurality of oxides included in the reaction mixture. In other embodiments, the one or more oxides can instead be formed as a result of heating the reaction mixture in the reactive atmosphere. Suitable oxides include, but are not limited to, SiO₂, Al₂O₃, Fe₂O₃, CaO, MgO, FeO, Fe₃O₄, MnO, yttria-stabilized zirconia (YSZ), and CaCO₃. In some embodiments, the spherical particles can be characterized by magnetic properties.

In some embodiments, the method can further include coating the spherical particles with a material that can be an organic, nitride, or ceramic material. The coating may promote containment of fines formed as the result of fracture stresses crushing the spherical particles in operation. Suitable organics include, but are not limited to, phenolic polymers and polyurethane.

The spherical particles can have any specific gravity suitable for induced hydraulic fracturing applications. Suitable specific gravities can be close to that of water (i.e., “1”). In some embodiments, the spherical particles can be characterized by a specific gravity of about 1.5 to 2.9, 1.6 to 2.8, 1.7 to 2.7, 1.8 to 2.6, 1.9 to 2.5, 2.0 to 2.4, or about 2.1 to 2.3. In other embodiments, the spherical particles can be characterized by a specific gravity of about 2.0 to 3.0.

The spherical particles can have any diametral strength suitable for induced hydraulic fracturing applications. In some embodiments, the spherical particles can have a diametral strength of at least about 10,250 psi, 10,500 psi, 10,750 psi, 11,000 psi, 11,250 psi, 11,500 psi, 11,750 psi, 12,000 psi, 12,250 psi, 12,500 psi, 12,750 psi, 13,000 psi, 13,250 psi, 13,500 psi, 13,750 psi, or at least about 14,000 psi.

The spherical particles can have any porosity suitable to attain the desired diametral strength and specific gravity. In some embodiments, the spherical particles are characterized by a porosity of about 10 to 60%. In other embodiments, the spherical particles are characterized by a porosity of about 13 to 57%, 16 to 54%, 19 to 51%, 22 to 48%, 25 to 45%, 28 to 42%, 31 to 39%, or about 34 to 36%. In some embodiments, the spherical particles can comprise a hollow core.

The spherical particles can have any size suitable to attain the desired diametral strength, specific gravity, and fracture particle distribution. In some embodiments, the spherical particles are characterized by a diameter of about 0.1 to 1.7 mm. In other embodiments, the spherical particles are characterized by a diameter of about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles are characterized by a diameter of about 0.3 to 0.7 mm. In some embodiments, at least about 80% of the spherical particles are characterized by a diameter within 20% of the average diameter of the spherical particles. In some embodiments, the spherical particles are characterized by a sphericity of about 0.7 to 1.0. In other embodiments, the spherical particles are characterized by a sphericity of about 0.8 to 1.0. In yet other embodiments, the spherical particles are characterized by a sphericity of about 0.9 and 1.0.

### VIII. Proppant Materials Prepared by Reaction Product Initiation Methods

In some embodiments, proppant materials are prepared by a method. In some embodiments, the method can include heating a reaction mixture comprising a plurality of oxides and one or more additives. The reaction mixture can be heated in a reactive atmosphere to a temperature below the melting point of the reaction mixture to form a powder comprising one or more reaction products. The powder can be processed to form spherical particles comprising an oxide, nitride, oxynitride, boride, or carbide, the spherical particles being characterized by a specific gravity of about 1.0 to 1.7 and a diametral strength of at least about 10,000 psi.

The plurality of oxides included in the reaction mixture can be any oxides that react to form the desired reaction products. Suitable oxides include, but are not limited to, SiO₂, Al₂O₃, Fe₂O₃, FeO, Fe₃O₄, CaO, MgO, MnO₂, MnO, Na₂O, SO₃, K₂O, TiO₂, V₂O₅, Cr₂O₃, SrO, ZrO₂, 3Al₂O₃2 SiO₂, 2Al₂O₃SiO₂, Ca₂Mg(Si₂O₇), Ca₂SiO₄, and CaCO₃. In some embodiments, each of the plurality of oxides can be SiO₂, Al₂O₃, Fe₂O₃, FeO, Fe₃O₄, CaO, MgO, MnO₂, or MnO.

The reaction mixture can include any additives suitable for forming proppant particles of the desired composition. Suitable additives include, but are not limited to, C, Al, Si, Mg, K, Fe, Na, B, O, N, ZrO₂, Y₂O₃, and compounds thereof, volcanic ash, and aluminum dross.

The reactive atmosphere in which the reaction mixture is heated can include any reactive gas suitable for forming proppant particles of the desired composition. Suitable reactive atmospheres include, but are not limited to, N₂, O₂, air, CO₂, and combinations thereof. In some embodiments, the reactive atmosphere can be N₂.

The one or more reaction products included in the powder formed by heating the reaction mixture in the reactive atmosphere can have any suitable composition. In some embodiments, the one or more reaction products can be an oxide, a nitride, an oxynitride, a boride, or a carbide. In other embodiments, the reaction products can be Si_{6-z}Al_{z}O_{z}N_{8-z} where 0<z<5, Li₂SiN₂, CaSiN₂, MgSiN₂, MgB₂, Si₃N₄, or yttria-stabilized zirconia (YSZ). In some embodiments, the spherical particles can be characterized by magnetic properties.

The reaction mixture can be heated to any temperature below the melting point of the reaction mixture suitable for forming the desired one or more reaction products. In some embodiments, the reaction mixture is heated to a temperature of about 700 to 1,800° C. In other embodiments, the reaction mixture can be heated to a temperature of about 800 to 1,700° C., 900 to 1,600° C., 1,000 to 1,500° C., 1,100 to 1,400° C., or about 1,200 to 1,300° C.

In some embodiments, the plurality of oxides included in the reaction mixture are present in the form of waste stream material. Any waste stream material suitable for forming spherical particles of the desired composition can be used. Suitable waste stream materials include, but are not limited to, metallurgical slag such as air-cooled slag, pelletized slag, and granulated slag, and fly ash. In some embodiments, the waste stream material can be air-cooled slag. In other embodiments, the waste stream material can be pelletized slag. In still other embodiments, the waste stream material can be granulated slag. In yet other embodiments, the waste stream material can be fly ash. In still other embodiments, the waste stream material can be aluminum dross.

In some embodiments, the waste stream material comprises metallurgical slag and fly ash. Any ratio of metallurgical slag and fly ash suitable for forming spherical particles having the desired composition and morphology can be used. In some embodiments, the metallurgical slag and fly ash can comprise about 50-99% (w/w) and 1-50% (w/w), respectively, of the reaction mixture. In other embodiments, the metallurgical slag and fly ash can comprise about 1-50% (w/w) and 50-99% (w/w), respectively, of the reaction mixture. In yet other embodiments, the metallurgical slag and fly ash can comprise about 20-99% (w/w) and 1-80% (w/w), respectively, of the reaction mixture. In still other embodiments, the metallurgical slag and fly ash can comprise about 1-80% (w/w) and 20-99% (w/w), respectively, of the reaction mixture. In some embodiments, the metallurgical slag can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In other embodiments, the metallurgical slag can comprise about 5-50% (w/w), 10-50% (w/w), 15-50% (w/w), 20-50% (w/w), 25-50% (w/w), 30-50% (w/w), 35-50% (w/w), or about 40-50% (w/w) of the reaction mixture. In some embodiments, the fly ash can comprise about 5-50% (w/w), 10-50% (w/w), 15-50% (w/w), 20-50% (w/w), 50% (w/w), 30-50% (w/w), 35-50% (w/w), or about 40-50% (w/w) of the reaction mixture. In other embodiments, the fly ash can comprise about 50-95% (w/w), 50-90% (w/w), 50-85% (w/w), 50-80% (w/w), 50-75% (w/w), 50-70% (w/w), 50-65% (w/w), or about 50-60% (w/w) of the reaction mixture. In still other embodiments, the metallurgical slag and fly ash can comprise about 95% (w/w) and 5% (w/w), respectively, of the reaction mixture. In yet other embodiments, the metallurgical slag and fly ash can comprise about 80% (w/w) and 20% (w/w), respectively, of the reaction mixture.

In some embodiments, the one or more reaction products can comprise an oxide, and processing the powder can include contacting the one or more reaction products with an etchant to remove the oxide. For example, in some embodiments, the reaction mixture can include SiO₂ and a nitride additive such as Li₃N, Ca₃N₂, or Mg₃N₂. When heated in an N₂ reactive atmosphere, reaction products including silicon nitrides (e.g., LiₓSi_{y}N₂, CaSiN₂, or MgSiN₂) and oxides (e.g., Li₂O, CaO, or MgO) can be formed. If the silicon nitride is the desired material, the oxide reaction product can be removed using an etchant. In some embodiments, etchants can be used to remove non-oxide reaction products, in addition to any remaining oxides and other materials that were present in the reaction mixture prior to heating. Any etchant suitable for removing undesired material in the formed powder while preserving the desired material can be used in some embodiments. Suitable etchants include, but are not limited to, hydrochloric acid, hydrofluoric acid, sodium hydroxide, phosphoric acid, nitric acid, and ammonium fluoride.

In some embodiments, processing the powder can include heating the powder in a non-reactive atmosphere to a temperature above the melting point of the powder to form a melt, and allowing the melt to solidify in a mold, the solidified melt being in the form of the spherical particles.

The mold can comprise any suitable material on which spherical particles form upon solidification. In some embodiments, the mold can comprise graphite or molybdenum. In other embodiments, the mold can comprise graphite In yet other embodiments, the mold can comprise a refractory material (e.g., alumina) coated with graphite or molybdenum. The mold can have any suitable dimensions. In some embodiments, the mold can comprise cylindrical holes in which the melt solidifies to form the spherical particles. In some embodiments, the melt can be introduced into the mold and then allowed to solidify. For example, the melt can be prepared in a separate crucible and then dripped into cylindrical holes of the mold where the melt cools and solidifies to form the spherical particles. In other embodiments, the formed powder comprising the one or more reaction products can be introduced into the mold in solid form and then heated. For example, the powder can be loaded into cylindrical holes of the mold where the powder is then heated to form a melt, cooled, and solidified to form the spherical particles.

In some embodiments, processing the powder can include forming a slurry comprising the powder, coating templating particles with the slurry, and heating the coated templating particles to consume the templating particles and form the spherical particles. Any suitable templating particle material and heating temperature can be used. In some embodiments, the templating particles can comprise a material that is glass, polystyrene, or cellulose, and the coated templating particles can be heated to a temperature of about 60 to 500° C. to form the spherical particles comprising a hollow core. In some embodiments, the templating particles can comprise glass. In some embodiments, the templating particles can comprise polystyrene. In some embodiments, the templating particles can comprise cellulose. For example, the templating particles can comprise walnut shell. In some embodiments, the coated templating particles can be heated to a temperature of about 100 to 450° C., 150 to 400° C., 200 to 350° C., or about 250 to 300° C. to form the spherical particles comprising the hollow core. In other embodiments, the coated templating particles can be heated to a temperature of about 60° C. to form the spherical particles comprising the hollow core. In still other embodiments, the coated templating particles can be heated to a temperature of about 300° C. to form the spherical particles comprising a hollow core. In yet other embodiments, the coated templating particles can be heated to a temperature of about 500° C. to form the spherical particles comprising the hollow core. In some embodiments, the spherical particles comprising the hollow core can be sintered at a temperature of about 500 to 2,000° C. in a reactive atmosphere comprising N₂, O₂, air, CO₂, or combinations thereof. In some embodiments, the spherical particles comprising the hollow core can be sintered at a temperature of about 600 to 1,900° C., 700 to 1,800° C., 800 to 1,700° C., 900 to 1,600° C., 1,000 to 1,500° C., 1,100 to 1,400° C., or about 1,200 to 1,300° C.

In some embodiments, the method can further include coating the spherical particles with a material that can be an organic, nitride, or ceramic material. The coating may promote containment of fines formed as the result of fracture stresses crushing the spherical particles in operation. Suitable organics include, but are not limited to, phenolic polymers and polyurethane.

The spherical particles can have any specific gravity suitable for induced hydraulic fracturing applications. Suitable specific gravities can be close to that of water (i.e., “1”). In some embodiments, the spherical particles can be characterized by a specific gravity of about 1.1 to 1.6, 1.2 to 1.5, or about 1.3 to 1.4. In other embodiments, the spherical particles can be characterized by a specific gravity of about 1.0 to 1.3.

The spherical particles can have any diametral strength suitable for induced hydraulic fracturing applications. In some embodiments, the spherical particles can have a diametral strength of at least about 10,250 psi, 10,500 psi, 10,750 psi, 11,000 psi, 11,250 psi, 11,500 psi, 11,750 psi, 12,000 psi, 12,250 psi, 12,500 psi, 12,750 psi, 13,000 psi, 13,250 psi, 13,500 psi, 13,750 psi, or at least about 14,000 psi.

The spherical particles can have any porosity suitable to attain the desired diametral strength and specific gravity. In some embodiments, the spherical particles are characterized by a porosity of about 10 to 60%. In other embodiments, the spherical particles are characterized by a porosity of about 13 to 57%, 16 to 54%, 19 to 51%, 22 to 48%, 25 to 45%, 28 to 42%, 31 to 39%, or about 34 to 36%. In some embodiments, the spherical particles can comprise a hollow core.

The spherical particles can have any size suitable to attain the desired diametral strength, specific gravity, and fracture particle distribution. In some embodiments, the spherical particles are characterized by a diameter of about 0.1 to 1.7 mm. In other embodiments, the spherical particles are characterized by a diameter of about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles are characterized by a diameter of about 0.3 to 0.7 mm. In some embodiments, at least about 80% of the spherical particles are characterized by a diameter within 20% of the average diameter of the spherical particles. In some embodiments, the spherical particles are characterized by a sphericity of about 0.7 to 1.0. In other embodiments, the spherical particles are characterized by a sphericity of about 0.8 to 1.0. In yet other embodiments, the spherical particles are characterized by a sphericity of about 0.9 and 1.0.

### IX. Examples

Aspects may be further understood by the following non-limiting examples.

### Example 1

### Producing Proppant Material from Direct Melt Processing of Waste Stream Materials

This example provides a method according to some embodiments of producing a proppant material in the form of spherical beads by direct melting of oxide-rich waste stream materials.

Various ratios and morphologies of waste stream materials were used, including blast furnace slag (from ArcelorMittal) and fly ash with low CaO concentrations, “low-Ca fly ash,” (from Boral). The powder samples included the following compositions by weight: 80% air-cooled slag/20% low-Ca fly ash, 95% air-cooled slag/5% low-Ca fly ash, 100% air-cooled slag, 100% pelletized slag, and 100% granulated slag. Prior to melting, the powder samples were ball milled for about 15 minutes using steel ball bearings in a steel vial and using a SPEX high energy ball mill.

Melting was carried out in a graphite crucible including round bottom holes that were machined to have a diameter of approximately 1.5 mm. The milled powder samples were placed in the holes in various amounts to achieve target bead diameters in the range of approximately 0.5 to 1.5 mm. The powders were pre-heated to temperatures in the 60 to 700° C. range in near-vacuum conditions using an RF induction coil, and then melted under nitrogen cover gas using the RF induction coil to temperatures of approximately 1200 to 1600° C. The time at maximum temperature ranged from approximately 20 seconds to 2 minutes.

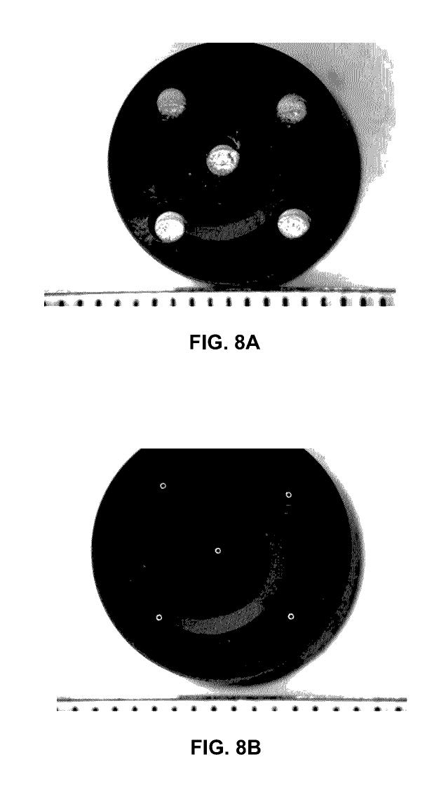

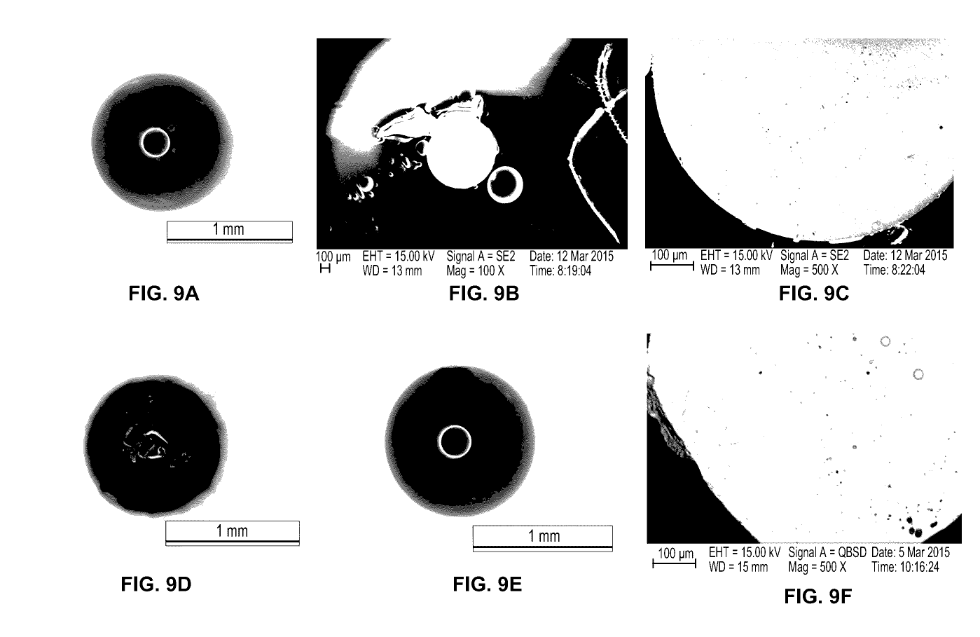

FIGS. 8A-8B show an exemplary powder sample before and after melting. FIG. 8A shows the graphite crucible with the powder loaded before melting, FIG. 8B shows the spherical beads in the graphite crucible holes after melting. FIGS. 9A-9F show exemplary molten beads. FIG. 9A shows an optical photograph of a single molten bead comprising 80% (w/w) air-cooled slag and 20% (w/w) low-Ca fly ash, FIG. 9B shows an SEM cross-sectional image of the molten bead, and FIG. 9C shows a close-up SEM cross-sectional image of the molten bead. FIGS. 9D-9E show optical photographs of molten beads comprising 100% (w/w) pelletized slag, and FIG. 9F shows a cross-sectional SEM image of a molten bead comprising 100% (w/w) pelletized slag.

The molten beads appeared to be non-reactive with graphite, with sphere formation occurring due to the surface energy of the melt being relatively high as compared to the graphite, thereby resulting in non-wetting conditions.

A diametral compression test was used to measure the fracture strength of the spherical beads formed from the various ratios and morphologies of waste stream material. This test involved crushing individual proppant beads between two platens. The diametral strength of each bead was calculated using the following equation:

$$\frac{Failure Load \times 1.4}{2 \times π \times bead {radius}^{2}}$$

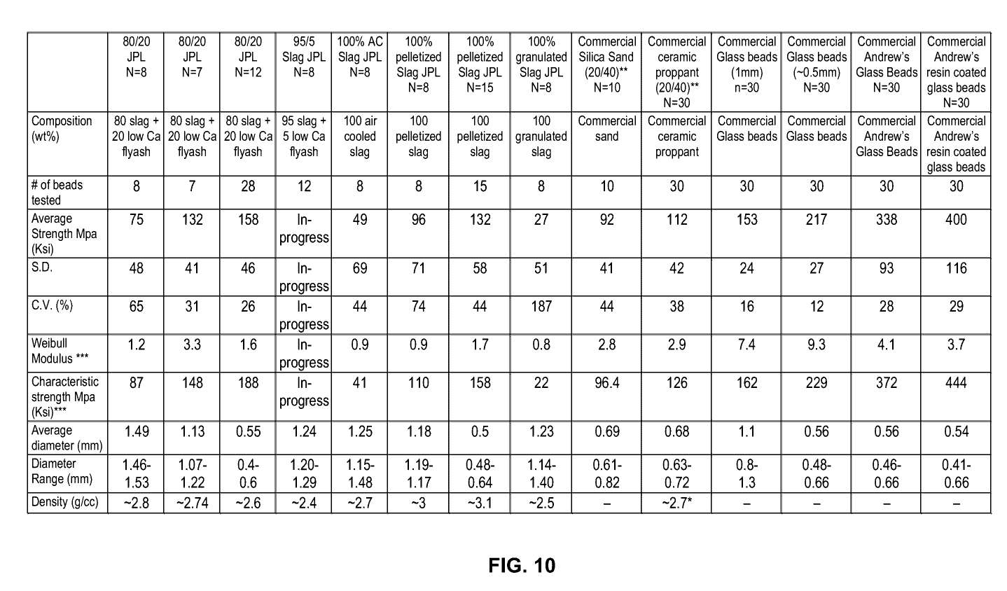

FIG. 10 shows a table of spherical bead compositions, diameters, and strength measurements for the tested samples formed from waste stream materials. Commercially available silica, ceramic, and glass proppants were also tested, and the resulting data for these materials is shown in FIG. 10 for purposes of comparison.

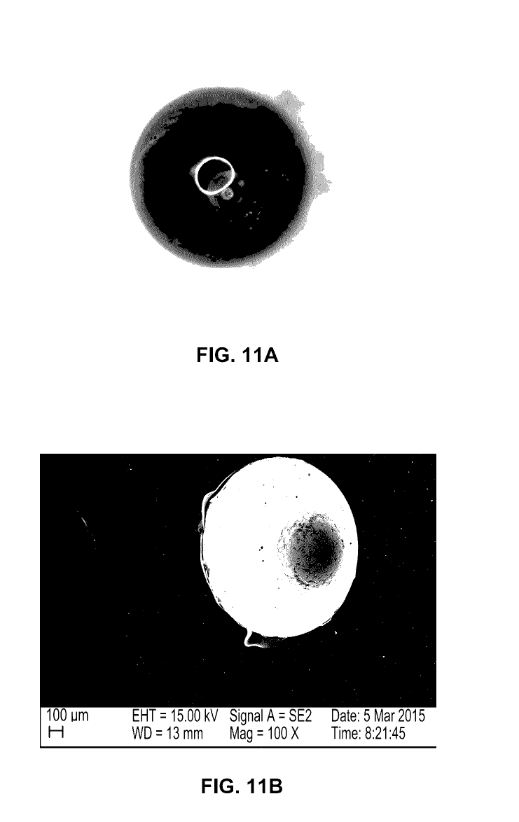

The morphology of the formed beads varied based on the waste stream material ratios used for each samples. For example, samples including 100% air-cooled slag and 80% air-cooled slag/20% low-Ca fly ash were characterized by a more solid, less porous composition. Surprisingly, samples including 95% air-cooled slag/5% low-Ca fly ash formed hollow beads upon solidification. Without being bound to any particular theory, the void may be formed by a gas releasing chemical reaction whose origin is likely in the low-Ca fly ash. The samples with higher concentrations of low-Ca fly ash expanded and then contracted due to the beads bursting. In contrast, such bursting was not observed during solidification of the beads including only 5% low-Ca ash, with the gaseous reaction product instead forming a hollow core. FIG. 11A shows a photograph of a hollow spherical bead, and FIG. 11B shows a cross-sectional SEM image of the bead and hollow core. Additionally, some of the formed beads were characterized by a composite-like structure as seen in FIG. 9D and FIG. 9F.

It was also surprisingly discovered that the solidified beads demonstrated magnetic properties. Without being bound by any particular theory, the magnetism of the beads may be due to Fe₃O₄ phases forming during solidification. Such magnetic properties may be useful as a tracer to detect the position and distribution of proppant particles in a hydraulically induced fracture.

### Example 2

### Producing Proppant Material from Reaction Product Initiation

This example provides a method according to some embodiments of producing a proppant material comprising MgSiN₂ using low-Ca fly ash and Mg₃N₂ additives.

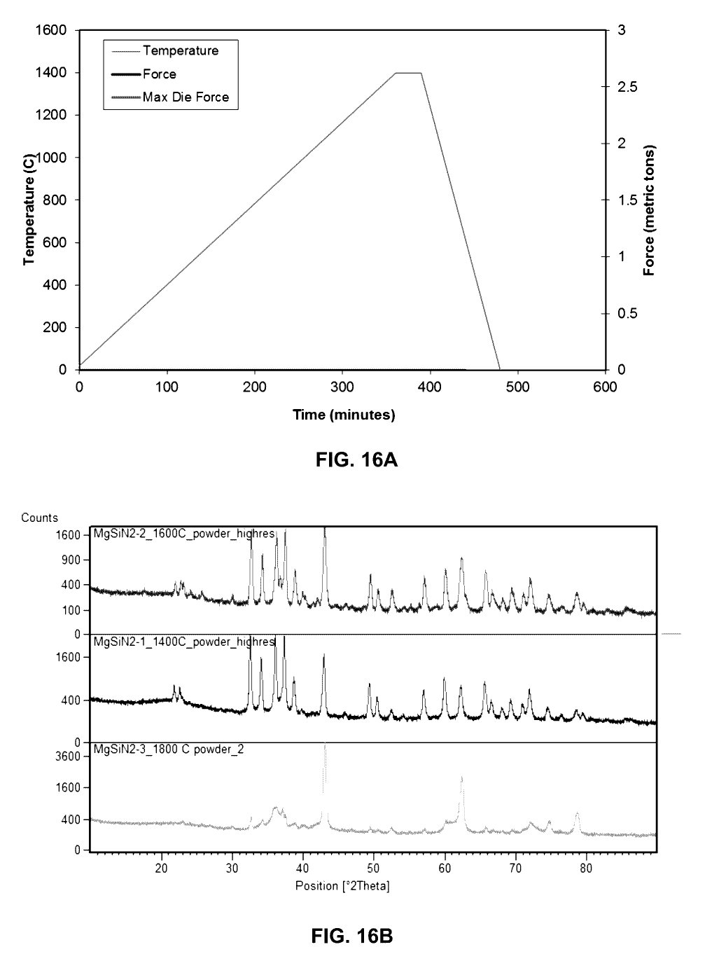

Low-Ca fly ash containing SiO₂ was mixed in stoichiometric amount with Mg₃N₂. The mixture was ball milled for one hour to homogenize using a SPEX high energy mixer mill with 2 7/16″ tungsten carbide ball bearings. The homogenized powder was then loaded into a graphite die and cold pressed. The die was then loaded into a hot press with no additional force applied and then heated in a nitrogen atmosphere. The hot press profile for the heating is shown in FIG. 16A. During heating, the following reaction occurred in the material:

Mg₃N₂+SiO₂ (from fly ash)→MgSiN₂+MgO

As shown in FIG. 16B, XRD characterization data indicated the presence of the target MgSiN₂ in the material after heating. The MgO reaction product was etched using 1M HCl in a process involving two cycles of stirring for 15 to 60 minutes, centrifuging, and decanting of the supernatant.

### Example 3

### Producing Proppant Material from Reaction Product Initiation by Vacuum Drying and Templating Processes

This example provides a method according to some embodiments of producing a proppant material in the form of spherical beads comprising Si_{6-z}Al_{z}O_{z}N_{8-z} precursors using low-Ca fly ash and Al₂O₃ additives, the method including vacuum drying and templating processes.

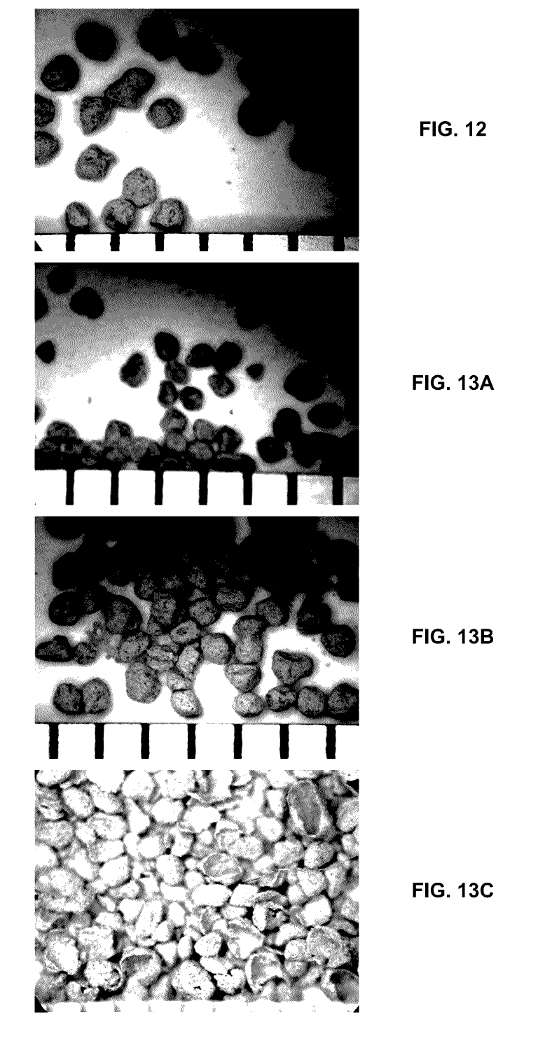

Walnut shells having a size of 200 to 700 microns were etched with 6M HCl. The etched walnut shells were then coated in a slurry comprising water and 1% (w/w) polyacrylamide. A 50/50 (w/w) mixture of low-Ca fly ash and Al₂O₃ were mixed and ball milled using a SPEX high energy mixer mill to form a powder mixture. The coated walnut shells were then dry coated with the fly ash/Al₂O₃ powder by rolling the coated walnut shells in the powder. The dry-coated walnut shells were dispersed in an SiO₂ sol-gel mixture comprising tetraethylorthosilicate (or silanol terminated polymer), water, and an ammonium hydroxide catalyst, and then dried in a vacuum oven at 60° C. for approximately 2 hours to remove the solvent. FIG. 12 shows the beads post-drying. Upon heating the formed beads to temperatures around 1,400° C. in a reactive environment (e.g., N₂), the precursors can react to from Si_{6-z}Al_{z}O_{z}N_{8-z} with the heat burning off the walnut shell core, thereby forming hollow proppant particles comprising Si_{6-z}Al_{z}O_{z}N_{8-z}.

### Example 4

### Producing Proppant Material from Reaction Product Initiation by Controlled Thermal Treatments and Templating Processes

This example provides a method according to some embodiments of producing a proppant material in the form of spherical beads comprising Si_{6-z}Al_{z}O_{z}N_{8-z} precursors using low-Ca fly ash and Al₂O₃ additives, the method including controlled thermal treatments and templating processes.

Walnut shells 500 microns in size were etched with 6M HCl. Uncoated walnut shell particles are shown in FIG. 13A. A 50/50 (w/w) mixture of low-Ca fly ash and Al₂O₃ was prepared separately by ball milling using a SPEX high energy mixer mill to form a powder mixture. A 4% (w/w) high MW methyl cellulose polymer was added to the precursor mixture, and the precursor/polymer mixture was dry-coated coated onto the etched walnut shells via shear mixing. An SiO₂ sol-gel coating was then applied and the coated shells dried in a similar fashion as described above in Example 3. The resulting coated particles are shown in FIG. 13B.

A heat treatment was then performed under nitrogen cover gas in which the coated particles were heated from room temperature up to 200° C. at 5° C./minute, then ramped up to 300° C. at 1° C./minute and then held at 300° C. for approximately 30 minutes. As shown in FIG. 13C, the resulting material included coated hollow shells due to the walnut shells being burned off during the controlled thermal treatments.

### Example 5

### Producing Proppant Material from Reaction Product Initiation by Annealing and Templating Processes

This example provides a method according to some embodiments of producing a proppant material in the form of spherical beads comprising Si_{6-z}Al_{z}O_{z}N_{8-z}, the method including annealing and templating processes.

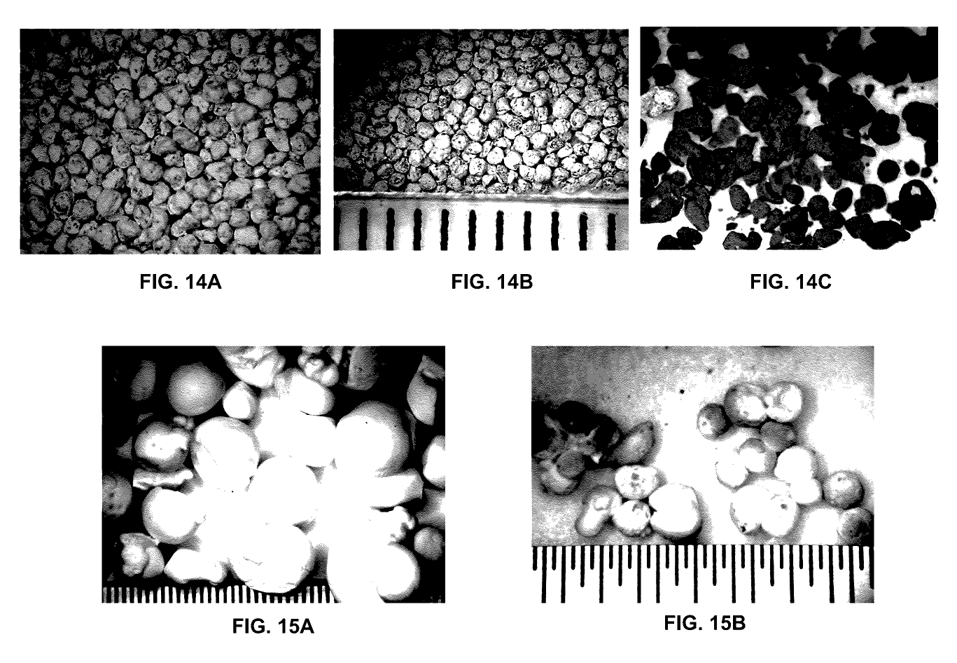

Similar to Example 4, walnut shells 500 microns in size were etched with 6M HCl. A mixture of Si_{6-z}Al_{z}O_{z}N_{8-z} powder and 4% (w/w) high MW methyl cellulose polymer was prepared, and then dry-coated coated onto the etched walnut shells via shear mixing. The coated shells were dried in a similar fashion as described above in Example 3. The resulting coated particles are shown in FIG. 14A.

Multiple annealing treatments were then performed under nitrogen cover gas in which one sample of coated particles was heated from room temperature up to 300° C. at 30° C. minute, held at 300° C. for approximately 30 minutes, and then cooled down to room temperature at 8° C./minute. Another sample of coated particles was heated from room temperature up to 500° C. at 30° C. minute, held at 500° C. for approximately 30 minutes, and then cooled down to room temperature at 8° C./minute. The Si_{6-z}Al_{z}O_{z}N_{8-z} proppant beads heated to 300° C. are shown in FIG. 14B, and the Si_{6-z}Al_{z}O_{z}N_{8-z} proppant beads heated to 500° C. are shown in FIG. 14C.

### Example 6

### Producing Proppant Material by Rapid Freezing

This example provides a method according to some embodiments of producing a proppant material in the form of spherical beads comprising Si_{6-z}Al_{z}O_{z}N_{8-z}, the method including rapid freezing processes.

A suspension was prepared comprising Si_{6-z}Al_{z}O_{z}N_{8-z}, 1% (w/w) methyl cellulose polymer, and water. Beads of SiAlON were dropped directly into liquid nitrogen and then immediately vacuum dried at 200° C. The dried beads are shown in FIG. 15A, which were then heated in the vacuum oven from room temperature to 250° C. at 5° C./minute, heated from 250° C. to 350° C. at 1° C./min, and held at 350° C. for about 30 minutes. The beads were then further heated in a hot press and under nitrogen cover gas from 350° C. to 1,750° C. at 5° C./minute, held at 1,750° C. for approximately 30 minutes, and then cooled down to room temperature at 10° C./minute. The resulting Si_{6-z}Al_{z}O_{z}N_{8-z} proppant beads are shown in FIG. 15B.

### Example 7

### Synthesis of Ceramic Materials Using Waste Streams

This example details the synthesis of ceramic materials using both high purity precursors as well as waste stream precursors for the synthesis of alkali/alkaline earth silicon nitrides and SiAlON. Reaction pathways are discussed below.

Alkali/Alkaline Earth Silicon Nitrides.

Alkali/alkaline earth (AE) silicon nitrides possess crystal structures that are similar to refractory ceramic alpha silicon nitride. Silicon nitride was selected as a useful proppant material in an initial pre-study based upon porosity/strength models, and the similar structure of the AE silicon nitrides is also useful for possessing similar properties. Since the synthesis of pure silicon nitride is well known to be extremely challenging, the AE analogs are investigated as alternate materials.

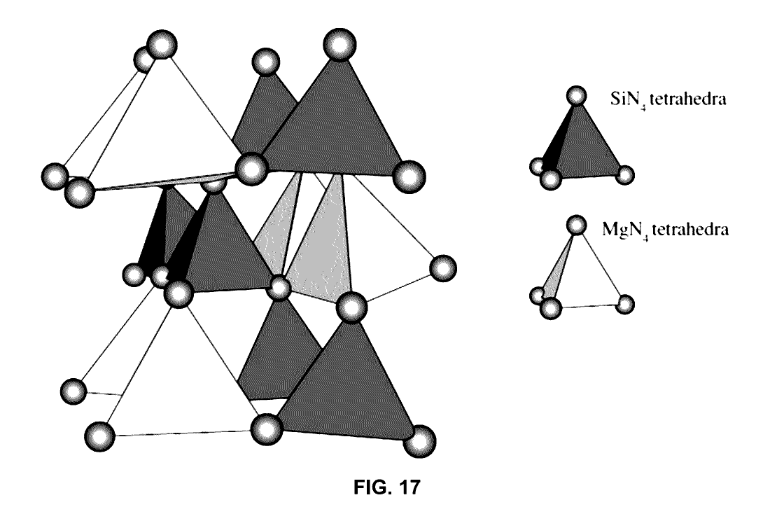

The structure is made up of alternating layers of corner sharing AE₃N₂ (AE=Mg, Ca) and Si₃N₄ tetrahedra as illustrated in FIG. 17. AE silicon nitrides were originally found as byproducts of an attempt to facilitate the synthesis of Si₃N₄. The synthesis of AESiN₂ may be conducted via the heating of a mixture of AE₃N₂ and Si₃N₄ at elevated temperatures (>1200° C.) for several days.

Synthesis of Alkali/Alkaline Earth Silicon Nitrides.

Solid State Metathesis Synthesis of Alkali/alkaline earth silicon nitrides. Solid state metathesis (SSM) reactions offer an useful method of synthesizing AE silicon nitrides. SSM reactions are highly exothermic double displacement reactions of reactive precursors. The reactions are driven not only by the formation of the product but also the formation of a thermodynamically favorable salt. Thus these reactions offer a potentially low energy pathway to the production of AESiN₂.

Thermochemistry Analysis of SSM AE Silicon Nitrides.

The synthesis of MgSiN₂ using the SSM technique may proceed according to the following reaction scheme:

Mg₃N₂+SiO2→MgSiN₂+MgO with a Gibbs free energy of −910 kJ/mol

Similarly, the when the Mg₃N₂ precursor is changed to Ca₃N₂ the reaction is also thermochemically favorable with a reaction Gibbs free energy of −270 KJ/mol.

According to one embodiment, a homogenous mixture of the precursor powders may be created, then the powders compacted into green body pellets. The reaction may be initiated, for example, using an oxy-hydrogen torch which applied to the compact for several seconds. Since SSM reactions propagate as a result of a phase change or change in state in the material, when the torch is applied it may trigger the initial or partial decomposition of the Mg₃N₂ (decomposition point 1080° C.) which may reduce the activation energy needed for the product formation and allow for propagation of the reaction (self-propagating reaction). The role of the precursor materials themselves may the influence of the product formation. For example, rice hull ash may be a potential SiO₂ source instead of reagent grade SiO₂. Rice hull ash is a byproduct of the rice industry and is effectively a waste stream of SiO₂. The reaction may readily yield MgSiN₂ as the main product with some secondary impurity phases.

Precursor Synthesis.

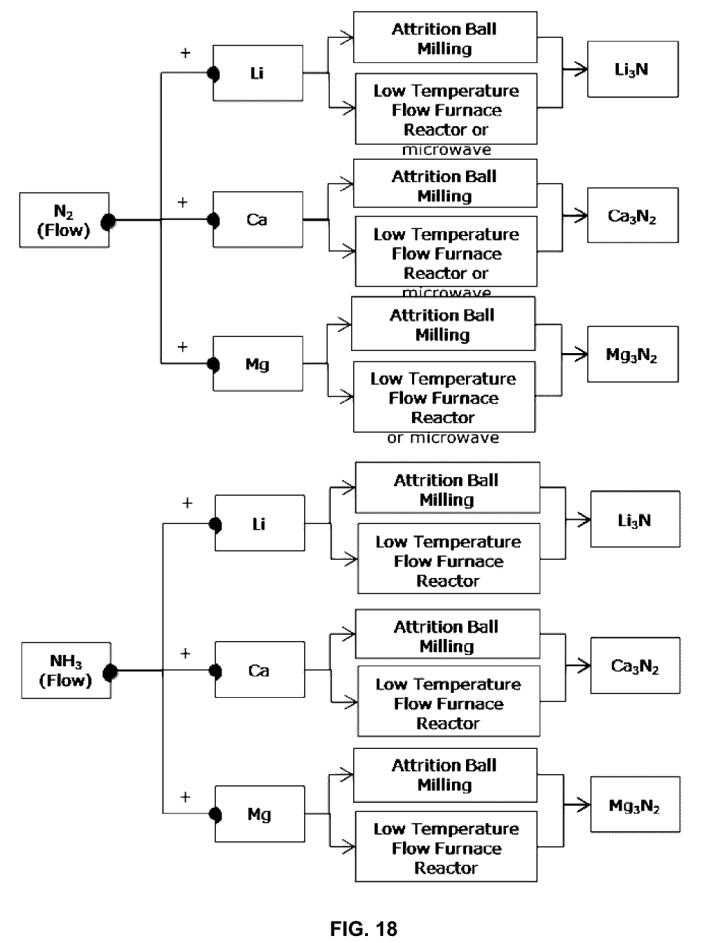

The first step in the synthesis of AE silicon nitrides for large scale use is the synthesis of the reactive alkali/alkaline earth metal precursors (i.e., Ca₃N₂, Mg₃N₂). FIG. 18 is a schematic flow diagram for the synthesis of the AE nitrides. These precursors may be formed in a flow furnace under a high pressure nitrogen flow. In some embodiments, extended and multiple heat treatments are may be used to ensure homogeneity of the nitride product. An alternative approach that may utilize attrition ball milling to synthesize the materials.

The attrition ball milling process is a mechanochemical approach to synthesizing large quantities of materials (100s of kilograms). In this technique, precursor materials are loaded into the milling vessel along with the milling media (typically stainless steel bearings) and an agitator. A cover gas/gas flow can be introduced if the product or reaction requires it. The products are formed as a result of the kinetic energy transfer of the agitated milling media to the materials in the form of chemical work. The milling process serves to increase the surface area of the materials as well as translate the kinetic energy from the ball media impacts into chemical work. This approach is useful with a variety of materials such as cellulose, Mg₂Si, La₃Te₄ etc. One advantage to this approach is that the reaction and processing times (and energy) is significantly reduced, thereby allowing for a significant amount of cost savings.

An approach in the synthesis of the AE nitrides is as follows: the reactive metal (20-100 grams) is loaded into the attrition mill vessel and agitator along with the media. A nitrogen flow (e.g., at 80 psi) may be introduced and the agitator set to run (e.g., at 800 RPM for 2-8 hours). A resulting black powder has been observed using this process. A test to confirm or at least indicate the formation of the AE nitride is to test for the formation of ammonia gas. Upon contact with water, the AE nitrides form ammonia and the AE oxide salt. XRD for the formed material may show broad amorphous peak due to the increased surface area of the material from the milling process, however, it may also show crystalline peaks that can be identified to match that of the desired AE nitride precursor. Thus, this process provides an alternate and potentially lower cost route to the synthesis of the AE nitride precursors.

Synthesis of the AE Silicon Nitrides.

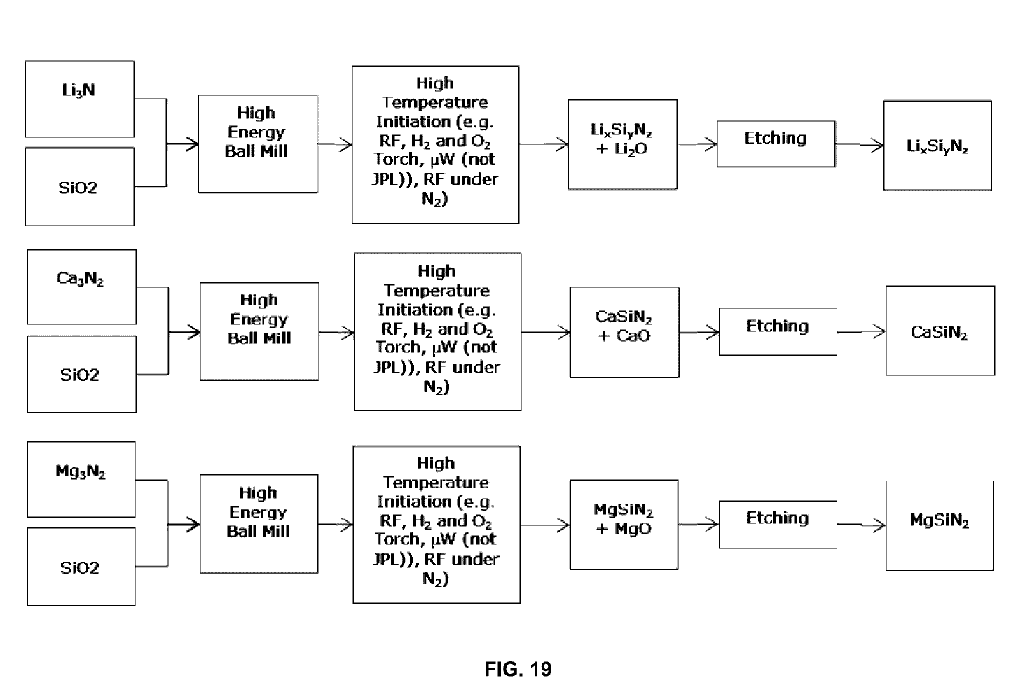

The general flow diagram schematic for the synthesis of AE silicon nitrides is outlined in FIG. 19. The process may involve mixing of the precursor materials (AE nitride+“SiO₂” source), which may be first homogenized via high energy ball milling to ensure uniform reaction conditions. Reactions using SiO₂ waste stream sources is detailed below. Since the reactions are driven by the thermodynamic stability of the salt product, various reaction initiation methods were evaluated to better understand the reaction kinetics.

Reaction Initiation Methods.

Several reaction initiation methods were explored. The methods included extended ball milling of the precursor materials, reaction initiation via oxy-hydrogen torch, reaction initiation via RF input, and reaction initiation via high temperature hot pressing.

Extended Ball Milling.

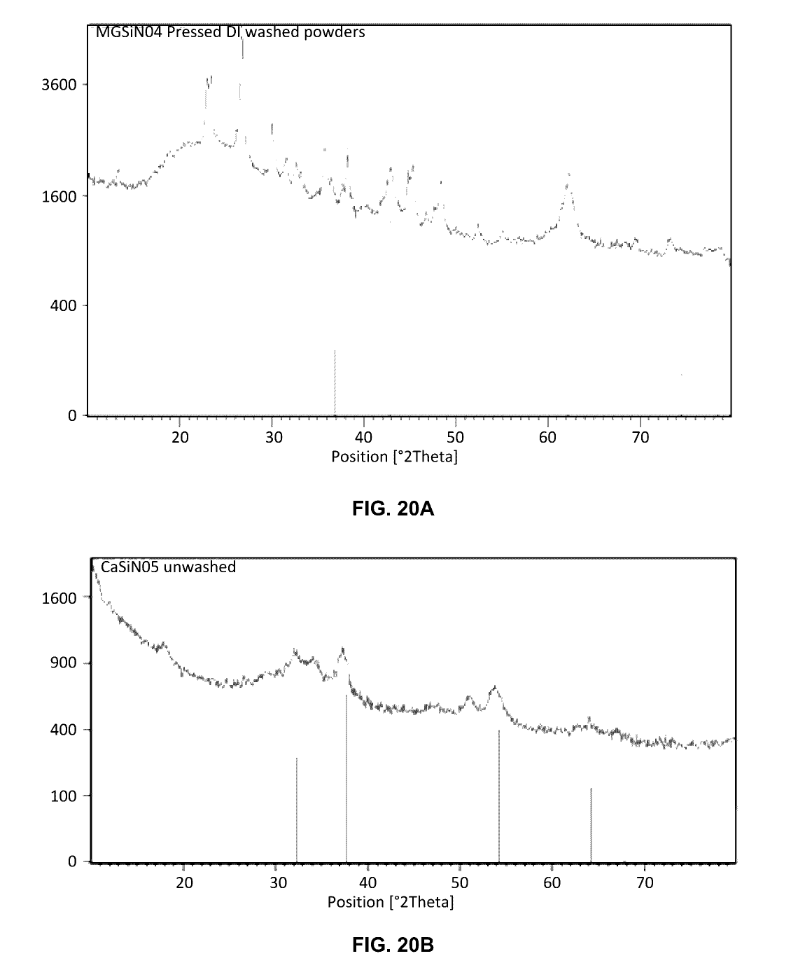

In the extended ball milling approach, the precursor materials were loaded into a ball mill vial sealed in an inert atmosphere. The vial was then loaded into a ball mill, Spex 3000D, and the powder mixture was ball milled for several hours. The ball milling method of reaction initiation has been successful in the synthesis of several materials systems such as nanostructured silicon and is thought of as a “low” energy approach. In the case of the AE silicon nitrides, this did not yield the desired orthorhombic AE silicon nitride phases; instead, the preliminary analysis of the XRD data indicates that new higher order AE silicon nitrides may have been formed, as alkaline earth and SiO₂ precursors are not detected, and the formation of the AE oxide salt is, thereby demonstrating a reaction took place. FIG. 20A and FIG. 20B respectively provide representative XRD of the MgSiN₂ and CaSiN₂ product using this approach. The orthorhombic phase of the (Mg/Ca)SiN₂ is not detected; however, the resulting salts, MgO or CaO, are and are indexed, indicating that a reaction took place and may be leading to an intermediate higher order structure. As a result of this brief investigation, it was determined that other techniques may be useful with direct ball milling for producing the AE silicon nitrides.

Oxy-Hydrogen Torch Initiation.

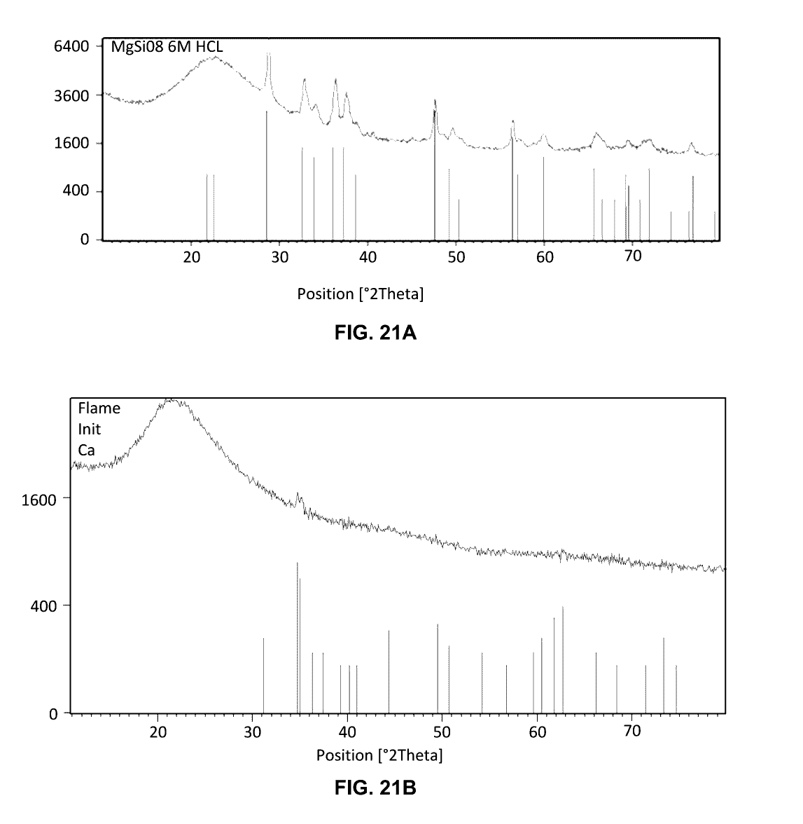

In this reaction initiation technique, the precursor materials are ball milled for 30 minutes to homogenize the powder mixture. The mixture is then cold-pressed into green body billets under an inert atmosphere. The billets are removed from the glove box and subjected to an oxy-hydrogen torch for several seconds to initiate the reaction. Since SSM reactions are high temperature, exothermic, self-propagating reactions, the reactants only needed a few seconds exposure to initiate the reaction. FIG. 21A and FIG. 21B show typical XRD of the products. This method successfully yielded the desired products, MgSiN₂ (FIG. 21A) and CaSiN2 (FIG. 21B). However, the consistency of the results may be impacted by the length of time that the reaction mixture is exposed to the flame. The results may also be impacted by the reaction scale, as initiating the reaction with pellets that are larger than a few millimeters in height may require additional energy input. This may result from reduced intimate contact of the precursor materials from the cold pressing process, which may reduce the heat transfer between the materials. In some circumstances, the products may have poor crystallinity as well.

RF Initiation.

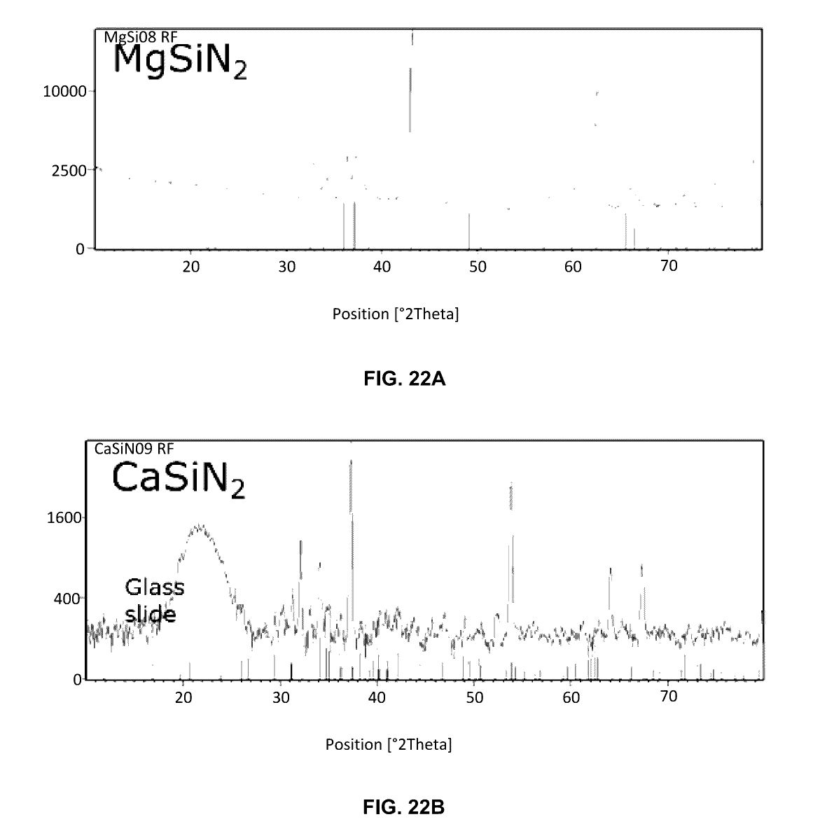

From the observations from the oxy-hydrogen torch initiation and lessons learned that a steady high temperature input is necessary to produce the desired product, RF initiation was investigated as method of rapid reaction initiation heating. In this process, the homogenized precursor powders are cold pressed and put into graphite crucibles. Although the precursor materials themselves may not be susceptible to RF, the graphite crucible is. Therefore, the RF is useful as a means of rapid, high temperature thermal input to initiate the reaction. The RF may be slowly ramped up to a temperature ˜1200° C. (as measured by a pyrometer) and held there for a few seconds and then subsequently quenched. The reaction may produce a white “smoke,” which is common to successful metathesis reactions. The “smoke” may actually be the salt in a vapor state, which indicates the completion of the successful reaction initiation. XRD analysis of the Mg and Ca reactions (FIG. 22A and FIG. 22B) revealed that the products of the reaction was the desired AESiN₂ phase and the respective AEO salts. Acid etching of the salts using 6 M HCl, yielded high purity, AESiN₂ product. Subsequent reactions using this process also reproducibly yielded the AESiN₂ product. The RF initiation demonstrates that a short period high energy input is useful for propagating these reactions.

Furnace Initiation.

Another method of reaction initiation investigated is was the use of high temperature hot pressing. In this approach, the homogenized powder is loaded into graphite dies and cold pressed in the die. The die is then loaded into the hot press with no additional pressure/force and the die heated to temperatures of 1400, 1600, 1800° C., etc. Effectively the die serves as a containment vessel and the hot press is a high temperature furnace. A useful temperature profile is shown in FIG. 16A. The temperature may be ramped 10 degrees/min to the respective temperatures and then held there for 30 minutes to ensure thermal equilibrium. The die may then be cooled to ambient temperature and the compact extracted.

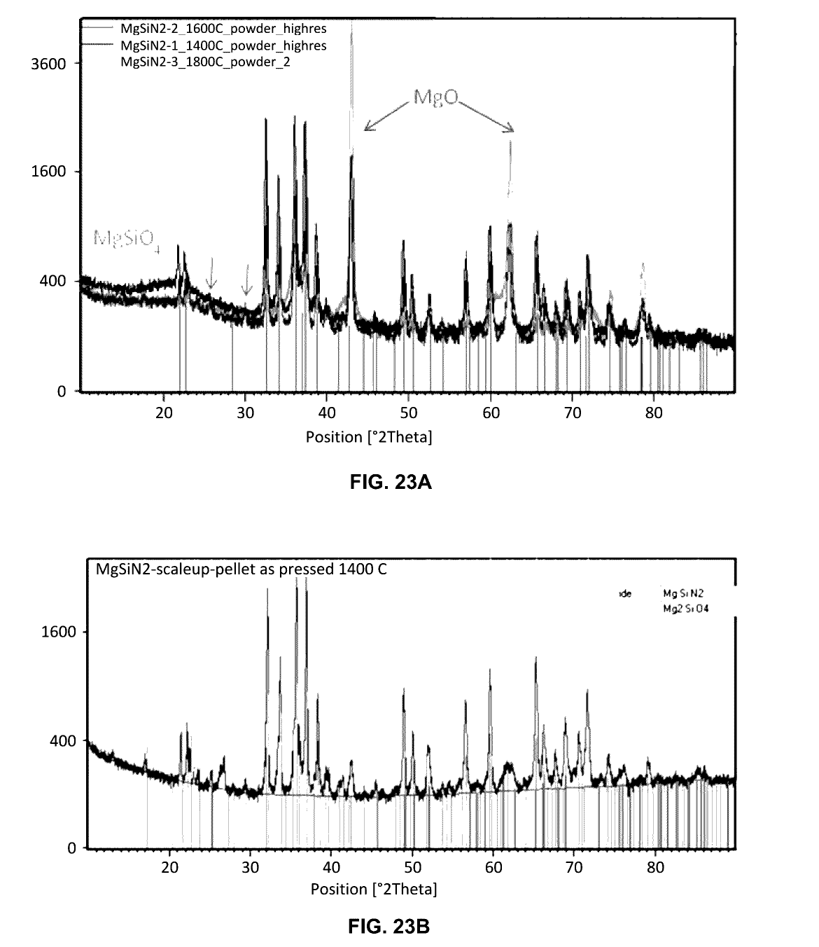

The resulting pellets from experiments may then be etched with acid to remove the salt product. FIG. 16B, FIG. 23A and FIG. 23B show the XRD of the MgSiN₂ reaction products at the various initiation temperatures. It was found that with temperatures as low as 1400° C., the optimized reaction conditions (see Table 1) may yield crystalline MgSiN₂ and some residual MgO impurities. The higher temperatures may also yield MgSiN₂ but with increasing MgSiO₄ impurities may be observed, likely due to partial decomposition of the MgSiN₂ product in the presence of oxides. Since the 1400° C. reaction yielded the ideal MgSiN₂ product, the reaction was scaled up to 10 grams to and isolated in order to obtain enough material to be densified into compacts for mechanical testing.

TABLE 1
A summary of the idealized reaction conditions
using the pure precursor materials.

| Reaction | Temperature |
|---|---|
| Mg₃N₂ + SiO₂ | 1400° C. |
| Ca₃N₂ + SiO₂ | 1200° C. |

SSM Synthesis of AE Silicon Nitrides Using Waste Stream Precursors.

The accommodation of waste stream materials may be useful as a SiO₂ source, since waste stream synthesis of Mg₃N₂ and/or Ca₃N₂ have not been fully identified. Potential sources for the Ca and Mg sources to form the respective nitride precursors include the processing of Mg and Ca metal may be harvested from residual salts from sea water desalination plants. Ideally, the metals may be isolated via electrolysis and then subsequently processed into the nitride precursor.

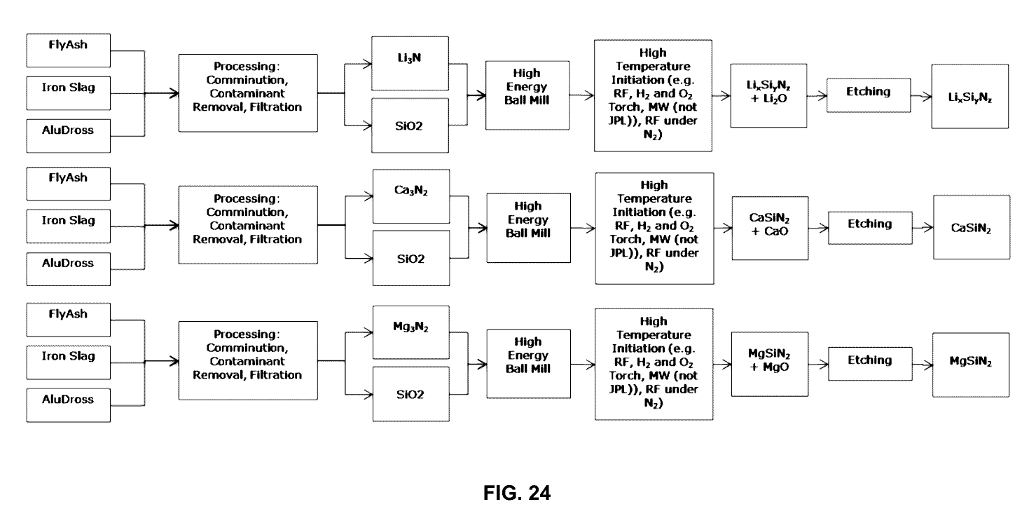

FIG. 24 outlines the synthesis of the AE silicon nitrides using the waste streams with the following sections focusing on MgSiN₂

MgSiN₂ Synthesis from Waste Streams. MgSiN₂ Synthesis from Pumice.

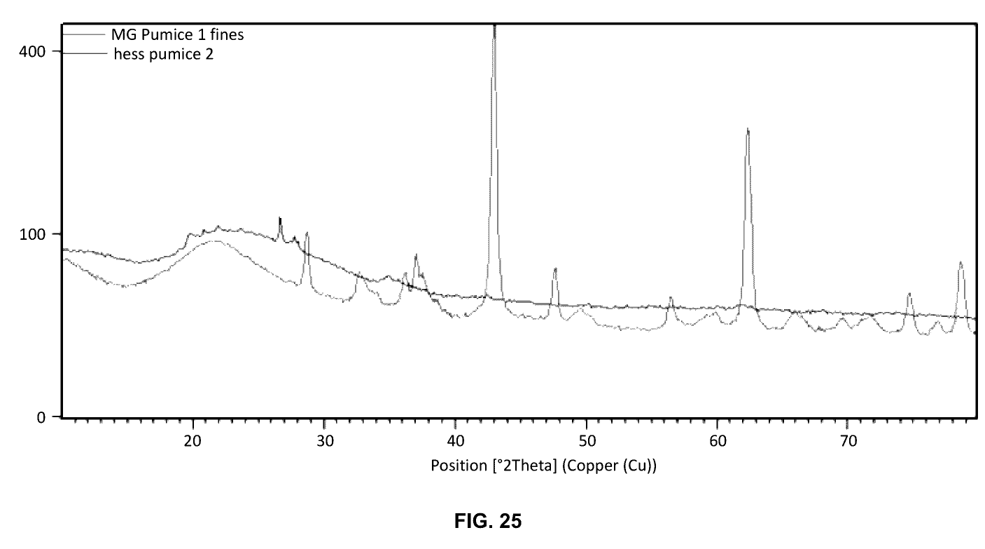

The SiO₂ content of the pumice may be a useful reactant. It was assumed that the silica content of the pumice was ˜75% (weight from XRF/XRD analysis). The pumice material is ball milled with the magnesium nitride precursor and the reaction initiated at 1400° C. FIG. 25 compares the pumice precursor with the reaction product before washing, and it is evident that the waste stream materials have been transformed from a somewhat amorphous phase into a crystalline phase.

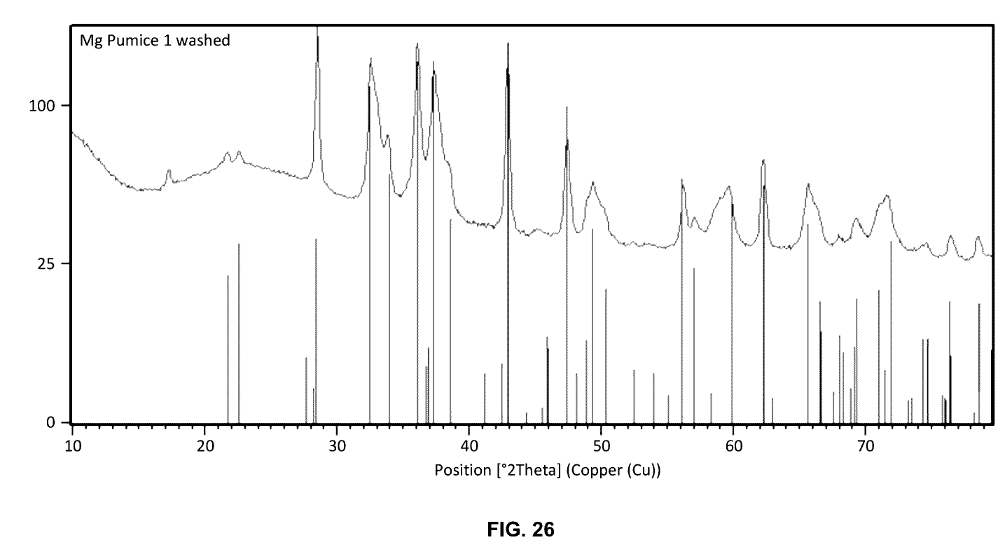

FIG. 26 shows the waste stream product XRD after acid etching to remove the residual salt. The XRD shows that the target MgSiN₂ phase exists as well as some iron silicide. There is some small residual MgO that remains as well. The residual MgO is thought to be trapped into the porous structure.

Synthesis of MgSiN₂ from Slag.

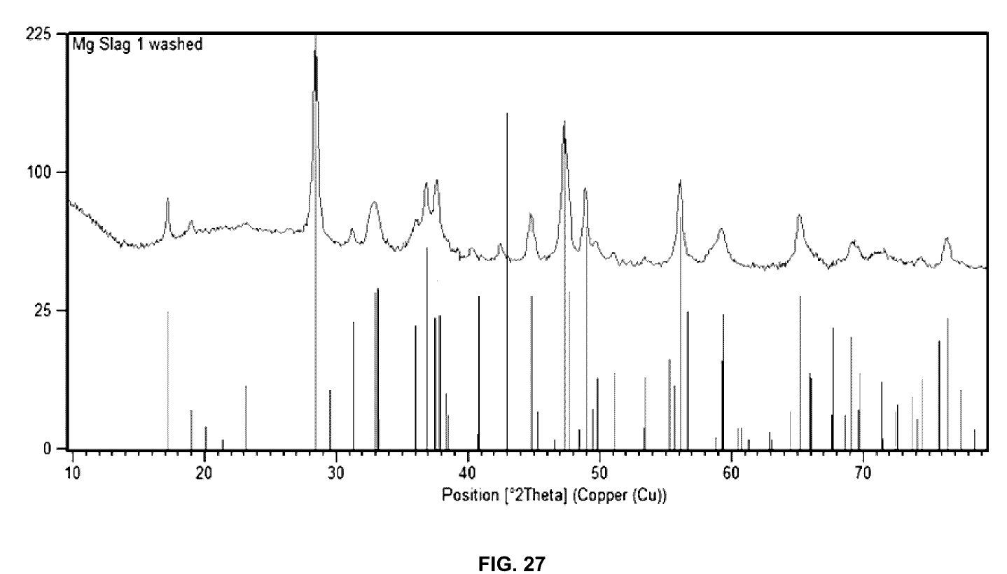

For the synthesis of MgSiN₂ from slag, the SiO₂ content of the slag (assumed to be 60% by weight from XRF analysis) was utilized as the reactant of interest, the other materials (i.e., Al₂O₃, Fe₃O₄, etc.) were assumed again to be spectator species. For the reaction, stoichiometric amounts of Mg₃N₂ and SiO₂ in the form of slag are ball milled to produce a homogenous powder. The reactions are then initiated by taking the powder to 1400° C. in a furnace. The resulting product is washed with 6 M HCl to remove the salt by-product. The XRD of the product is shown in FIG. 27 indicating that the products were MgAl₂O₄ (spinel) phase as well as some AlN (silicon was added as reference). The AlN was attributed to the nitridation of the Al₂O₃ in the slag. The Fe in the slag was also transformed into iron nitride. The target MgSiN₂ does not appear to be synthesized in this reaction scheme.

MgSiN₂ Synthesis from Fly Ash.

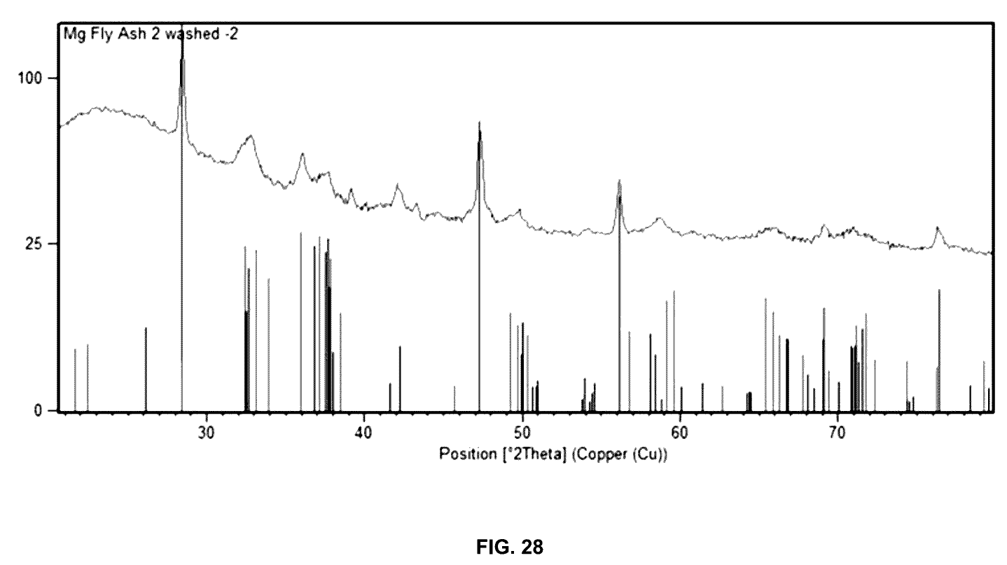

For the synthesis of MgSiN₂ from fly ash, the SiO₂ content of the fly ash was utilized as the reactant of interest, the other materials (i.e., Al₂O₃, Fe₃O₄, etc.) were assumed to be spectator species. For the reaction, stoichiometric amounts of Mg₃N₂ and SiO₂ in the form of fly ash are ball milled to homogenize. The reactions are then initiated at 1400° C. in the furnace. The resulting product is washed with 6 M HCl to remove the salt by-product. The XRD of the product is shown in FIG. 28, which shows that the products are the target MgSiN₂ phase as well as some AlN (silicon was added as a XRD reference). The AlN is likely from the nitridation of the Al₂O₃ in the fly ash. Interestingly, there is also some evidence of the formation of NaSi₂N₃, most likely a byproduct from the residual sodium salts in the fly ash mixture.

Conclusions for SSM AESiN₂ from Waste Streams.

From the reactions of the waste streams, pumice, fly ash and slag with magnesium nitride to form magnesium silicon nitride, it was found that the materials with the highest SiO₂ content (i.e., pumice) resulted in the highest crystallinity and MgSiN₂ product formation. The fly ash yielded some MgSiN₂, whereas slag did not yield any nitride phase of interest. Similar results were also found for CaSiN₂ reactions. For the synthesis of the AE silicon nitrides, a higher, free SiO₂ content is useful, as SiO₂ is the main reactant in this system. In the case of the slag and also the fly ash, the “SiO₂” may be trapped in silicate phase and thus may not “free” SiO₂ and, therefore, may hinder or reduce the reaction kinetics, not allowing for the optimal formation of the AE silicon nitride.

Lower Cost Precursor Pathways to AESiN₂.

Alternative reaction pathways were also investigated. The premise of these reactions was in response to the potential high cost of the raw elemental Ca and Mg that is need to form the nitrides for the SSM reactions. New pathways were identified via thermochemical approach and using potential waste or low cost sources of precursor materials. For the simplification and also abundance of materials, the CaSiN₂ based materials were focused on.

Lower Cost Ca Based Precursor Reaction Pathways to CaSiN₂.

A lower cost Ca based precursor that was quickly identified was calcium cyanoamide, CaCN₂. CaCN₂ is typically used as an industrial fertilizer and can be either purchased or produced or it can be synthesized via carboreduction of calcium oxide. The overall reaction scheme for the reaction pathways is detailed in Table 2 below at a temperature of 1000° C. The overall reaction starting from the CaCO₃ source is thermodynamically favorable. However, it should be noted that this is not a direct reaction pathway and requires multiple high temperature steps. Also, the thermochemical analysis neglects the reaction kinetics (may need multiple heat treatments etc.) and utilizes an assumption for the enthalpy and entropy of formation for the CaSiN₂.

TABLE 2
Thermochemical reaction pathway chain and thermochemical data.

| Reaction | | Total |
|---|---|---|
| Phase | | Contribution |
| 1^{st} Phase | CaCO₃ → CaO + CO₂ | −21.27 kJ |
| 2^{nd} Phase | CaO + C → CaC₂ + CO | 183.76 kJ |
| 3^{rd} Phase | CaC₂ + N₂ → CaCN₂ | −295.50 kJ |
| 4^{th} Phase | CaCN₂ + SiO₂ → CaSiN₂ + CO₂ | 127.75 kJ |
| Final | CaCO₃ + SiO2 + C + N₂ → CaSiN₂ + 2CO₂ + | −5.26 kJ |
| Reaction | CO | |

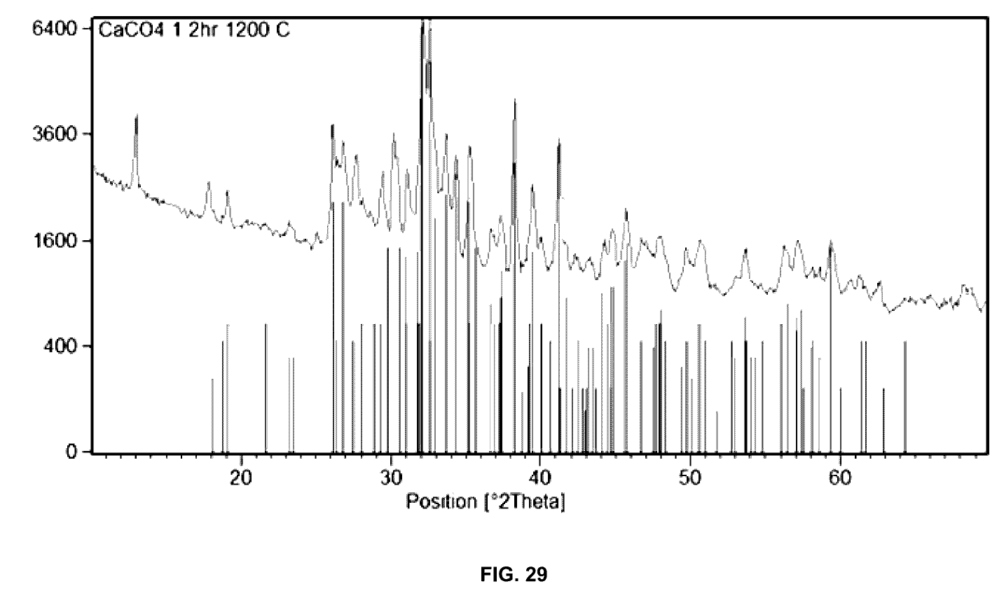

The CaCO₃+SiO₂+C+N₂ reaction was carried out at 1200° C. for 2 hrs in a N₂ flow furnace. The XRD of the product of the reaction is shown in FIG. 29. The reaction product had a high match to the Ca₂SiO₄ lamite silicate. The silicate is very stable and forms rapidly under the reaction conditions and is believed to be a kinetic by product of the reaction or a more favorable product. It was also presumed that the nitriding reaction kinetics were impeded by the formation of the silicate product.

An intermediate reaction step using CaCN₂ was investigated. Although the CaCN₂ reaction was predicted to be non-spontaneous, the previous results were quite telling in the description of the CaSiN₂ reaction kinetics. The main assumption was that the CaSiN₂ would decompose into respective precursors and thus be a favorable reaction. The following reactions were investigated using different “SiO₂” sources.

CaCN₂+SiO₂→CaSiN₂+CO₂

CaCN₂+SiO₂+C→CaSiN₂+2CO

For the second reaction, additional carbon was added to drive the reaction forward (via carbothermoreduction of the SiO₂. The precursor materials were ball milled to homogenize the precursors and then loaded into the nitriding furnace and heated to a temperature of 1500° C. under N₂ stream. For the reactions, a variety of precursors were investigated and the results are detailed in Table 3.

TABLE 3
Reactions using CaCN₂ using various
SiO₂ precursors and resulting products.

| | SiO₂ | Additional | |
|---|---|---|---|
| Sample | Source | Carbon | Result |
| CaCN₂ QZ1-1 | Fused | No | CaSiN₂ + Ca—Si—O—N + |
| | Quartz | | Some CaSiO₄ |
| CaCN₂ QZ1-2C | Fused | Yes | Ca—Si—O—N + |
| | Quartz | | various Ca—Si—N phases |
| CaCN₂ PM1-1 | Pumice | No | Ca—Si—O—N + |
| | | | some CaSiO₄, maybe CaSiN₂ |
| CaCN₂ PM1-2C | Pumice | Yes | Ca—Si—O—N + |
| | | | various Ca—Si—N phases |
| CaCN₂ FA1-1 | Fly Ash | No | Contaminated by CaCN₂ |
| | (F) | | PS1-1 |
| CaCN₂ FA1-2C | Fly Ash | Yes | Ca—Si—O—N + |
| | (F) | | some unreacted C |
| CaCN₂ PS1-1 | Pelletized | No | Melted into CaCN₂ PS1-1 |
| | Slag | | |
| CaCN₂ PS1-2C | Pelletized | yes | O′—SiAlON, |
| | Slag | | Al—Mg—N, CaSi₂ |

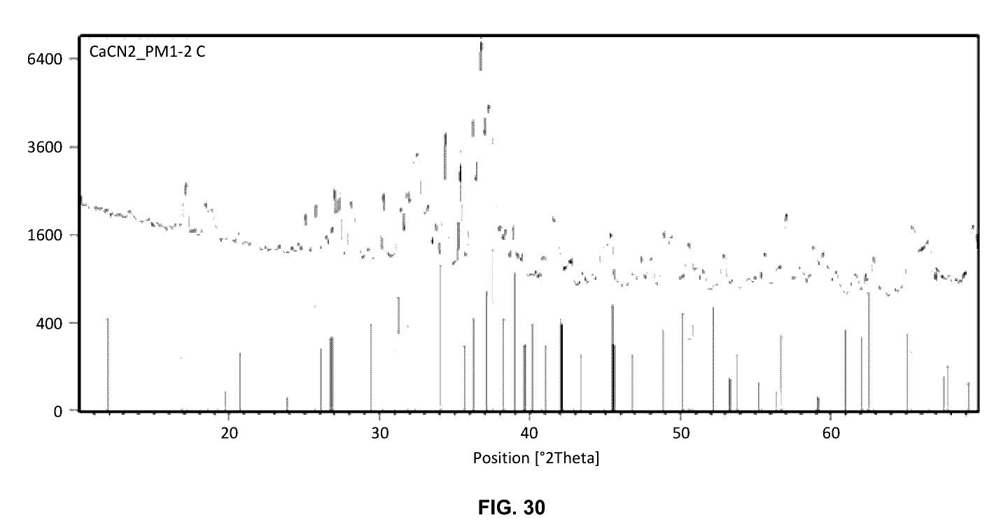

FIG. 30 is a representative XRD for the CaCN₂ PM1-2C reaction with pumice and additional carbon. The diffraction pattern has a good match to a mixed phase product that includes CaSiN₂ of interest and calcium silicon oxynitride. The reactions that used fly ash and pelletized slag yielded complex diffraction patterns with a mixture of calcium silicon oxynitride products. No CaSiN₂ phase was observed. This is likely due to the presence of the silicate phases in the fly ash (mullite) and diopside.

Summary on AESiN₂.

In summary, two reaction pathways have been identified for the synthesis of (AE)SiN₂: one utilizes the solid state metathesis technique, the other carbonitridation of oxide precursors. One advantage of the metathesis approach is that the reaction completion is rapidly and only requires a “flash” heating. However, the reactive nitride precursor may be cost prohibitive. An alternative pathway was identified using the lower cost CaCN₂ precursor. However, the reaction may benefit from multiple extended heat treatments.

SiAlON Synthesis.

SiAlON is an abbreviated form of a solid solution of Al, 0 in the Si₃N₄ crystal structure. The stoichiometry of SiAlON can vary based upon the Al and O doping in the system and the formula can be generalized as Si_{6-z}Al_{z}O_{z}N_{8-z} (where 0<z<5). There are several methods/approaches to synthesize SiAlON, they include the high temperature carbothermal reduction of SiO₂ and Al₂O₃ in a nitrogen environment or the reaction of nitride precursors such as AlN and Si₃N₄:

6SiO₂+3Al₂O₃+15C+5N₂→2Si₃Al₃O₃N₅+15CO

6SiO₂+3Al₂O₃+2Si₃N₄+6AlN+9C+3N₂→4Si₃Al₃O₃N₅+9CO

Both reactions involve the carbothermal reduction of oxides, which the first of these reaction is exclusively composed of. The second reaction involves addition of Si₃N₄ and AlN. These materials serve as “seed” materials and facilitate the synthesis of SiAlON by reducing the activation energy barrier needed to synthesize the SiAlON.

The previously described reactions were conducted using high purity reagent-grade materials in order to demonstrate the feasibility of synthesizing SiAlON. The materials were synthesized using a high temperature nitrogen reactor. The reactor uses a high temperature furnace (Lindberg blue M) and uses MoSi₂ heating elements and is rated to a maximum temperature of 1500° C. The reactor tube is composed of SiC. The entire reactor can be either operated under vacuum or under inert gas flow (e.g., N₂). As the reactions yield CO gas, CO sensors and alarms were installed throughout the lab, and the CO gas exhausted into the fume hood.

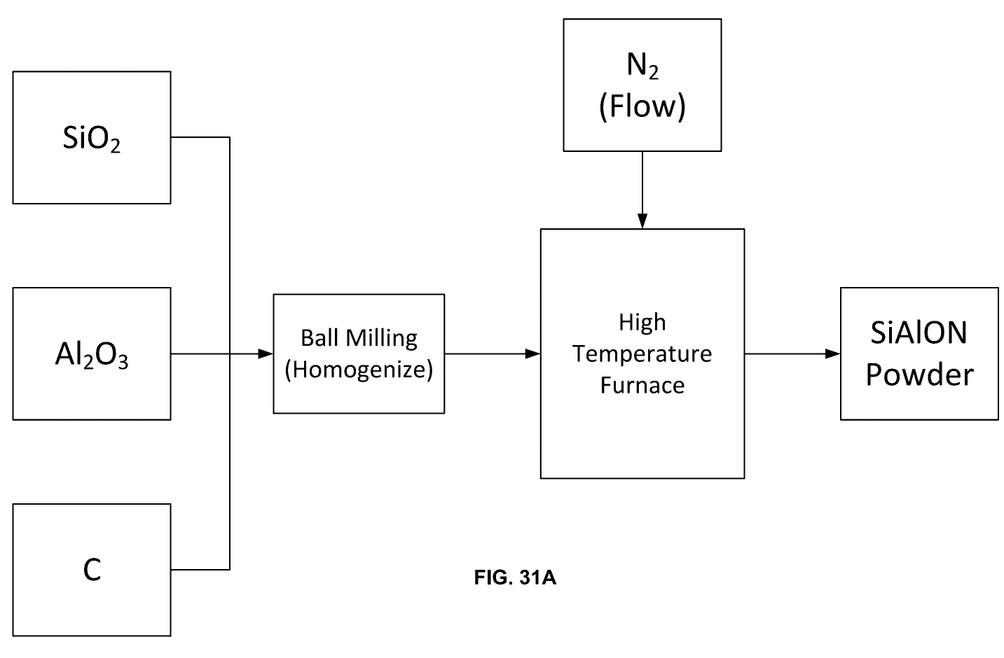

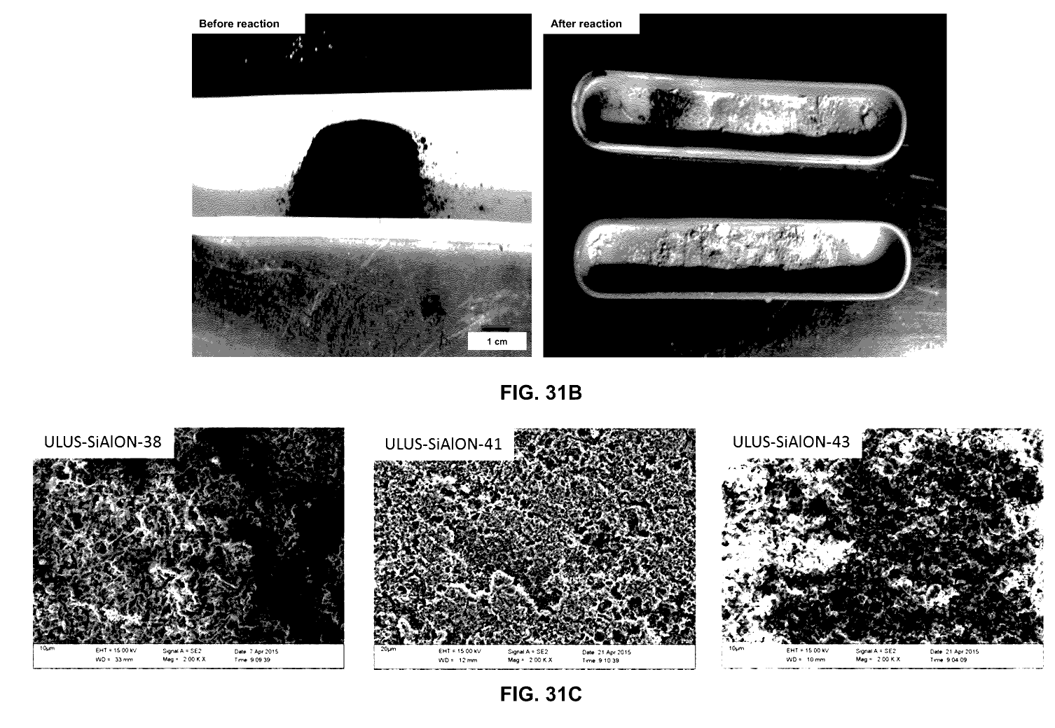

FIG. 31A describes the process flow diagram for the synthesis of SiAlON using the first reaction using high purity reagents to demonstrate the feasibility and reaction conditions. The precursor materials were first homogenized via ball milling. The materials are then loaded into BN coated Al₂O₃ crucible and is then heated to high temperatures (1300-1500° C.) under N₂ stream. The heating rate is on the order of 50 degrees per hour, with a dwell time at peak temperatures from 10-20 hours.

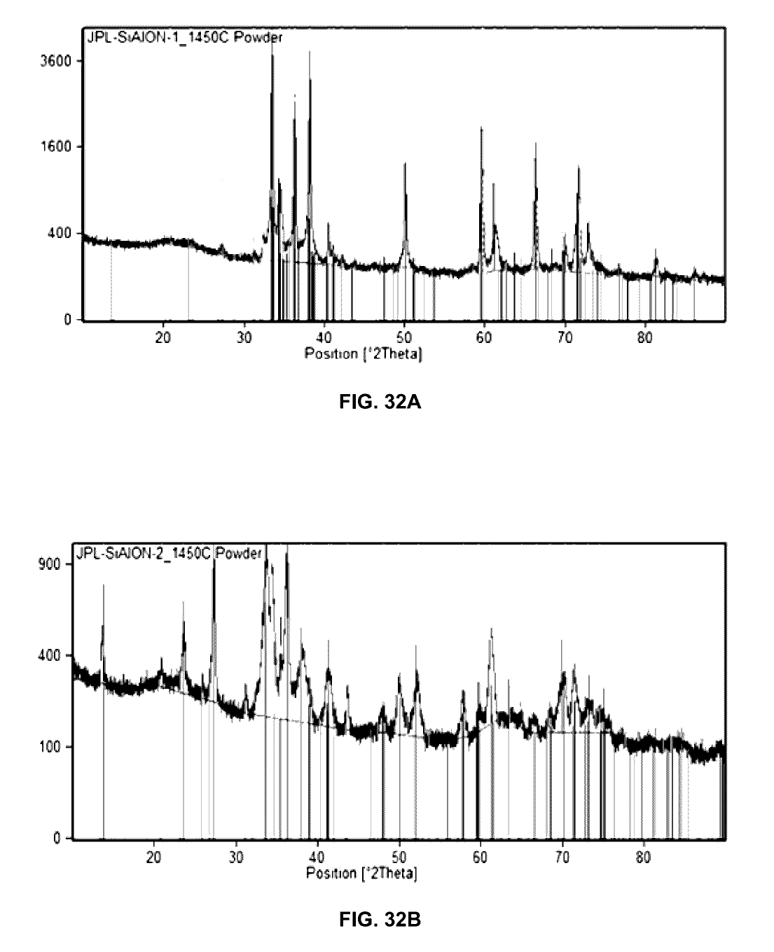

The crucibles were subsequently loaded into the furnace. The furnace was then evacuated/purged 3 times to remove the residual oxygen. The temperature was ramped 50 degrees per hour to 1450° C. and held there for 15 hours under 100 cc/min of N₂ flow. FIG. 32A and FIG. 32B are representative XRD patterns for SiAlON synthesized from the first and second reactions, respectively, at 1450° C. for 8 hours. It should be noted that the SiAlON phases exist across a large compositional range and that it can be challenging to identify using XRF and powder XRD due to the overlap with AlN and Si₃N₄ diffraction patterns. It should also be noted that some of the literature inaccurately indexes AlN and Si₃N₄ peaks for SiAlON.

FIG. 31B shows photographs of the mixture of materials before reaction (left) and after reaction (right), showing a transformation from a dark or nearly black powder mixture to a lighter grey SiAlON powder. Multiple samples of the SiAlON powder were generated, which exhibited densities in the range of about 1.6 g/cm³ to about 3.5 g/cm³. FIG. 31C shows electron micrograph images of 3 different samples of the formed SiAlON powder.

Table 4 shows the results of elemental analysis of compacted pellets of SiAlON using WDS (wavelength dispersive spectroscopy). The samples were hot pressed at 1750° C. for 30 minutes and 80 MPa of pressure. The WDS was used as a secondary confirmation technique to confirm the SiAlON composition/stoichiometry and has less than 1% error. The stoichiometry from the WDS analysis confirms that we had successfully synthesized SiAlON.

TABLE 4
WDS results of SiAlON second reaction compact. The elemental
analysis confirms the SiAlON stoichiometry.

| Atomic % | Si | Al | O | N |
|---|---|---|---|---|
| Spot 1 | 10.90 | 35.06 | 15.88 | 38.15 |
| Spot 2 | 10.07 | 35.78 | 15.74 | 38.41 |
| Spot 3 | 13.88 | 31.76 | 24.29 | 30.07 |
| Spot 4 | 11.54 | 37.56 | 14.87 | 36.02 |
| Spot 5 | 11.55 | 35.68 | 14.91 | 37.86 |

SiAlON Synthesis Via Waste Streams.

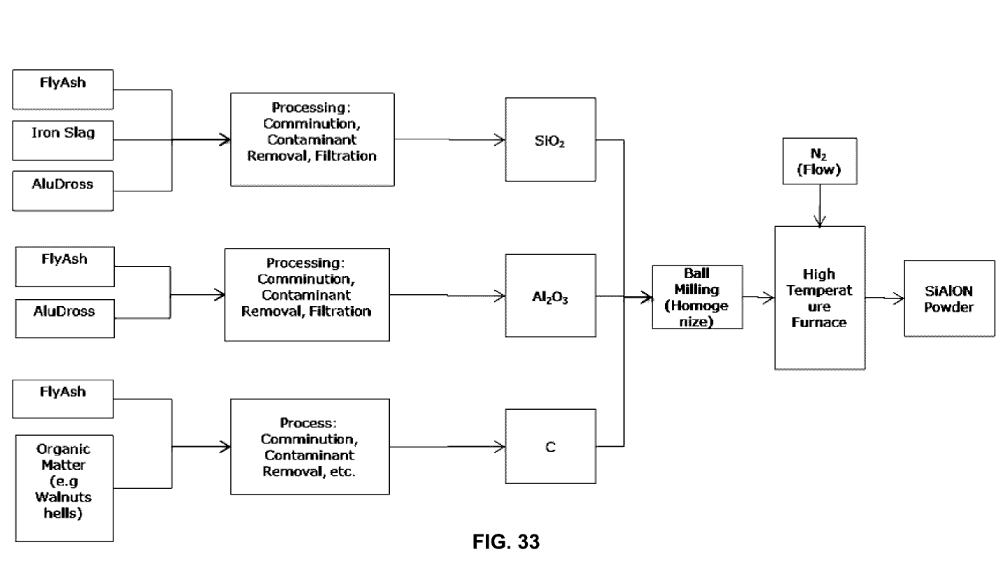

From the previous study using the high purity materials, the optimized reaction conditions were determined to form high purity/high yield SiAlON. The flow diagram for the SiAlON from waste stream synthesis is illustrated in FIG. 33. It should be noted that some of the waste streams are amorphous glassy phases and are difficult to characterize.

TABLE 5
Reaction conditions for SiAlON synthesis
using waste stream precursors

| | | | | N₂ gas |
|---|---|---|---|---|
| | | | | flow |
| | | Temp. | Time | (cm³/ |
| Sample ID | Materials | (° C.) | (hr) | min) |
| WS-SiAlON1 | Low Ca fly ash | 1453 | 8 | 100 |
| WS-SiAlON2 | Low Ca fly ash | 1437 | 2 | 100 |
| WS-SiAlON3 | Pumice + Al₂O₃ + C | 1450 | 2 | 100 |
| WS-SiAlON4 | Slag + Al₂O₃ + C | 1450 | 2 | 100 |
| WS-SiAlON5 | Post reacted WS-SiAlON1 + | 1450 | 16 | 100 |
| | Pumice + Al₂O₃ + C | | | |
| WS-SiAlON6 | Post reacted WS-SiAlON2 + | 1450 | 16 | 100 |
| | Pumice + Al₂O₃ + C | | | |

Fly ash, slag and pumice waste streams were mainly utilized for their silica content and supplemented with regent grade alumina and carbon to obtain the idealized SiAlON stoichiometry. Similar to the pure materials reaction schemes, the precursors (SiO₂ (via waste stream), alumina, and C) were first ball milled for 1 hour to form a homogenous mixture. The reactants were then loaded into alumina crucibles and into the nitridation furnace. Table 5 is a representative matrix of waste stream reactions to form SiAlON and Table 6 is the nominal SiO₂:Al₂O₃:C ratio used for all reactions.

TABLE 6
Nominal SiO₂:Al₂O₃:C ratio for SiAlON reactions

| | Weight % | | |
|---|---|---|---|
| Reactant ID | SiO₂ | Al₂O₃ | C |
| JPLSiAlON | 41.3 | 35.0 | 23.7 |

Fly Ash Synthesis of SiAlON.

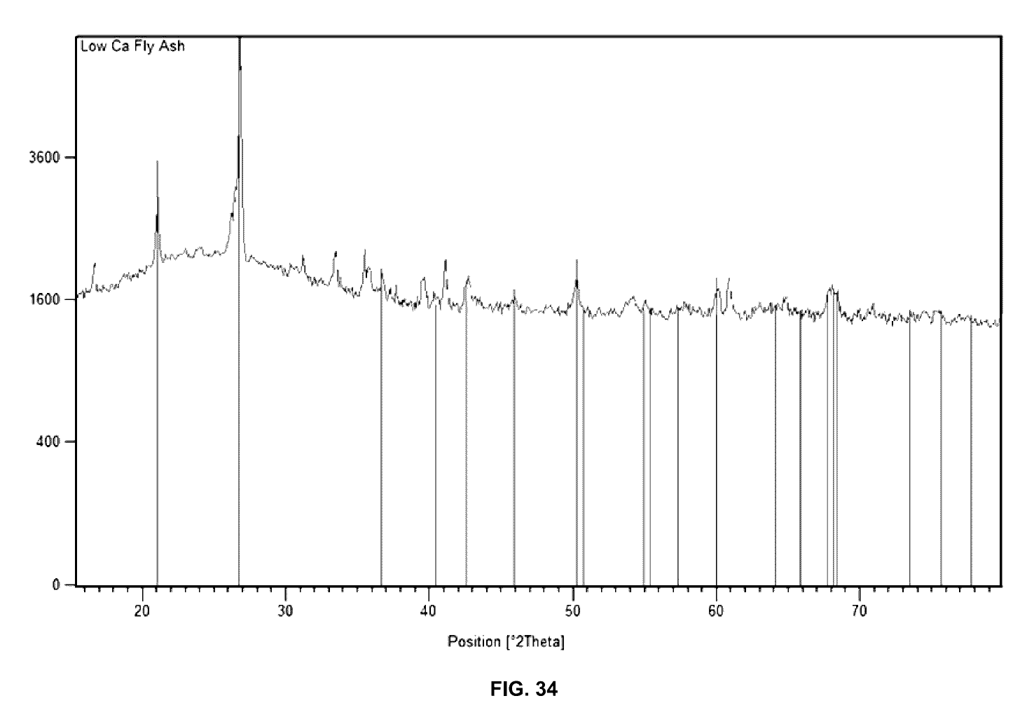

For the synthesis of SiAlON using fly ash, from the XRF analysis of the low CaO fly ash from Boral, the nominal SiO₂/Al₂O₃ ratio was similar to that of the target SiAlON phase. Therefore, as a first reaction, only carbon (˜23.7% wt) was added to for the carbothermal reduction. Other impurities such as Fe, MgO, etc., were neglected for the time being. It should be noted that the SiO₂ and Al₂O₃ were in the form of aluminosilicate, mullite as shown in FIG. 34.

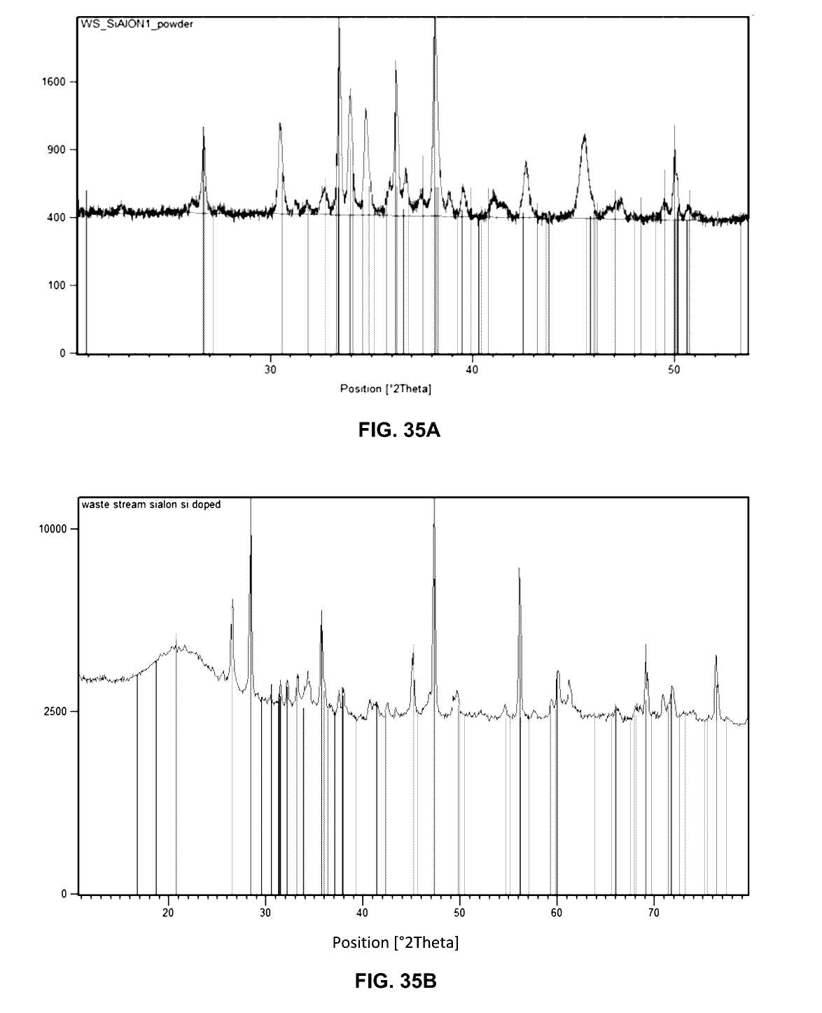

The fly ash and carbon were homogenized using ball milling and the precursors were loaded into alumina crucibles and into the nitridation furnace. The reaction conditions were 1450° C. for 2 hours and 8 hours under 100 cc/min N₂ flow. The resulting powder was gray in color. The XRD of the product is shown in FIG. 35A (8 hrs) and FIG. 35B (2 hrs), and the samples were spiked with Si as a reference. The XRD shows that there is a good match between AlN and Si₃N₄ with some remaining SiO₂ and Al₂O₃ both as respective compounds and as mullite. Interestingly, in the second SiAlON reaction, there appears to be no evidence of mullite. Other silicates such as sodium calcium silicate and potassium silicate were also detected as well as iron silicide.

SiAlON Synthesis Using Pumice.

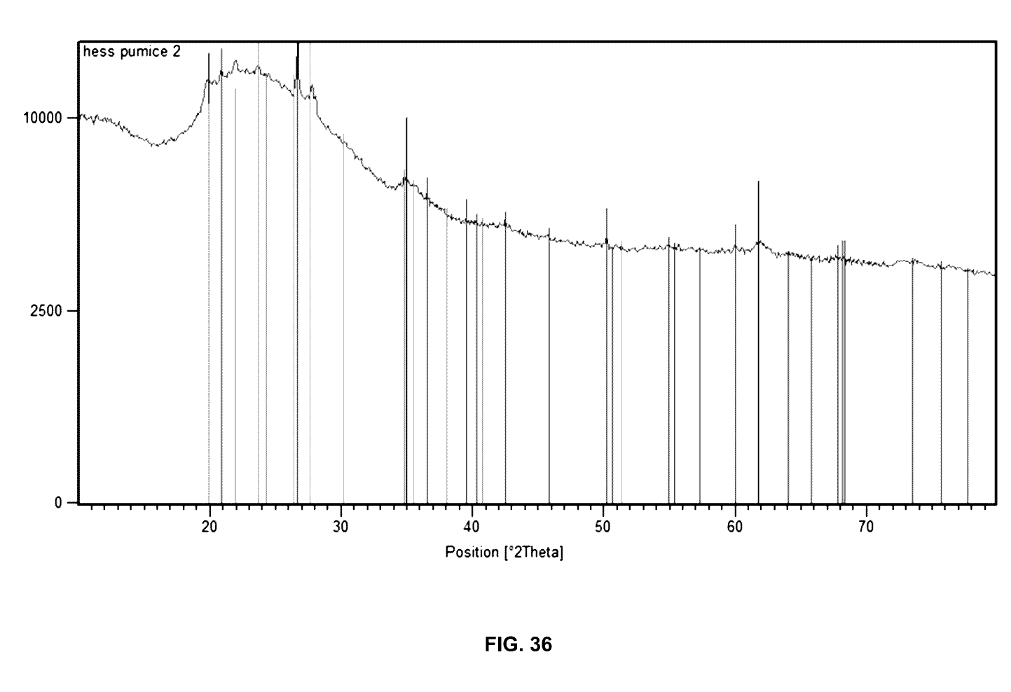

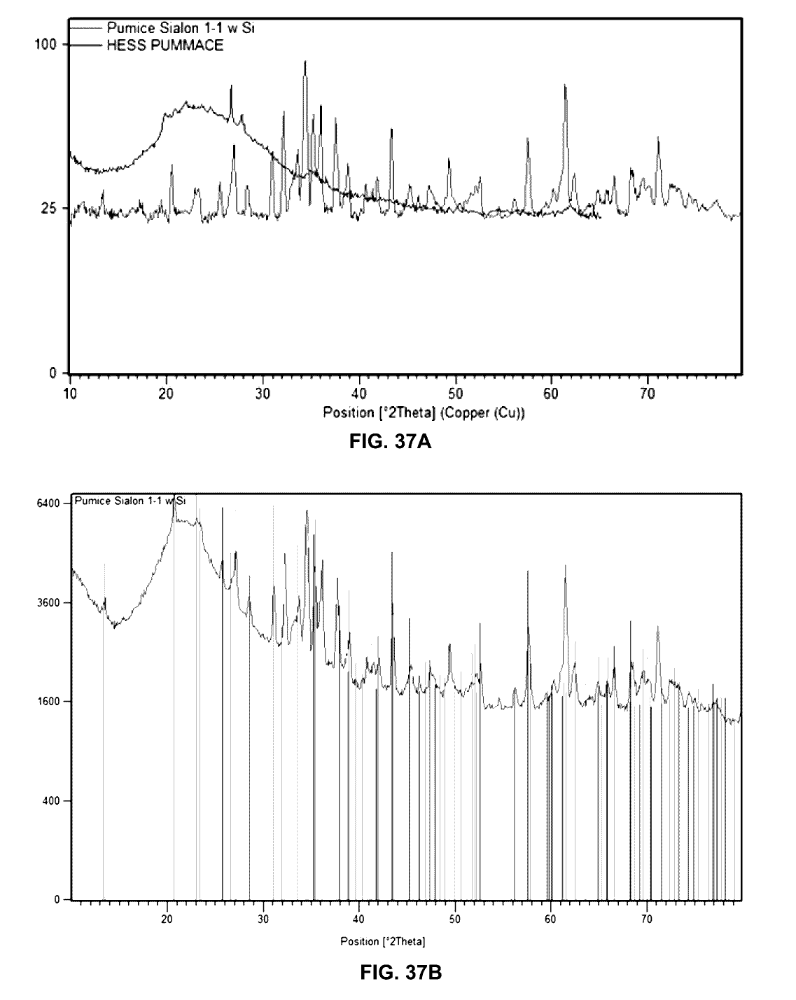

The XRD (FIG. 36) and XRF analysis of pumice implied that the material was mainly composed of SiO₂ and mica. For the reactions using pumice, it was assumed that the SiO₂ was the only contributing reactant. Thus, Al₂O₃ and C were added according to mass ratios listed in Table 4. The reaction mixture was nitrided at 1450° C. for 2 hours with the resulting XRD of the product being shown in FIG. 37A and FIG. 37B. FIG. 37A shows a comparison between the pumice starting material and the SiAlON synthesized via waste stream which clearly shows a transformation of the product. FIG. 37B shows that there is evidence of SiAlON product, Si₃N₄, AlN and some residual Al₂O₃.

SiAlON Synthesis from Slag.

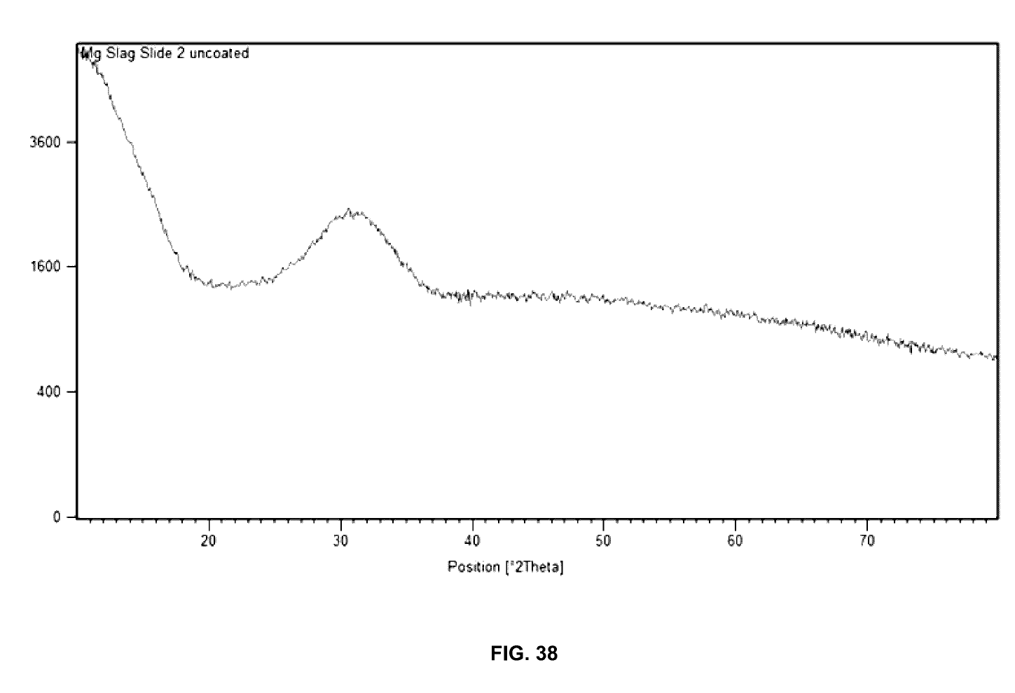

FIG. 38 is the XRD of the slag waste stream starting material. There are no crystalline phases to be identified. From the XRF analysis, the waste stream was assumed to be SiO₂ rich with some Al₂O₃. Additional Al₂O₃ and C were added according to Table 3. The waste stream materials, Al₂O₃, and C were ball milled to homogenize and then heated under nitrogen flow at 1450° C. for 2 hours.

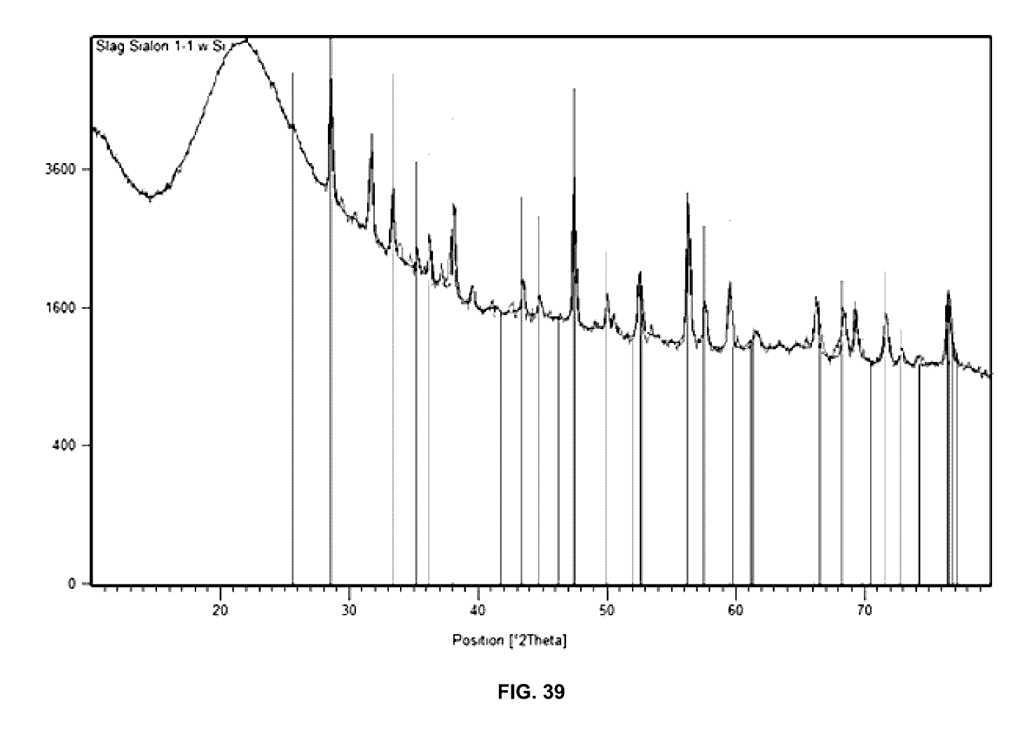

FIG. 39 shows the XRD of the waste stream slag product. AlN and an aluminosilicate product are clearly indexed. There is some residual Al₂O₃ as well, however no SiAlON appears to be present. Since the slag precursor is amorphous, devitirfication of material into crystalline phases may assist in the extraction of the desired SiO₂ and Al₂O₃ materials.

Thermochemical Analysis of SiAlON Reactions Using Waste Stream Precursors.

In order to better understand the chemistry of the waste stream synthesis, thermochemical analysis of the SiAlON reactions were carried out similar to the previous description on the (AE)SiN₂. In order to do this, the waste streams were surveyed for the crystalline compositions via XRD. X-ray fluorescence (XRF) is an elemental analysis technique and only details the elements present but does not detail the actual composition of the constituent materials. From XRD, a series of silicate materials were identified as being present in the slag waste and fly ash waste stream. Table 7 is an example of silicate phases that were identified using a combination of XRF and XRD analysis and used as input for ThermoCalc for blast furnace slag pelletized.

TABLE 7
Sample silicate phases that were identified from XRD and XRF

| Mineral Name | Mineral Composition |
|---|---|
| Anorthite | CaAl₂Si₂O₈ |
| Akermanite | Ca₂MgSi₂O₇ |
| Clino_pyroxene/diopside | CaMgSi₂O₆ |
| Spinel | MgAl₂O₄ |
| C1A8M2 | CaMg₂Al₁₆O₂₇ |
| Wollastonite | CaSiO₃ |
| Fostertite | Mg₂SiO₄ |

The enthalpy of formation for SiAlON was calculated using the silicate phases as precursor materials. This was not conducted for the pumice precursor as pumice is mainly SiO₂. Several assumptions were made in order to simplify the calculation process. These assumptions were that no intermediate products were formed (i.e., AlN/Si₃N₄) and that SiAlON was the exclusive product. The reaction below is an example reaction with akermanite Ca₂Mg(Si₂O₇) (first reaction below) and monticellite CaMgSiO₄ (second reaction below), both of which are found in the blast furnace slag):

3Ca₂Mg(Si₂O₇)+3Al₂O₃+5N₂+17C→2Si₃Al₃O₃N₅+17CO(g)+6CaO+3MgO

6CaMgSiO₄+3Al₂O₃+5N₂+15C→2Si₃Al₃O₃N₅+15CO(g)+6CaO+6MgO

The enthalpies of formation for the respective precursors were obtained from the literature. As the entropy and Gibbs free energy is not reported for many of the compounds, only the enthalpy of formation was calculated at 1275 K. The enthalpy of formation for the first reaction was −7457 kJ/mol and for the second reaction was −8967 kJ/mol. The reactions appear to be heavily favorable. This is also the case for to diopside, CaMgSi₂O₆. However, when the precursor is changed to wollastonite, CaSiO₃, the reactions is not favorable by a factor of 3. Upon further investigation, the previous slag precursor material that was used was blast furnace slag chunks, air cooled which had a high amount of Ca₂SiO₄, a very stable silicate, and is likely the reason why the reaction did not proceed. However, from analysis of the phase diagrams and from the previously reported phase diagrams from ThermoCalc, the certain slag compositions could be heated and then quenched in order to form a more favorable silicate phase. As a result of this study, the reaction was repeated and the results are detailed below.

In the case of fly ash, the main constituent is mullite 3Al2O₃:2SiO₂, similar assumptions were made for this precursor material. The reaction is detailed below:

(3Al₂O₃.2SiO₂)+4SiO₂+10N₂+15C→2Si₃Al₃O₃N₅+15CO(g)

The enthalpy of formation for the reaction was 2827 kJ/mol and the reaction would not be favorable; however, experimental work has shown some indication of SiAlON precursor formation. This is likely from the decomposition of the mullite silicate into SiO₂ and Al₂O₃ at high temperatures, a factor that was neglected in the original calculations.

The thermochemical analysis described here is useful for to guiding the experimental work and offering some rationalization for the reactions.

Revised SiAlON Synthesis Via Waste Streams.

Only Si-based and Al-based waste streams have been identified, but not a carbon source. Various carbon waste streams may be available, however. The waste stream reactions were repeated and the results are discussed below. The reaction still follows the 2-step approach with the formation of the Si₃N₄ and AlN seed material. The reactions are detailed in Table 8.

TABLE 8
Table of reactions using waste stream
precursors and resulting products

| | Step 1 | | |
|---|---|---|---|
| Sample ID | Precursors | Conditions | Product XRD |
| JPLSiAlON5-1 | Pumice + | Pressureless sintering | Si₃N₄, AlN |
| | Al dross + C | 1750° C., 2 hr with N₂ | |
| JPLSiAlON6-1 | Slag1 + | Pressureless sintering | Si₃N₄, AlN, |
| | Al dross + C | 1750° C., 2 hr with N₂ | Silicates, |
| | | | Ca—SiAlON? |
| JPLSiAlON10 | Post-treated | 1450° C., 2 hr with N₂ | Ca—SiAlON + |
| | Slag1 + C | | silicate |

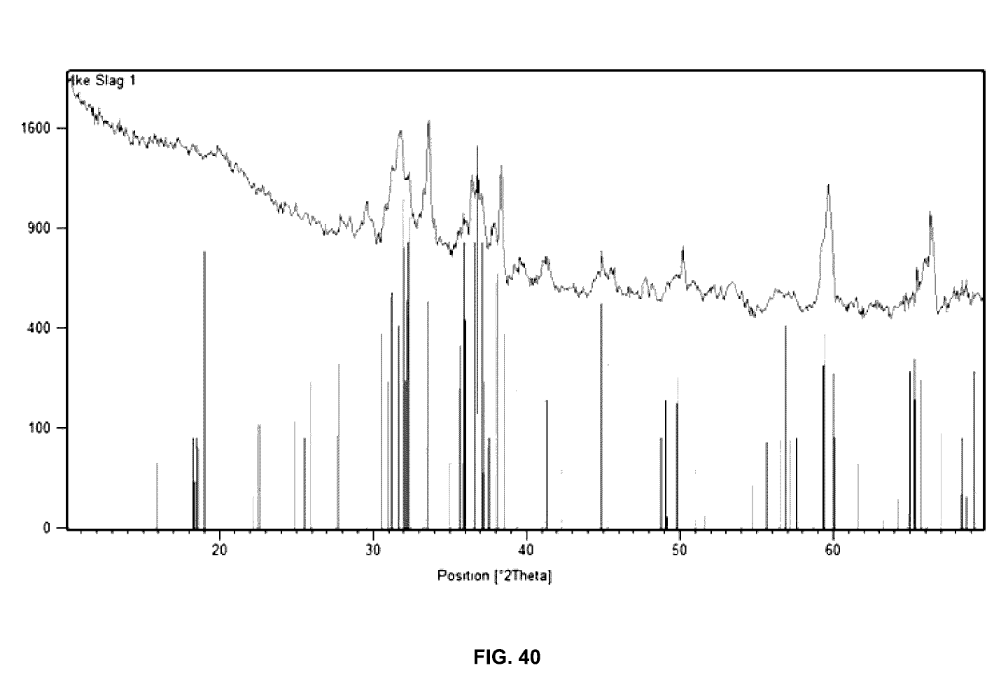

FIG. 40 shows a representative XRD of the JPLSiAlON6 reaction which utilized slag 1 pelletized and Al dross waste stream. The products were identified as mainly silicates with some Si₃N₄ and AlN. Pre-processing (via melt/quench) of the slag material did not yield discernable results and yielded similar results to the as received slag materials.

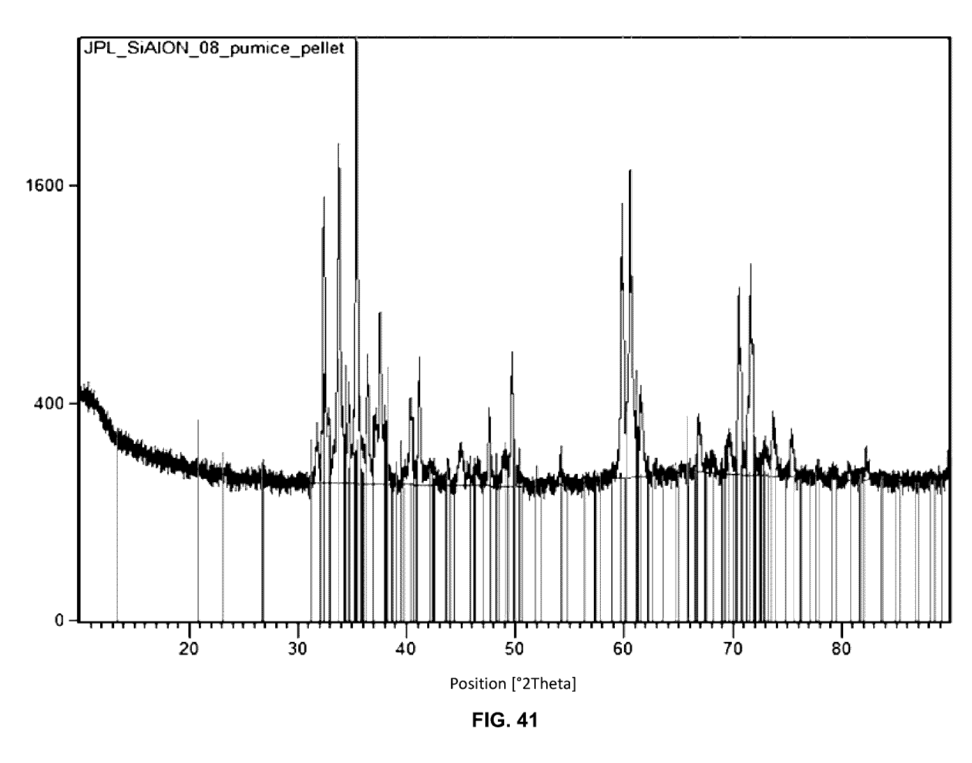

The products of the reactions were then utilized for the second step of the reaction and is listed in Table 9. The reaction successfully led to a high yield of SiAlON from a total waste stream synthesis. The XRD is also detailed in FIG. 41.

TABLE 9
Step 2 SiAlON synthesis using waste stream precursors

| | | | N₂ gas | Product |
|---|---|---|---|---|
| | Step 2 | | flow | XRD |
| Sample ID | Precursors | Conditions | (cm³/min) | (powder) |
| JPLSiAlON7-1 | Post CRN | CRN at | un- | SiAlON |
| | pumice + | 1450° C., 2 hr; | calibrated | |
| | post CRN Al | Pressureless | | |
| | dross + | sintering at | | |
| | Pumice + Al | 1800° C., 2 hr | | |
| | Dross + C | | | |

Conclusions on SiAlON.

Upon examination of the waste stream synthesis of SiAlON, certain waste streams, such as pumice and fly ash, readily yielded SiAlON or SiAlON precursors (i.e., AlN and Si₃N₄) as compared to the slag precursor. Thermodynamically, the formation of AlN and Si₃N₄ are heavily favored over SiAlON itself. However, as demonstrated above, the AlN and Si₃N₄ can be transformed into SiAlON via a secondary heat treatment.

### Example 8

### Powder Granulation for Bead Formation

This example details a method for formation of proppant beads and/or proppant bead precursors using granulation. Granulation is a process by which materials supplied as fine particles, often in the range of 50 to 80 micrometers, are converted into larger ones. Generally, granulation generates particles within a fairly large size distribution and there is no one particular size of larger particles that are formed. It is not unusual to have particles under 1 mm to as large as several millimeters. In order to facilitate the formation of these large particles, it is customary to add a binder before granulation begins, for example. The granulation process can be accomplished in a number of ways, but in any case, the principle may involve generating “seed” particles which continue to grow during the process. The “seed” formation may involve subjecting the fine powders and binder to considerable shear using an impellor. One example of such an impellor is a rotating blade. The growth process can then be accomplished with less energy intensive means such as a rotating pan or drum. Taken together, the process is comparable to the nucleation and growth of crystals, for example. As with granulation, the nucleation requires more energy than growth. Once the granulation process is complete, classification of the particles may be useful because of the large particle size distribution of the product.

In some embodiments, the sorting or classification of particles may be done by sieving. By employing two sieves in series of different sizes, all particles larger than a certain size are excluded, and all particles smaller than a certain size are not retained. Together the two sieves may dramatically reduce the size distribution of the final product.

Preparing Proppant Green Bodies or Bead Precursors.

Granulation has been used to produce 0.5 mm “green bodies” from various materials including, aluminum dross, fly ash, blast furnace slag, furnace black, and ground walnut shell. These “green bodies” are spherical agglomerates intended for subsequent firing. The granulation process was facilitated by the use of PQ type N silicate binder, Elvanol type 7130 PVA binder made by Kurary, or type 250 PVA binder made by Sekisui.

Generally, carbon black, fly ash, and aluminum dross mixtures were granulated to produce “green bodies” that were intended for firing under nitrogen. From these, it was expected that a chemical conversion to SiAlON would occur followed by sintering. Other powder mixtures of slag and fly ash, with or without furnace black and walnut shells were expected to undergo sintering only. Silicate binder was used to make green bodies intended for subsequent SiAlON formation, while both PVA and silicate binder for others. In some embodiments, green bodies that were made with PVA binder fell apart after firing at 800° C. in air. Because fly ash/slag mixtures from previous experiments not involving granulation were generally fired at 1400° C., and furnace black, fly-ash, and aluminum dross mixtures were fired at up to 1800° C., it was concluded that PVA binder may not be as useful as silicate binder for the compositions tested.

Granulation Process.

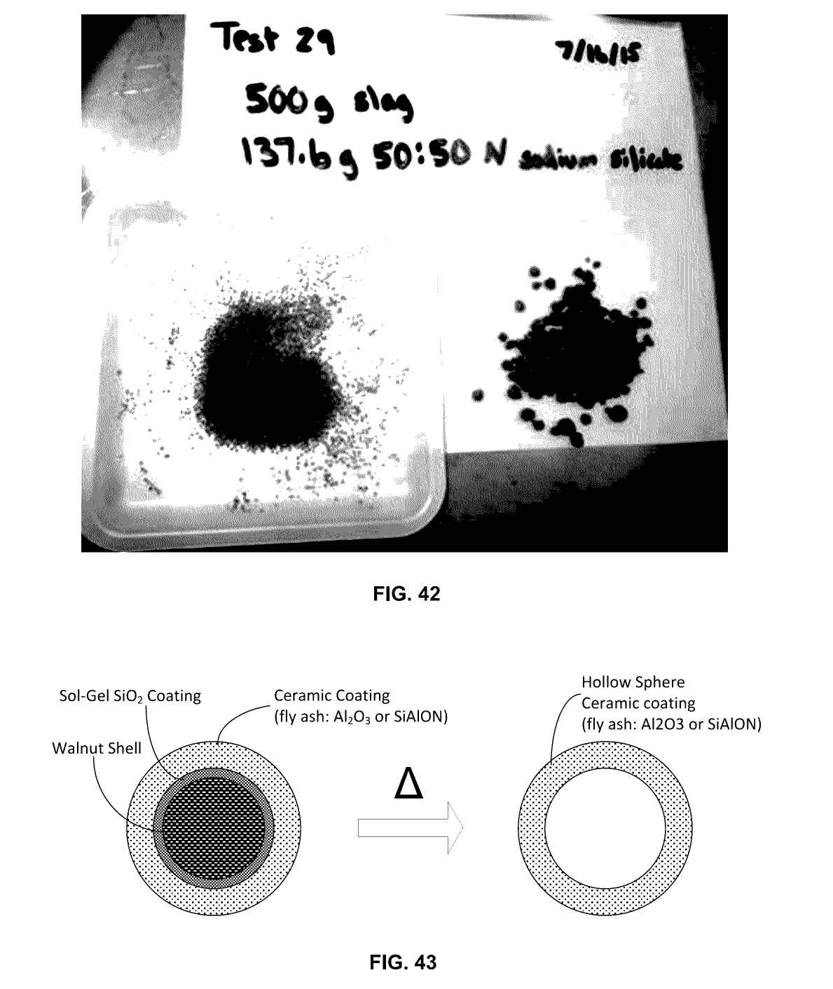

The granulation process was initiated with a high energy mixing step. This was accomplished with the use of a food processor or an eggbeater for the lab scale testing process. The granulation process was than completed by the use of a pan granulator. The two step process was intended to mimic, on a laboratory scale, a machine commercially available and known as an Eirich machine. This machine is also capable of two granulation steps performed at high and low energies respectively, but is designed to process large quantities of material. When the granulation process is complete, the material is passed through two sieves. The first is a sieve of mesh size #20 (841 microns), and the second of mesh size #40 (400 microns). The material retained fell between those two size extremes. FIG. 42 show a photograph of a typical example of granulated material both before and after sieving.

### Example 8

### Walnut Core Shell-Based Bead Templating

This example provides further details beyond Example 4 above of a method for formation of proppant beads and/or proppant bead precursors by the coating of template particles with ceramic or ceramic precursors. In this process, a spherical organic bead (such as walnut shell or a polystyrene bead) was utilized as a scaffold in which ceramic or pre-ceramic powders are coated. Upon thermal treatment, the organic material may be either consumed or burned out to leave a hollow ceramic bead. FIG. 43 shows a schematic illustration of the hollow sphere formation process.

For this process, walnut shells were procured from commercial vendors. The walnut shells were then sieved to the 300-500 μm range. The walnut shells were optionally pre-treated via acid wash to clean the surfaces. The walnut shells were then coated with ceramic (SiAlON) or pre-ceramic cursors (SiO₂, Al₂O₃, slag, fly ash, etc.). The inorganic materials (i.e., SiAlON powder, slag, fly, ash, etc.) were either dispersed in water/methanol based methyl cellulosic slurry or were dry coated using shear mixing (adhesion via polymer coating on the surface of the walnut shell). FIGS. 13A-13C show photographs of example walnut shells coated with a 50:50 mixture of fly ash/Al₂O₃, with the coating being on the order of a few microns.

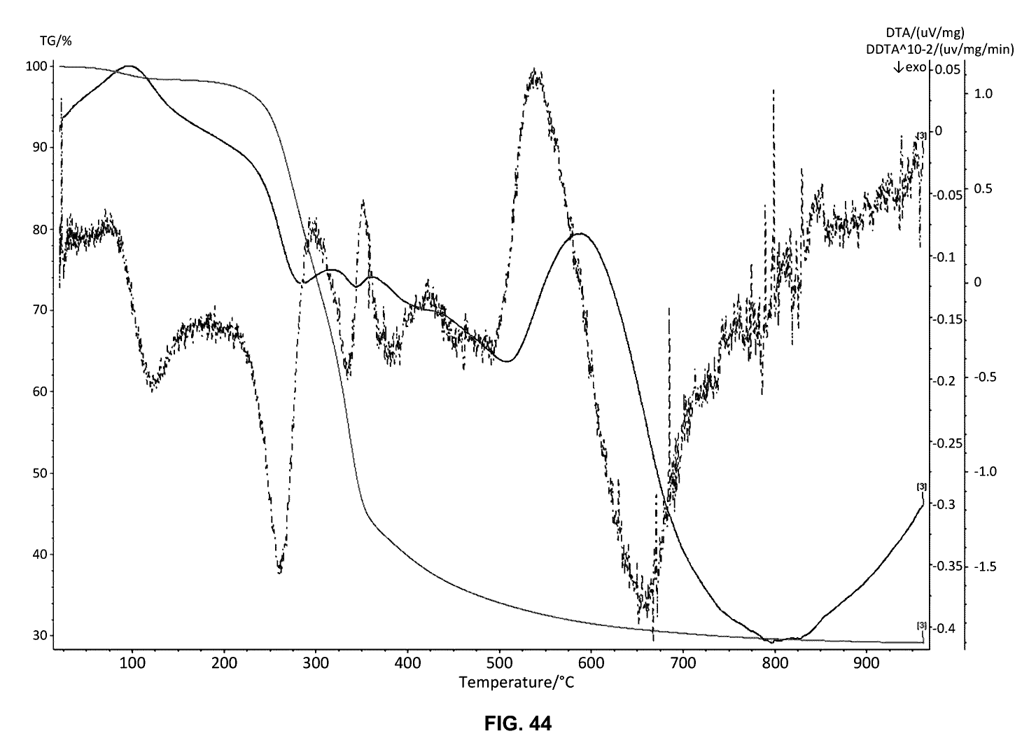

Thermal analysis was conducted on the walnut shells in order to identify thermal events and to establish thermal treatment procedures. The thermogravimetric analysis (TGA) and differential thermal analysis (DTA) are shown in FIG. 44 for the walnut shells. It was found that the walnut shells experience a large mass loss at 300° C. likely due to the loss of volatile organics that the shells undergo a first order endothermic event at 500° C., followed by a second order exothermic event at 600° C. These events are likely related to the carbothermal reduction of the organic material in an inert environment.

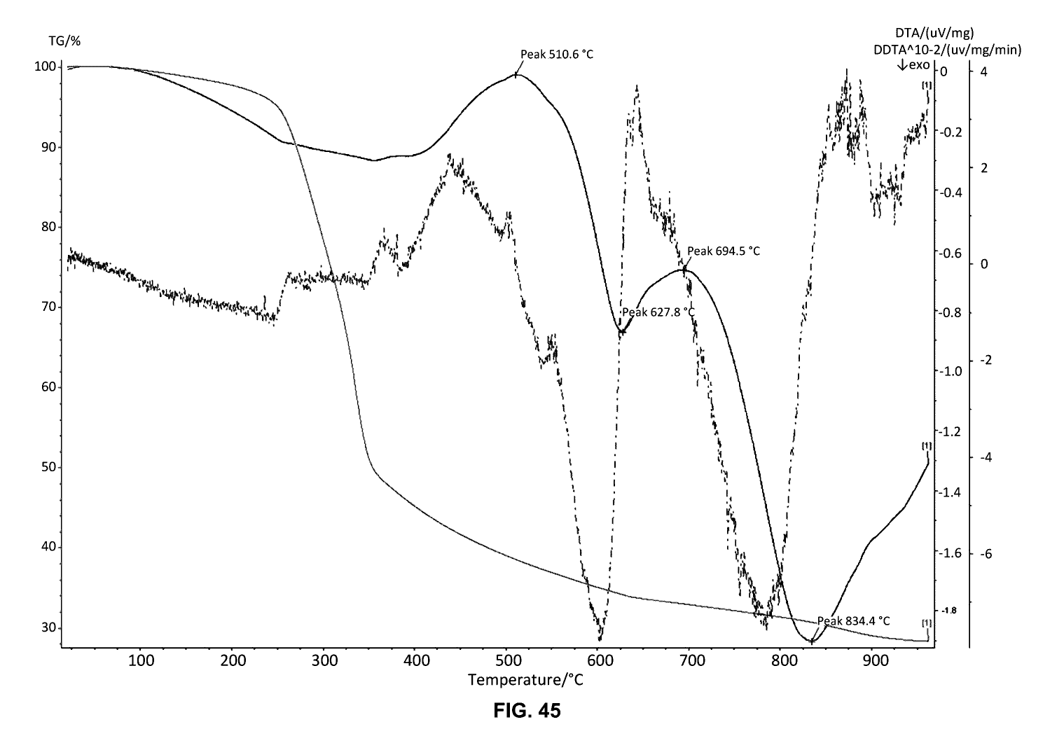

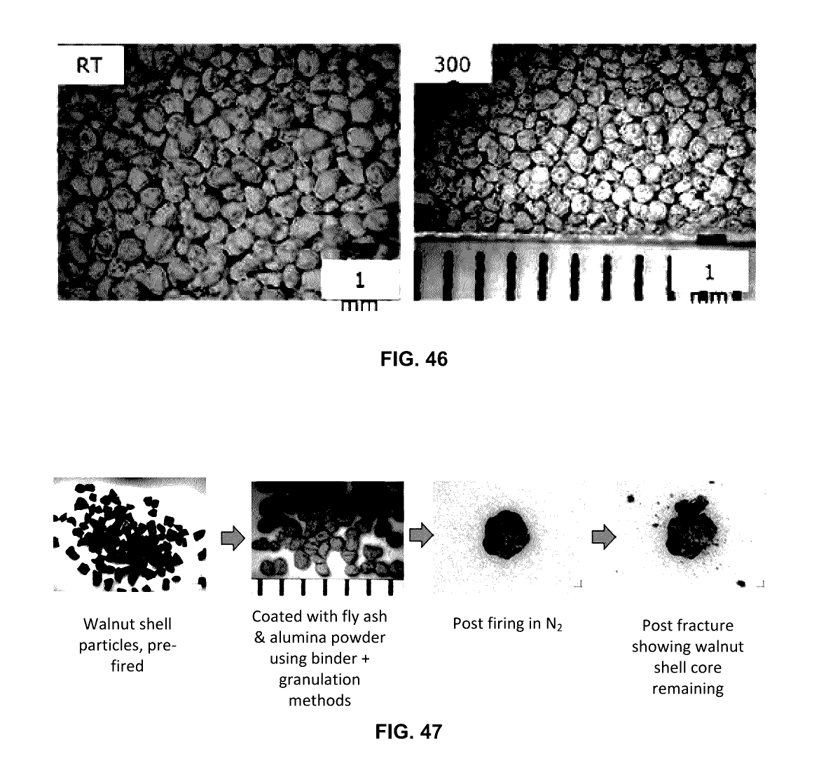

Based upon this data, the following heating profile was established in a N₂ flow. A slow ramp up to 200° C. at 5° C./min to allow for outgassing of the volatile organics from the binder and from the walnut shell, followed by a ramp up to 300° C. at 1° C./min followed by a dwell at 300° C. for 30 mins to allow for walnut shell out gassing. The temperature was then increased to 300, 500 and 1000° C. at 5° C./min and the product was characterized as shown in FIG. 45.

With increasing heat treatment temperature, it was observed that the coating may crack, leading to broken shells, such as at temperatures of 500° C. or 1000° C. This may be due to the rapid outgassing of the walnut shell organic materials and poor sintering and adhesion of the ceramic materials to the shell. It should be noted that the cracked shells did maintain a somewhat rounded morphology. Further work using alternate coatings (i.e., sol-gel based, poly acrylamide based) also resulted in cracked shells.

In order to mitigate the outgassing of the walnut shells, the walnut shells themselves were pre-treated at 400° C. to remove volatile organics, leaving a somewhat rigid walnut structure. Subsequent coating and firing (up to 1450° C. in N₂) of the pre-treated walnut shell resulted survival of intact ceramic coated beads. Macroscopic analysis was carried out on the fired beads and it was found that the walnut shell based core remained inside the ceramic coating as shown in the photographs of FIG. 47.

### Example 9

### Freeze Drying Bead Formation

This example provides further details beyond Example 6 above of a method for formation of proppant beads and/or proppant bead precursors by a freeze drying process. Silicon oxycarbide (SiOC) beads were prepared using precursor solutions and a variety of approaches, including emulsification techniques, foams, and freeze-drying. All of these approaches used preceramic polymers to make the SiOC beads.

SiAlON beads may be made from a water-based precursor solution using a freeze-drying approach in which an emulsion is frozen by dropping it into a liquid nitrogen bath. The beads created may subsequently be put in vacuum for 24 hours and then cured. The emulsion may be made from water, a water soluble polymer, and SiAlON powder.

Experimental Procedure.

A 1%, by weight, stock solution of cellulose was prepared by dissolving cellulose in water and allowing the solution to sit overnight. Powdered SiAlON was added to an aliquot of the stock solution to make a suspension that was 1% polymer and 1% SiAlON, by weight. The suspension was sonicated for 15 minutes.

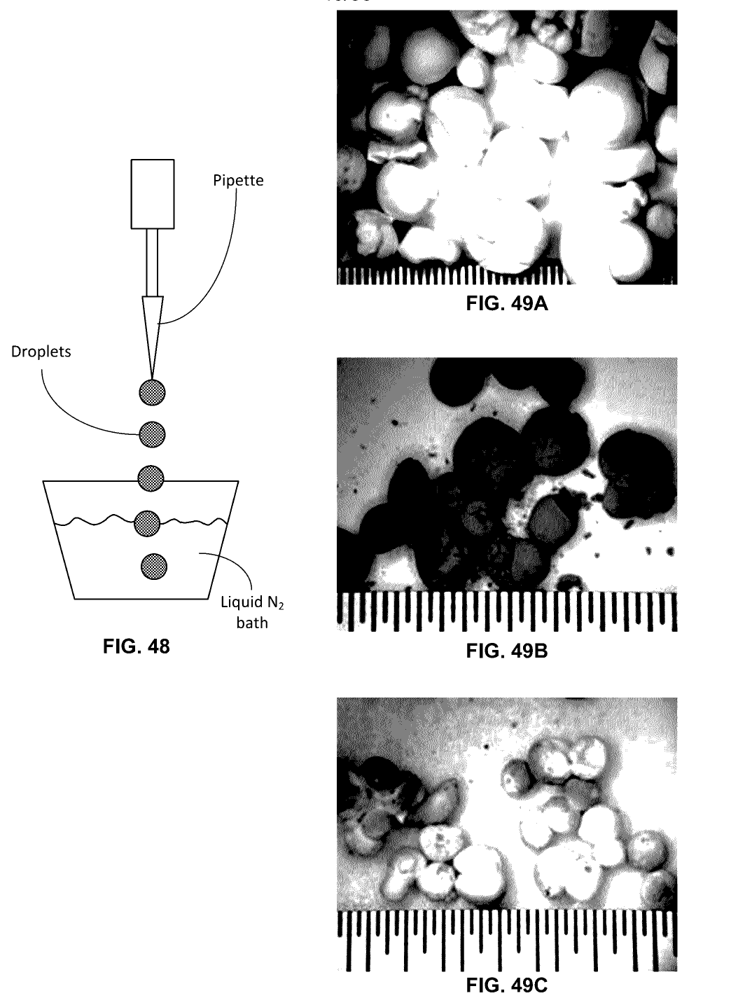

A liquid nitrogen bath was prepared in a small Styrofoam bowl. To create the beads, a 100-1000 μL pipette was used to dispense the emulsion, drop-wise, into the liquid nitrogen bath (see the schematic illustration in FIG. 48). The pipette was set for 500 μL, but the droplet volume was difficult to control because of the high viscosity of the emulsion. When the droplets hit the liquid nitrogen bath, they floated on the surface until they froze and sank to the bottom. Some of the droplets stuck together if they touched while on the surface of the liquid nitrogen.

Once a sufficient number of beads were produced, the bowl was placed in a vacuum oven and was left under vacuum for 24 hours. Under vacuum the liquid nitrogen boiled off and then the bowl iced over as the water was pumped out of the beads. After a 24 hour period, the bead morphologies were examined. The beads were hollow and rubbery spheres and in the mm size range. (See FIGS. 49A, 49B, and 49C)

Green Body Sintering.

These beads were subsequently annealed. Two different annealing profiles were used. The first profile annealed the spheres up to 350° C. This temperature was selected because previous analysis had shown that the polymer would burn off at this temperature, leaving the ceramic.

Annealing Profile 1:
Room temperature to 250° C. at 5° C./min,
250° C. to 350° C. at 1° C./min,
Stay at 350° C. for 30 mins,
Ramp down to room temperature at 5° C./min

Annealing Profile 2:
Room temperature to 250° C. at 5° C./min, in vacuum
250° C. to 350° C. at 1° C./min, in vacuum
Stay at 350° C. for 30 mins, in vacuum
350 to 1750° C. at 5° C./min, in nitrogen gas
Hold at 1750° C. for 30 min, in nitrogen gas
1750° C. to room temperature at 10° C./min, in nitrogen gas

In summary, hollow polymer/SiAlON spheres were successfully produced using the freeze-drying method. Following additional high temperature sintering, the spheres became fairly robust porous ceramic beads.

### Example 10

### Spray Drying Bead Formation

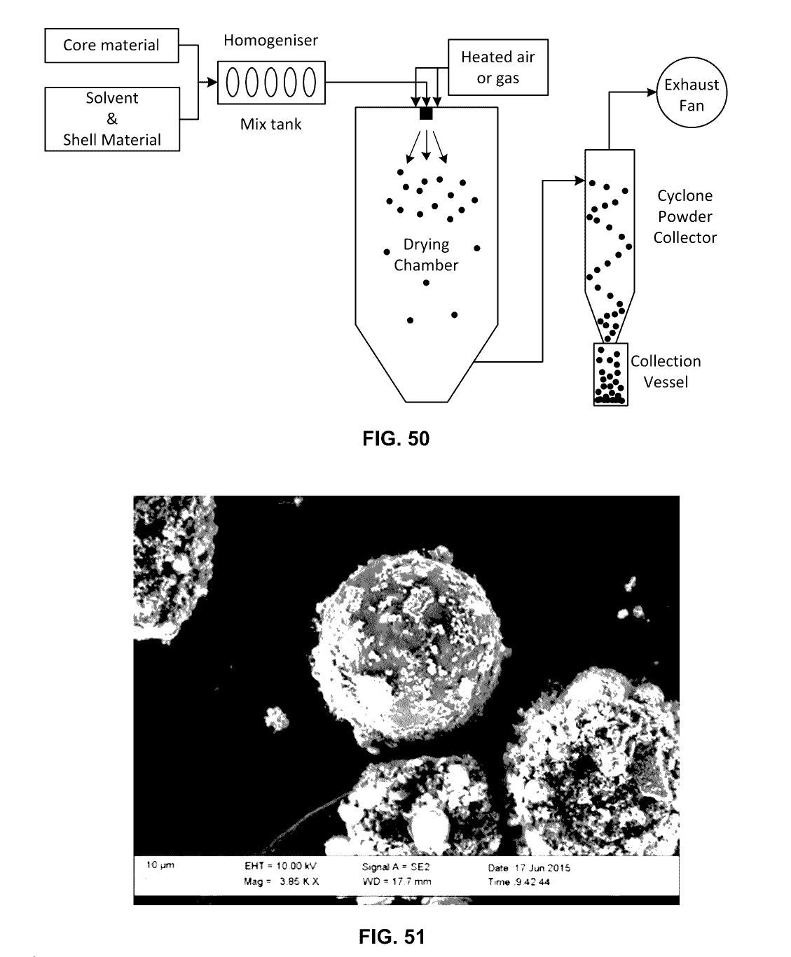

This example details a method for formation of proppant beads and/or proppant bead precursors using a spray drying process. Spray drying works by forcing a suspension through an orifice with a forced gaseous medium, often air. The “emulsion” is then sprayed vertically, with gravity and surface tension providing driving forces for surface area reduction into a sphere, which combines the maximum volume per surface area of any geometry. As the spherical droplets fly vertically, they are met with a counter flow of pre-heated air, typically between 190-220° C., thereby drying the particles, which subsequently are collected back onto the separator by gravity, as illustrated in FIG. 50. At this point, the spheroidized particles are held together by a combination of frictional and van der Waal's forces, caused by the rapid drying and contraction of the particle. The particles are reasonably robust and can be handled without significant damage if the spray drying is performed properly.

Small sized desktop spray drying units are useful for laboratory-scale suspension spray drying, and has been able to produce spherical particles up to 100 μm, as shown in FIG. 51. Commercially available pilot or production scale systems are useful for producing 500 μm particles that are desirable for commercial proppant use. The benefit of spray-drying as a spheroidization technique is that there may not be significant differences between benchtop and production scale machinery, other than size effects. The larger particle flow path in an industrial system and the greater pumping pressures allow for larger particulates. Another benefit of the process is that any material that has insufficient diameter (e.g., fines) can be placed back into suspension and recycled, as long as they have not been subjected to a heat treatment. If the material is subjected to a heat-treatment or sintering cycle, it may still be recycled after an additional grinding process.

The use of larger spray drying systems can sometimes lead to alternate particle morphologies, such as hollow particles, partial shells, and collapsed particles. Typical processing with controlled parameters and a well-developed system should result in less than 1 vol. % of these types of particles. If further process control is needed, industrial screening approaches may be applied to remove undesirable sizes or morphologies.

Post-Processing.

Given that the as-spray-dried particles are spheroidized, they flow reasonably well and can be sintered to reasonable densities without significant interparticle surface diffusion, thereby maintaining a spherical shape. This is caused by the major driving force being reduction of surface area for each individual particle. As such, the particles can be handled and fired using a variety of techniques, including conveyor based furnace systems, wherein they can be translated along a belt and sintered appropriately. Additional morphologies may be achievable through the use of a plasma-spraying technique, as described below.

Spray Drying Powder Morphologies.

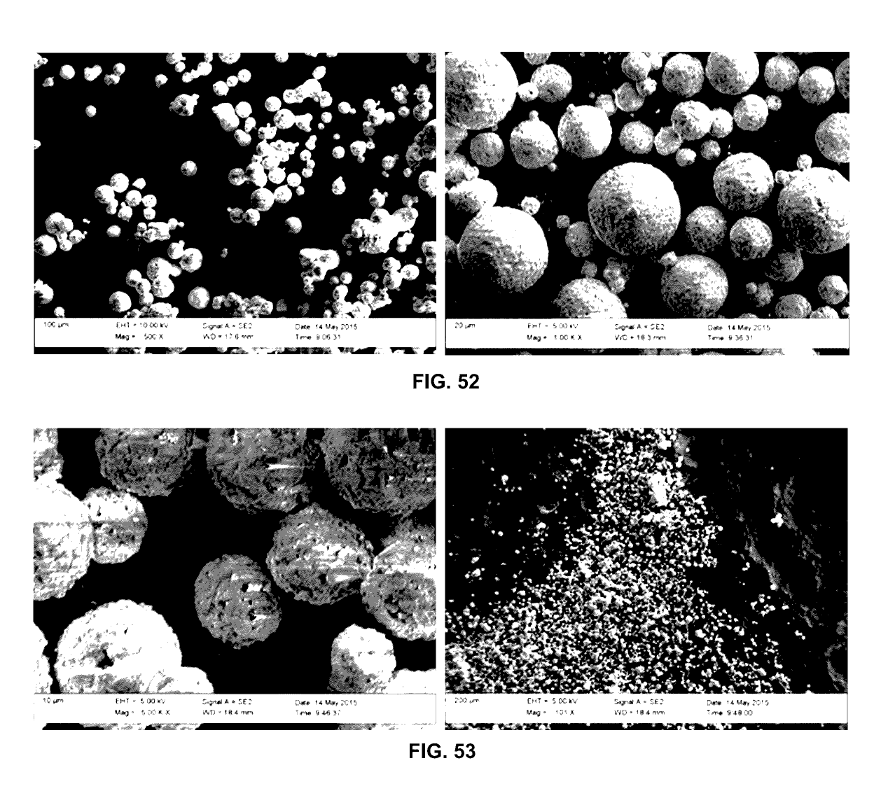

A variety of morphologies can be achieved using spray drying, though generally the most desirable structures will be spherical or proximately spherical. The advantages of spherical powder are flowability and ease of handling, as well as making it more challenging for global densification during post-processing. A range of fine particle sizes of Al₂O₃—SiO₂, FIG. 52 (left panel), demonstrates the effective size distribution and nature of the process, with particles ranging from ˜10-50 μm. A similar composition, FIG. 52 (right panel), illustrates the porous nature of the spray-dried particle, with differing pore sizes, seen as the dark surface spots, and shapes. This may be due to the non-spherical feedstock material and packing factors experienced. Point contact between non-spherical powder feedstock enhance surface diffusion during densification and can provide greater densification at lower processing temperatures, thereby reducing cost. Higher magnification images of as-sprayed porosity, FIG. 53 (left panel), further highlights the nature of particle adhesion, with angular constituent feedstock particles more readily visible. During processing, there is some finite risk of particle adhesion, beyond weak electrostatic or frictional forces, which can result in particle agglomeration, FIG. 53 (right panel).

Coarse starting particles, or vastly differing starting materials can result in non-spherical shapes. These non-spherical particles can generally be utilized with appropriate densification, to prevent insufficient strengths. If the concern is too significant, since the particles are only bound frictionally, electrostatically or by van der Waal's forces, they can be re-milled and re-inserted into the processing stream with minimal additional effort.

Additionally, post-processing of the particles can result in spherical, densified materials with unique microstructures. This can be accomplished either through heat-treatment or plasma spraying, to provide partial densification or full densification.

### Example 11

### Melt-Based Bead Formation

This example provides further details beyond Example 1 above of a method for formation of proppant beads and/or proppant bead precursors by a melting process. Proppant beads were formed directly from “waste stream” materials (slag and mixtures with fly-ash, aluminum dross and SiAlON) via melting in a graphite crucible under nitrogen cover gas using and RF induction coil. Powders were first mixed via ball milling (15 min-120 min) followed by RF melting for bead formation.

Melting was carried out in a graphite crucible with ˜1.5 mm diameter round bottom holes machined. Powder loads were filled in the holes, and these powder loads may represent a bead precursor. The powder mass was calculated/varied to achieve target bead diameters in the 0.5-1.5 mm range. Melting temperatures were in the 1200° C. to 1600° C. range. FIG. 8A shows a photograph of the graphite crucible before melting. FIG. 8B shows a photograph of the graphite crucible after melting. FIG. 9A shows a close up of a single bead.

The beads appear to be non-reactive with graphite with sphere formation occurring while molten due to surface tension of the melt and poor wetting on the graphite crucible material.

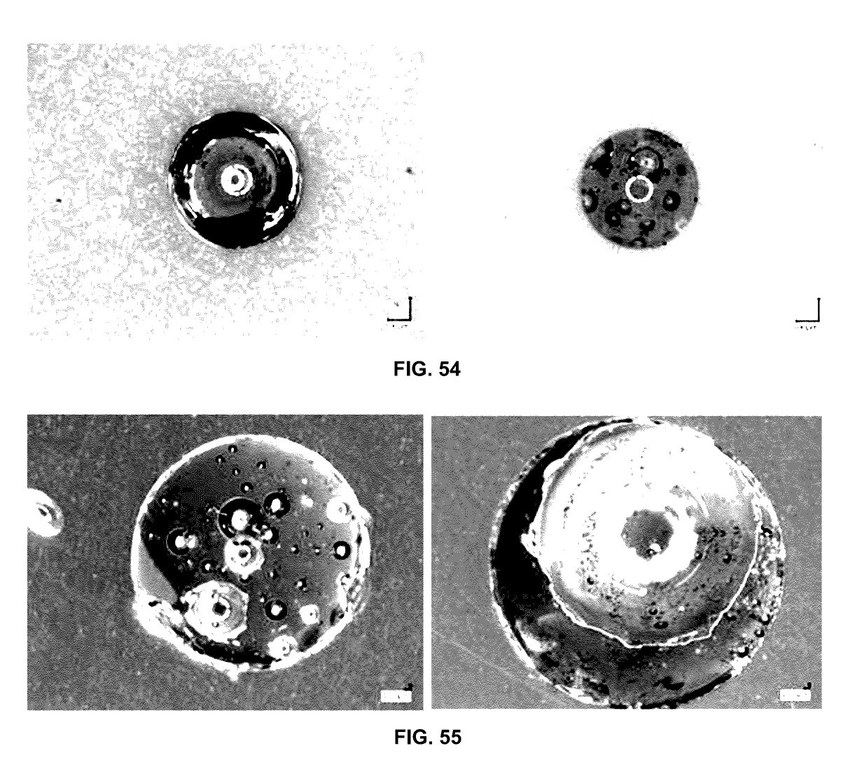

It was found that hollow and porous beads could be produced by mixing small amounts fly ash (up to 5% by mass) with the steel blast furnace slag. Melting under N₂ yielded a higher percentage of hollow beads while melting under rough vacuum yielded a higher percentage of distributed pore beads. However, dense, hollow and distributed pore beads were observed in both N₂ and vacuum type melting runs. Densities as low as 1.6 g/cm³ were observed. Macro and cross-section images are shown of beads with hollow and distributed pore type geometries in FIG. 54 and FIG. 55.

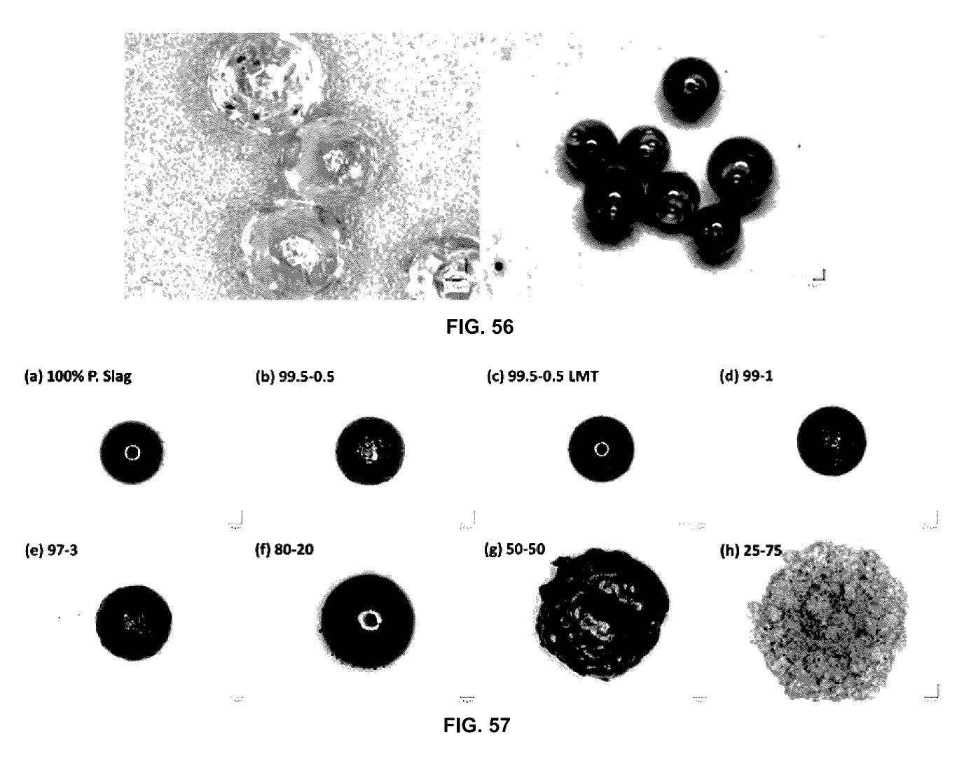

A phenolic resin process was also developed for coating melt beads. Diametral strength enhancements of over 80% were observed for phenolic coated melt beads. The strength enhancements are discussed in detail below. Photographs of uncoated and coated beads are shown in FIG. 56.

For the coated and uncoated beads, the apparent densities, the average strengths, and the sphericities were measured and compared with measured values for commercial ceramic proppant and commercial white sand. For the uncoated beads, the apparent density was 2.6 g/cm³, the average strength was 158 MPa (about 23,000 psi), and the sphericity was greater than 0.95. For the coated beads, the apparent density was 2.6 g/cm³, the average strength was 313 MPa (about 45,396 psi), and the sphericity was greater than 0.95. The commercial ceramic proppant had an apparent density of 2.7 g/cm³, an average strength of 112 MPa (about 16,200 psi), and a sphericity of about 0.9. The commercial white sand had an apparent density of 2.7 g/cm³, an average strength of 92 MPa (about 13,300 psi), and a sphericity of about 0.7. It will be appreciated that the phenolic coated beads exhibited a dramatic increase in strength.

FIG. 57 exhibits a macro comparison of the slag/SiAlON compositions that were tested, ranging from (Panel a) pure pelletized slag to (Panel h) 25% slag/75% SiAlON. Round and spherical beads were readily formed with SiAlON powder additions of up to 20% in pelletized slag.

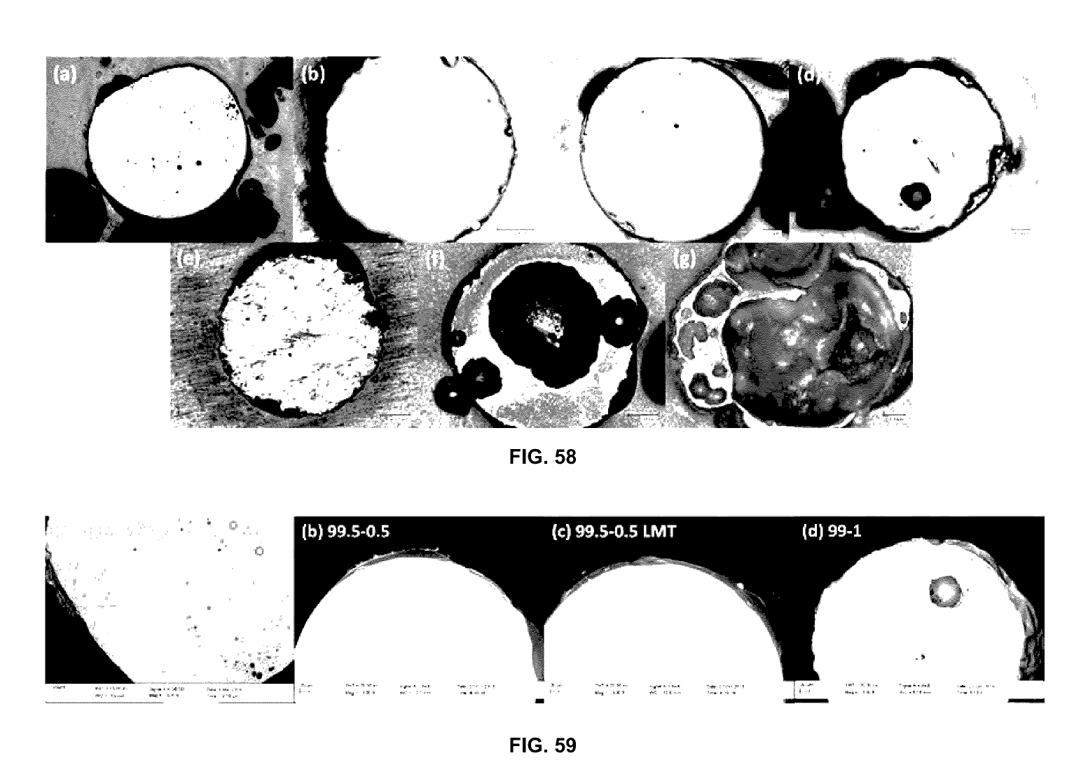

Cross-sectional optical (FIG. 58) and SEM (FIG. 59) micrographs are shown for some selected slag/SiAlON composite beads. Note the formation of hollow type bead geometry (FIG. 58, panel f) and evidence of possible bead crystallization (FIG. 59, panel d) due to composite additions.

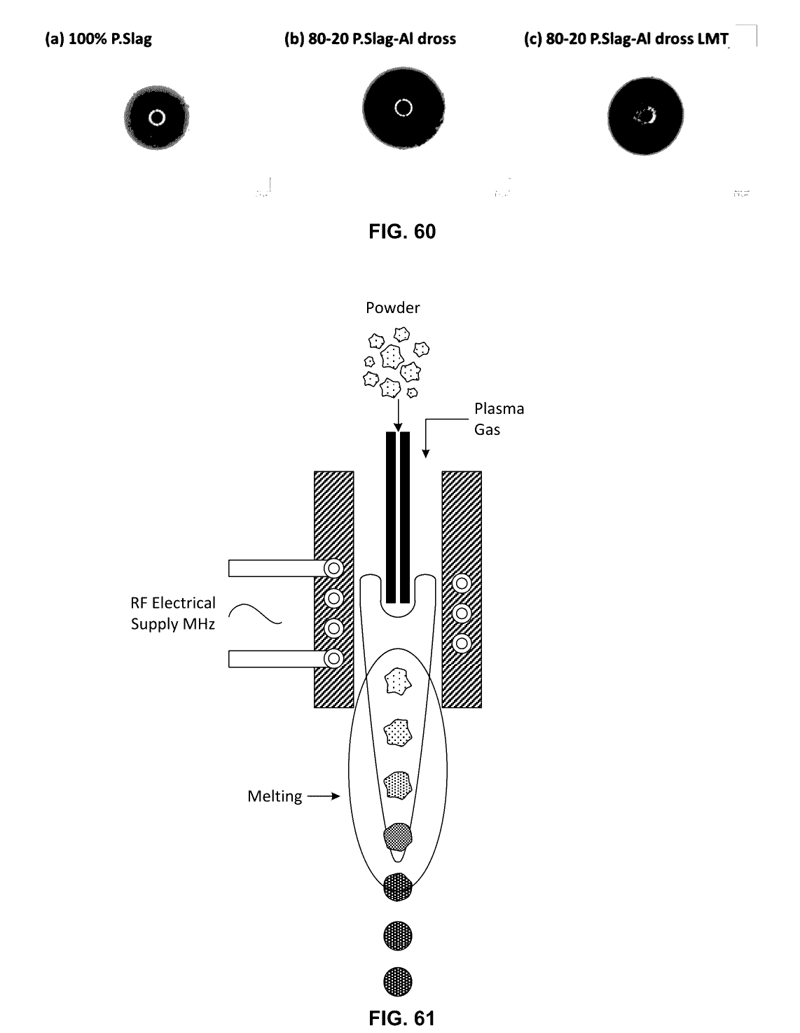

Macro photographs of pelletized slag and Al dross composite beads are shown in FIG. 60. Highly spherical and round bead formation was achieved with aluminum dross additions of 20% and 80% (balance slag).

### Example 12

### Scale Up of Melt-Based Bead Formation Via Plasma Spheroidization

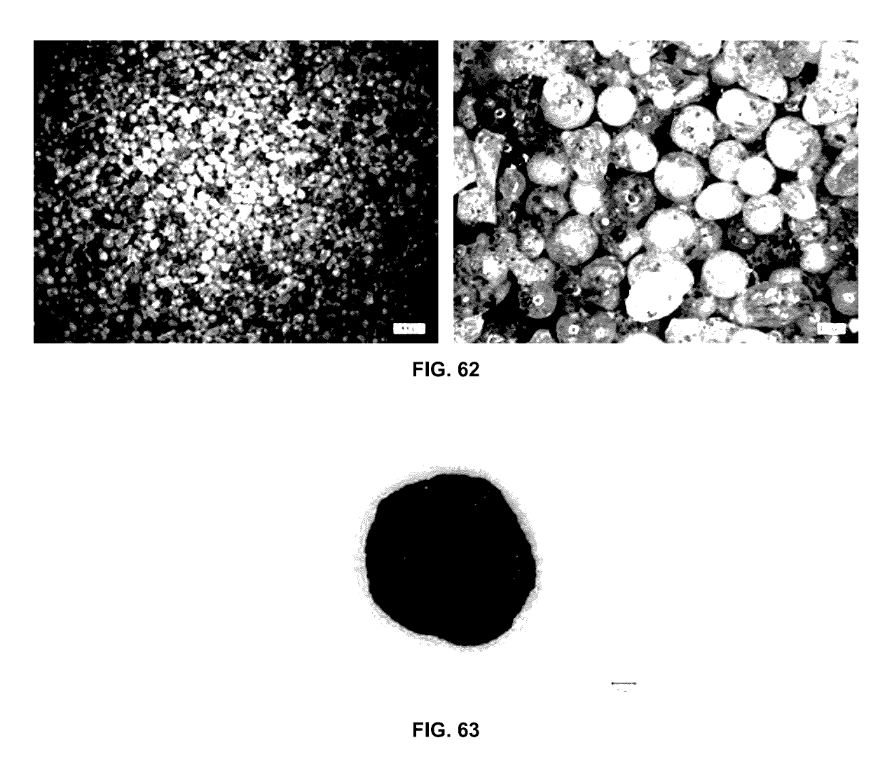

This example details a method for formation of proppant beads using a plasma spheroidization process. Plasma spheroidization scale up experiments were carried out for several different waste stream material combinations as summarized in Table 10. A schematic illustration of the plasma type spheroidization process and device is shown in FIG. 61. Slag materials were crushed and seived in the 300 to 700 μm range in preperation for plasma processing. In general, plasma spheroidization of all the materials appeared to be feasible. Spheroidization rates were highest for the granulated slag and Calumite air cooled (roughly 80% spheroidization). Macro images of spheroidized slag beads are shown in FIG. 62. Initial results indicated that highly round and spherical beads were formed similar to those produced via RF melting.

TABLE 10
Waste stream materials used in plasma spheroidization processing.

| | | Quantity |
|---|---|---|
| Material | Composition | (grams) |
| ACT 7 | 80/20 slag/fly ash, sodium silicate binder | 47 |
| ACT 12 | Fly ash, sodium silicate binder | 93 |
| ACT 16 | 20/80 slag/fly ash | 70 |
| ACT 17 | 20/80 slag/fly ash with walnut shell | 65 |
| ACT 19 | Fly ash, dross, carbon black | 50 |
| ACT 20 | 80/20 slag/fly ash, sodium silicate binder | 109 |
| ACT 32 | 80/20 slag/fly ash, carbon black | 27 |
| G. Slag | Crushed slag | 500 |
| Calumite A.C. | Crushed slag | — |
| Slag | | |

### Example 13

### Bead Formation Via Granulation

This example details a method for formation of proppant beads using a granulation process. A granulation process was developed using a cellulose type binder (1-2%) with combinations of slag, fly-ash, Al dross, carbon black and walnut shell powders. Beads were subsequently fired in nitrogen at 1450° C. for 2-8 hrs followed by chemical and mechanical characterization.

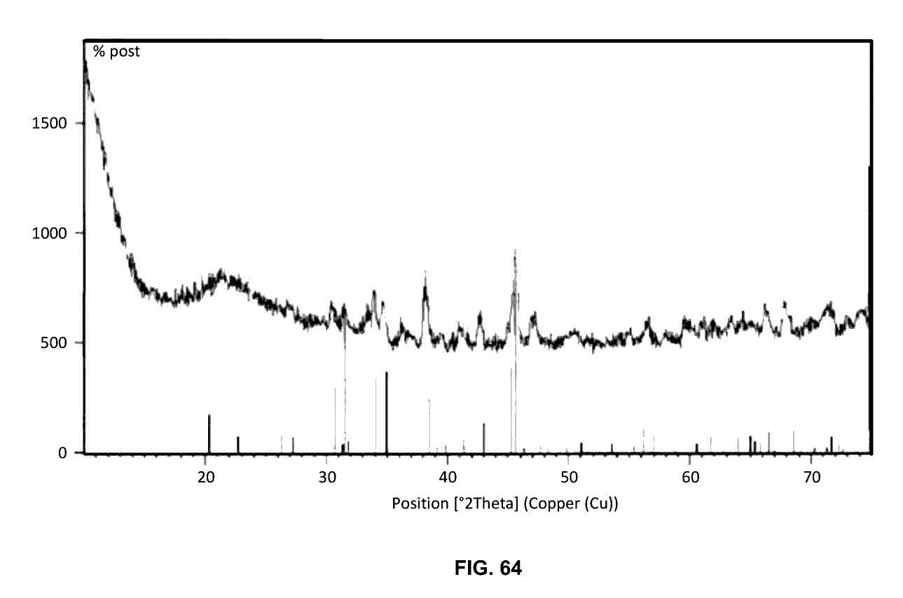

Preliminary findings indicate Ca—SiAlON formation with certain mixtures of high Ca containing fly ash+Carbon black. Beads were prepared by first ball milling of high Ca containing fly ash+Carbon black powders for 2 hours (400 rpm and 5/1 ball to powder mass ratio). Next, the ball milled powders were mixed with the polymer binder solution and granulated into beads in a food processor. These beads were fired at 1450° C. and preliminary diametral strength measurements indicate strength and density characteristics similar to Carbo Ceramics Econoprop proppants. FIG. 63 shows a macro image of a granulated and sintered bead and FIG. 64 shows the corresponding XRD diffractogram, indicating presence of CA-SiAlON.

### Example 14

### Characterization of Bulk Materials and Proppant Beads

This Example contains a summary of mechanical property, density, and chemical stability characterization results for different proppant materials at the bulk and bead level.

The materials systems covered are as follows:
Slag, fly ash, SiAlON, and Al dross based melt beads
Granulated beads
Commercially produced SiAlON
Synthesized MgSiN₂ (from pure pre-cursers)

In addition, glass beads and Carbo Ceramics Econoprop beads (also referred to as “ECP” or “commercial ceramic proppant” in this Example) were evaluated to serve as a baseline for relative comparison with our candidate materials.

Strength—Bulk Level.

The flexural strengths of SiAlON and MgSiN₂ were measured using a ring-on-ring (ROR) equibiaxial type flexural test. The ˜100% dense SiAlON test coupons were machined from commercially procured rod stock and lapped down to the appropriate dimensions and surface finish. SiAlON samples at two reduced densities (˜2 g/cm³ and ˜2.5 g/cm³) were produced via hot pressing of commercially procured SiAlON powders. The MgSiN₂ material was synthesized in powder form from “pure” pre-cursors and hot pressed into rods which were then machined and lapped to the appropriate thickness and surface finish for testing. The ROR tests were conducted in accordance with the ASTM test standard C1499. The test specimens were ˜12.7 mm in diameter and 1 mm thick. The load at failure was measured using an Instron mechanical testing machine and the material strength was calculated using the following equation:

$${σ}_{f} = \frac{3 F}{2 π {h}^{2}} [ ( 1 - v ) \frac{{D}_{S}^{2} - {D}_{L}^{2}}{2 {D}^{2}} + ( 1 - v ) ln \frac{{D}_{S}}{{D}_{L}} ]$$

where F is the failure load, ν is Poisson's ratio, Dₛ is the support ring diameter, D_{L} is the load ring diameter and h is the specimen thickness.

The average strength values for the SiAlON and MgSiN₂ materials are reported in Table 11.

TABLE 11
Ring-on-ring (ROR) equibiaxial strength
for SiAlON and MgSiN₂ bulk materials.

| | | Den- | Avg. | Stan- | Coeffi- | Predicted |
|---|---|---|---|---|---|---|
| | # | sity | ROR | dard | cient of | Fracture |
| | Test | (g/ | strength | Devi- | Variation | pressure |
| Material | coupons | cm³) | (MPa) | ation | (%) | (ksi) |
| 100% dense | 10 | 3.2 | 502 | 58 | 11.5 | 85 |
| SiAlON | | | | | | |
| 80% dense | 10 | 2.6 | 188 | 23.5 | 12.5 | 30 |
| SiAlON | | | | | | |
| 61% dense | 10 | 1.0 | 29 | 2.2 | 8 | 5 |
| SiAlON | | | | | | |
| MgSiN₂ | 9 | 3.0 | 278 | 45 | 16 | 16 |

The decrease in strength with the reduction in density for the SiAlON samples correlates well with analytical models at the 100% to 80% density level. However, the measured strength for the 61% dense SiAlON samples was ˜70% lower than the calculated value using the same model. This may be attributed to poor sintering of the samples or discrepancy of the model for strength prediction at higher porosity levels (approaching 50%).

Strength—Bead Level.

The diametral tensile strengths of melt processed slag and fly ash beads, commercial glass beads (both un-coated & phenolic resin coated) and commercial ceramic proppant were measured by compressing individual beads between two hardened steel platens and measuring the load at failure. The tensile strength of the material can be approximated using σ=2.8P÷πd², where σ is the diametral tensile strength, P is the failure load and d is the bead diameter.

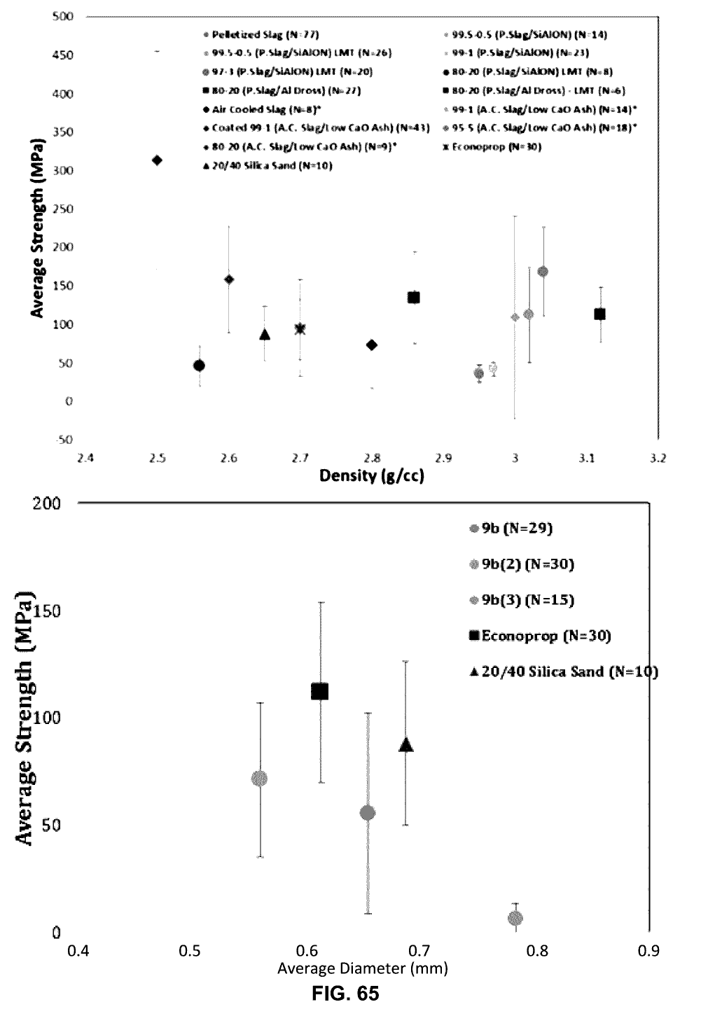

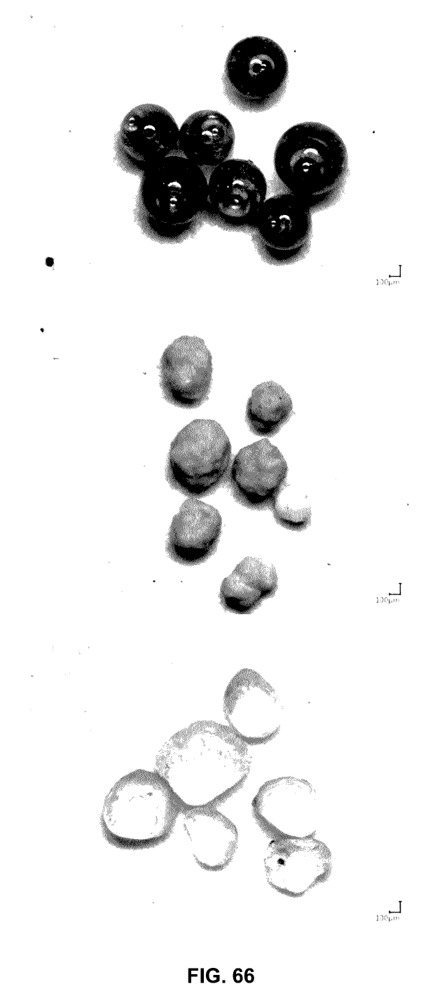

Diametral test data are summarized in Tables 12-14 and shown in FIG. 65. Due to the brittle nature of ceramic materials and inherent scatter in the data, Weibull statistical analysis was completed and the resulting characteristic strengths are provided in Tables 12-14. The feasibility of high speed video capture of bead failure during testing was also explored as method to gain some insight into the nature of the bead fracture and the generation of bead fragments (fines generated during bead crushing) and possible correlation to the pack crush behavior of the these materials. High speed video capture of example bead test was performed at frame rates in the 5000 frames per second to 20000 frames per second range.

TABLE 12
Test summary table including diametral strengths for A.C. slag and low CaO fly ash combinations.

| | 80/20 | 95/5 | 96/4 | 97/3 | 98/2 | 99/1 | Resin Coated | 100% A.C. |
|---|---|---|---|---|---|---|---|---|
| | JPL | JPL | JPL | JPL | JPL | JPL | 99/1 JPL | Slag JPL |
| # of beads | 9 | 18 | 16 | 16 | 17 | 14 | 43 | 8 |
| tested | | | | | | | | |
| Average | 158 | 95 | 55 | 54 | 78 | 109 | 313 | 73 |
| Strength | | | | | | | | |
| (MPa) | | | | | | | | |
| S.D. | 69 | 63 | 77 | 73 | 78 | 132 | 142 | 56 |
| C.V. (%) | 44 | 66 | 140 | 134 | 100 | 121 | 45 | 76 |
| Weibull | 1.6 | 1.5 | 0.9 | 0.9 | 0.9 | 0.6 | 0.6 | 0.83 |
| Modulus | | | | | | | | |
| Characteristic | 188 | 108 | 49 | 49 | 79 | 90 | 511 | 85 |
| Strength | | | | | | | | |
| (MPa) | | | | | | | | |
| Average | 0.55 | 0.56 | 0.59 | 0.56 | 0.58 | 0.54 | 0.51 | 0.57 |
| Diameter | | | | | | | | |
| (mm) | | | | | | | | |
| Diameter | 0.38-0.63 | 0.48-0.69 | 0.45-0.71 | 0.46-0.67 | 0.43-0.67 | 0.36-0.76 | 0.38-0.69 | 0.52-0.61 |
| Range (mm) | | | | | | | | |
| Density | ~2.6 | ~2.7 | ~2.2 | ~2.2 | ~2.2 | ~3.0 | ~2.5 | ~2.8 |
| (g/cm³) | | | | | | | | |

TABLE 13
Test summary table including diametral strengths for pelletized slag and SiAlON/Al dross/low CaO fly ash combinations.

| | 80/20 | 80/20 | 97/3 | 99/1 | 99/1 | LMT 99.5/0.5 | 99.5/0.5 | | |
|---|---|---|---|---|---|---|---|---|---|
| | Pellet. | Pell. Slag/ | Pell. Slag/ | Pell. Slag/ | Pell. Slag/ | Pell. Slag/ | Pell. Slag/ | 100% | Coated 100% |
| | Slag/Al | SiAlON | SiAlON | Low CaO | SiAlON | SiAlON | SiAlON | Pell. Slag | Pell. Slag |
| | Dross | JPL | JPL | Ash JPL | JPL | JPL | JPL | JPL | JPL |
| # of beads | 36 | 8 | 26 | 22 | 22 | 26 | 14 | 76 | 15 |
| tested | | | | | | | | | |
| Average | 130 | 45 | 35 | 62 | 43 | 112 | 36 | 169 | 236 |
| Strength | | | | | | | | | |
| (MPa) | | | | | | | | | |
| S.D. | 57 | 27 | 12 | 39 | 10 | 62 | 11 | 74 | 58 |
| C.V. (%) | 44 | 59 | 33 | 63 | 23 | 55 | 31 | 44 | 45 |
| Weibull | 2.1 | 1.5 | 2.3 | 1.7 | 4.5 | 1.7 | 3.6 | 2.2 | 3.1 |
| Modulus | | | | | | | | | |
| Character. | 149 | 52 | 41 | 69 | 46 | 115 | 40 | 274 | 269 |
| Strength | | | | | | | | | |
| (MPa) | | | | | | | | | |
| Average | 0.54 | 0.66 | 0.52 | 0.59 | 0.56 | 0.55 | 0.55 | 0.54 | 0.56 |
| Diameter | | | | | | | | | |
| (mm) | | | | | | | | | |
| Diameter | 0.39-0.64 | 0.60-0.74 | 0.39-0.59 | 0.54-0.69 | 0.42-0.65 | 0.49-0.60 | 0.52-0.61 | 0.42-0.71 | 0.47-0.64 |
| Range (mm) | | | | | | | | | |
| Density | ~2.9 | ~2.6 | ~2.9 | ~2.7 | ~3.0 | ~3.0 | ~2.9 | ~3.0 | — |
| (g/cm³) | | | | | | | | | |

TABLE 14
Test summary table including diametral strengths
for commercial proppants or glass beads.

| | | | | | Com- |
|---|---|---|---|---|---|
| | | | | | mercial |
| | Com- | Com- | Com- | Com- | Andrew's |
| | mercial | mercial | mercial | mercial | Glass |
| | Silica | Ceramic | Glass | Andrew's | Beads |
| | Sand | Proppant | Beads | Glass | with resin |
| | (20/40) | (20/40) | (~0.5 mm) | Beads | coating |
| # of beads | 10 | 30 | 30 | 30 | 30 |
| tested | | | | | |
| Average | 88 | 112 | 217 | 338 | 400 |
| Strength | | | | | |
| (MPa) | | | | | |
| S.D. | 38 | 42 | 27 | 93 | 116 |
| C.V. (%) | 43 | 38 | 12 | 28 | 29 |
| Weibull | 2.5 | 2.9 | 9.3 | 4.1 | 3.7 |
| Modulus | | | | | |
| Charac- | 96.4 | 126 | 229 | 372 | 444 |
| teristic | | | | | |
| Strength | | | | | |
| (MPa) | | | | | |
| Average | 0.69 | 0.68 | 0.56 | 0.56 | 0.54 |
| Diameter | | | | | |
| (mm) | | | | | |
| Diameter | 0.61-0.82 | 0.63-0.72 | 0.48-0.66 | 0.46-0.66 | 0.41-0.66 |
| Range (mm) | | | | | |
| Density | — | ~2.7 | — | — | — |
| (g/cm³) | | | | | |

Various findings from the diametral testing include:
On average, direct melt synthesized beads (80/20 and 100 pelletized) are 15-20% stronger than the commercial ceramic proppant beads. The direct melt beads may be further optimized for strength.
Also, the melt beads can be processed to obtain different average densities in the 1.8-3.0 g/cm³ range. In comparison, the commercial ceramic proppant has a density of ˜2.7 g/cm³.
The phenolic resin coating of beads appears to increase strength:
   Up to 20% in the case of the glass beads
   Up to 79% in the case of the 100% pelletized slag beads
   Up to 187% in the case of 99-1 (Air Cooled Slag/Fly ash) beads
In general, smaller diameter beads are stronger than larger diameter beads of the same composition. This can be explained by flaw probability/Weibull theory.
High speed video fractography can be a useful technique to gain insight into the nature of bead failure and fines production and aid in materials selection for proppant materials.
   Findings indicate that high strength beads containing Ca—SiAlON can be achieved via optimization of granulation and sintering. Strengths and densities comparable to Carbo Ceramic Econoprop proppants are observed.

Macrophotography & Microscopy.

In addition to diametral strength testing, macrophotography, optical microscopy, and scanning electron microscopy were used to characterize bead sphericity & roundness as well as internal geometry (i.e., internal porosity). FIG. 66 shows a macro-photograph comparison of 95/5 beads of Air cooled Slag/low CaO fly ash (top), commercial ceramic proppant (center), and commercial silica sand (bottom). The melt beads appear to be highly spherical and round as compared to the commercial proppant materials. The bead sphericity and roundness can be quantified using the Krumbien/Sloss chart, where it is apparent that the beads fall into the (0.9, 0.9) region, while the commercial proppants generally were in the (0.7, 0.9) or (0.9, 0.7) regions. This increased sphericity could facilitate improved flow of proppants in carrier fluids used in stimulating natural fractures.

Measurements of the apparent densities, average diametral strengths, and sphericity for different materials were obtained. For the ceramic beads formed using the melt forming method described herein, the apparent density was 2.6 g/cm³, the average strength was 158 MPa (or about 23,000 psi), and the sphericity was greater than 0.95. For the commercial ceramic proppant, the apparent density was 2.7 g/cm³, the average strength was 112 MPa (or about 16,200 psi), and the sphericity was about 0.9. For the commercial white sand, the apparent density was 2.7 g/cm³, the average strength was 92 MPa (or about 13,300 psi), and the sphericity was about 0.7.

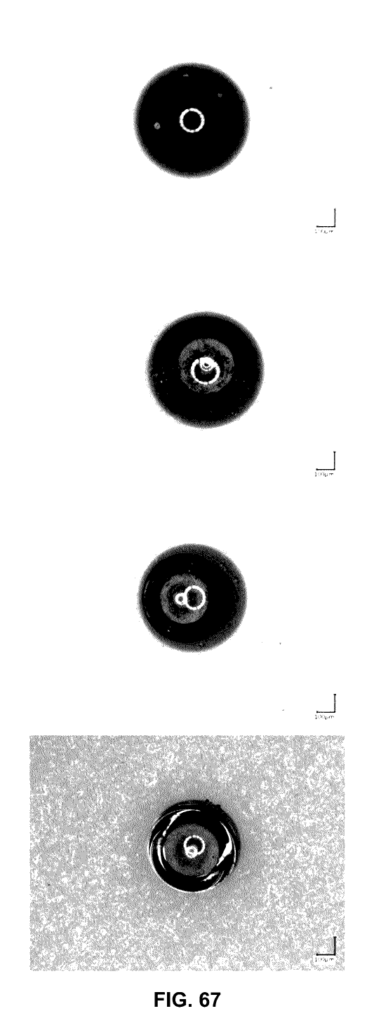

Porosities of the ceramic beads was modified densities and diametral strengths were measure. FIG. 67 shows a macro-photograph comparison of four different beads with different porosities. From top to bottom in FIG. 67, the measured apparent densities of the beads was 2.6 g/cm³, 2.3 g/cm³, 2.2 g/cm³, and 1.8 g/cm³. For the beads with a density of 2.6 g/cm³, the measured average strength of the beads was 158 MPa (about 23,000 psi). The average strength of beads with a density of 2.0 g/cm³ was observed to be 97 MPa (about 14,000 psi). While these beads had a diametral strength comparable to the commercial ceramic proppant and the commercial white sand, they are significantly lighter than these commercial materials.

Cross sectional microscopy was also used to characterize the beads to correlate the bead diametral strengths and densities with their respective microstructures. In general, beads with a large central pore (FIG. 55) had reduced diametral strengths. In many cases the large pore is offset (not concentric within the bead) resulting in a very thin wall section and decreased diametral strengths. FIG. 55 also shows several pores of various sizes distributed across the cross-section. It is thus possible to produce solid, hollow and porous beads using the melt process, pointing to its versatility.

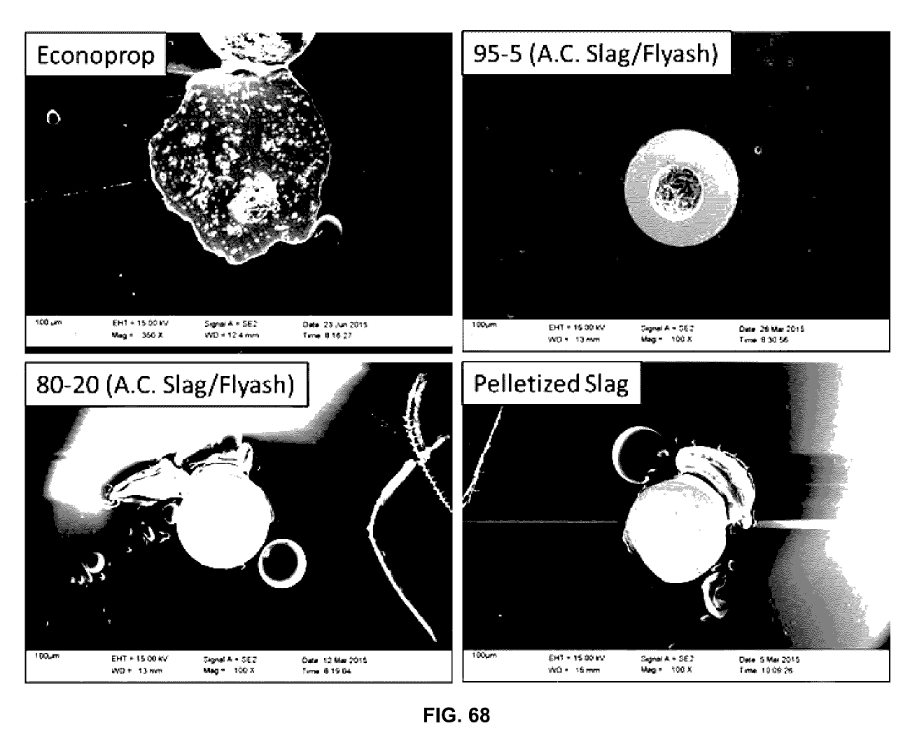

FIG. 68 displays scanning electron images of the cross-sections of the commercial ceramic proppant (top left panel) and that of melt processed beads. From this figure, the smooth outer surfaces of the melt processed beads are apparent. In addition, differences in the pore structure are visible, e.g., the commercial ceramic proppant has a porous interior, while the melt processed beads shown here appear to be hollow (top right panel) or solid (bottom left panel and bottom right panel).

Table 15 shows the Energy Dispersive Spectroscopy (EDS) analysis of the JPL beads in comparison to a commercial proppant (Econoprop). It can be seen that there was very little difference in atomic composition in the beads, despite using different ratios and/or types of slag and fly ash powder. These beads were mainly comprised of O, Si, Ca, Al, and Mg. The commercial ceramic proppant on the other hand, seemed to consist of mainly O, Si, & Al and in larger atomic %.

TABLE 15
EDS Analysis of JPL beads in comparison
to commercial ceramic proppant

| | Atomic % | | | |
|---|---|---|---|---|
| | | 95/5 (A.C. Slag/ | 80/20 (A.C. Slag/ | Pelletized |
| Element | Econoprop | Fly Ash) | Fly Ash) | Slag |
| O | 64 | 58 | 58 | 58 |
| Si | 18 | 15 | 16 | 14 |
| Ca | — | 15 | 13 | 15 |
| Al | 18 | 5 | 6 | 5 |
| Mg | — | 6 | 5 | 6 |

Various findings from the diametral testing include:
Formed beads are rounder and more spherical than the commercial proppants
Beads that tend to form large pores have a decrease their densities but also their diametral strengths
EDS analysis showed that the bead atomic compositions did not vary with the different slag to fly ash ratios

Density Characterization.

Density characterization measurements were made at JPL using geometric means as well as via liquid pycnometry. The test methods have been setup using the ISO 13503-2 specification as a guide; however, other specifications (ASTM) have been consulted and used in conjunction with the ISO standard to develop liquid pycnometry methods. In addition, a PO was set up with Micrometrics for ISO standard gas pycnometry measurements of samples. The three different types of density are bulk, apparent, and absolute density:
Bulk density is the density of proppant pack, including the proppants and interstitial spaces between each proppant in the pack. The bulk density is measured using a custom apparatus described in the ISO (ISO 13503-2 2006).
The apparent density is the relative density of the individual proppants including any enclosed porosity in the proppant bead. The apparent density is measured using a liquid pycnometer.
The absolute density is the density of individual proppant excluding most porosity. The absolute density is measured using a gas pycnometer.

Apparent Density.

Apparent density measurements were completed using a 50 mL capacity liquid pycnometer. The in-house procedure follows ISO 13503 to determine the apparent density of proppants. The density determination using the pycnometer is calculated using

$${ρ}_{p} = {ρ}_{l} \frac{{m}_{p}}{{m}_{l} + {m}_{p} - {m}_{p + l}} ,$$

where ρₚ and ρₗ are the density of the powder and testing liquid (in this case deionized water), respectively, mₚ is the mass of the powder sample, mₗ is the mass of the liquid, and mₚ₊ₗ is the mass of the powder and liquid.

The procedure and system were investigated to limit possible points of errors. The error in the liquid density was found to be ˜0.0003 g/cm³, which corresponds to a value of a false readout of a thermometer of 0.1° C. and error in mass measurement given by the manufacturers of the electronic balance, i.e., 0.003 g. As such, the total relative error calculated to be less than 0.1% for a 10 gram charge for the 50 mL pycnometer. As the sample mass increases, the relative error decreases.

To calibrate the liquid pycnometer, the apparent density of Econoprop 30/50 was measured five different times. The measured average apparent density was 2.62±0.06 g/cm³. The measured apparent density was similar to the reported apparent density of 2.7 g/cm³ for the commercial ceramic proppant 30/50. In addition, a sample of the commercial ceramic proppant was sent for absolute density characterization which was also found to be in good agreement with the measured value.

Chemical Stability.

An acid solubility test setup was developed to perform preliminary acid solubility testing on different proppant materials. The test procedure closely follows the prescribed method in the ISO 13503-2 standard for quantifying the percent dissolution of proppant material after exposure to acidic solution. In addition, elemental compositional analysis was completed using an x-ray microscope on samples before and after testing to gain insight to the dissolved material chemistry.

Acid solubility testing was performed on SiAlON (unpolished bulk discs ˜1 mm thick and 12.7 mm in diameter), Carbo Ceramics Econoprop (ECP) 30/50 mesh beads, and 30-40 mesh glass beads.

Acid solubility (amount removed/dissolved), expressed in percent of the base material was as follows:
SiAlON disks:

$$S = \frac{( 5.0543 + 23.6921 - 28.7429 )}{5.0543} * 100 \% = 0.0692 \%$$

ECP 30/50 Ceramic:

$$S = \frac{( 5.0013 + 22.5434 - 27.4086 )}{5.0013} * 100 \% = 2.721 \%$$

30-40 Mesh Glass Beads:

$$S = \frac{( 4.9840 + 21.8666 - 26.5062 )}{4.9840} * 100 \% = 6.910 \%$$

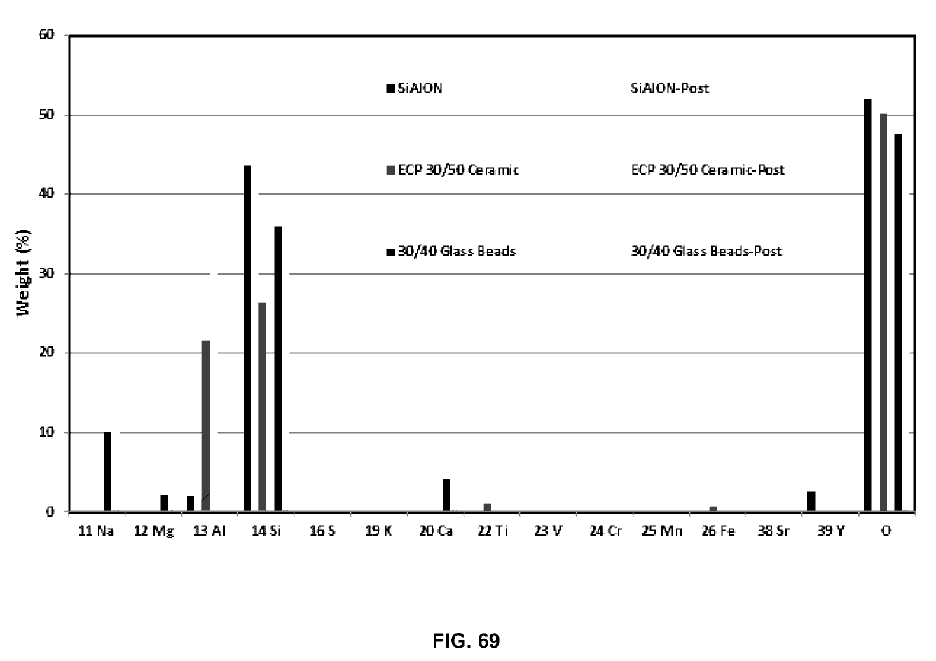

Pre- and post-exposure XRF was performed on each of the samples. Results are summarized in FIG. 69.

The XRF results suggest that the glass beads were etched fairly uniformly while the commercial ceramic proppant appeared to have selectively lost the Si (or most likely SiO₂). The SiAlON had negligible material dissolution (˜0.07% loss) and, therefore, the before and after XRF results are very similar. This points to the stability of this material in fluids used to stimulate wells.

In addition, a preliminary acid solubility tests were carried out on MgSiN₂ granules and pelletized slag melt beads (reduced sample size). An acid solubility of 27% was observed for the MgSiN₂ and an acid solubility of 90% was observed for the pelletized slag beads. Proppants of these compositions would require a coating or other means for corrosion protection.

Bead Characterization Summary.
ROR flexural strengths were measured for commercial SiAlON and synthesized MgSiN₂ disks resulting in values of about 500 MPa and 280 MPa respectively.
The diametral strengths of several different types of direct melt beads and commercial ceramic proppant beads was characterized. In general, the melt processed beads have higher strengths for comparable densities of the commercially available ceramic proppant.
Melt beads of reduced densities (as low as 1.6 g/cm³) have been produced. Some beads are lower in strength than the ones comparable to commercially available ceramic beads; however, the versatility of the process has been demonstrated.
Phenolic coatings have consistently resulted in improved strength values of proppant beads.
ISO density measurement standards have been carefully examined The procedure has been validated using commercial proppant material
Acid solubility test procedures and facilities have been setup and samples of glass beads, commercial ceramic beads and SiAlON disks have been characterized. The SiAlON material is more resistant to chemical attack than the commercial ceramic proppant and glass beads. However, pelletized slag and MgSiN₂ based proppants may benefit from a coating or other means for corrosion protection.

Although the foregoing invention has been described in some detail by way of illustration and example for purposes of clarity of understanding, one of skill in the art will appreciate that certain changes and modifications can be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method of preparing a plurality of ceramics bead comprising:
mixing a plurality of ceramic precursors to form a mixture comprising particles of the ceramic precursors having sizes of about 30 μm to about 500 wherein the ceramic precursors include two or more of fly ash, slag, carbon black, pumice, and aluminum dross;
forming a plurality of bead precursors each comprising the mixture, wherein the bead precursors each have cross-sectional dimensions of about 0.1 mm to about 2.5 mm; and
heating the bead precursors to a temperature of greater than about 1200° C. to initiate a chemical reaction between the ceramic precursors, wherein the chemical reaction transforms the bead precursors into ceramic beads, wherein the ceramic beads are each characterized by one or more of a diameter of about 0.03 mm to about 2.0 mm, diametral strengths greater than about 100 MPa, and a specific gravity of about 1.0 to about 3.0.

2. The method of claim 1, wherein the mixture comprises one or more of:
a suspension, an emulsion, or a slurry comprising the plurality of ceramic precursors suspended in a solvent;
homogenized ceramic precursors; or
ground or milled ceramic precursors.

3. The method of claim 1, wherein the mixture comprises slag and fly ash, wherein the slag comprises about 20% to about 99% of the mixture by weight, wherein the fly ash comprises 1-80% of the mixture by weight, wherein carbon black comprises 0% to about 30% of the mixture by weight, wherein pumice comprises 0% to about 50% of the mixture by weight, and wherein aluminum dross comprises 0% to about 30% of the mixture by weight.

4. The method of claim 1, wherein the mixture further comprises one or more of:
a binder, wherein the binder comprises one or more of a silicate binder or a polyvinyl alcohol (PVA) binder;
a reactive additive, wherein the reactive additive comprises one or more of AlN, Si₃N₄, or SiO₂;
cellulose;
a polymer; or
a solvent, wherein the solvent comprises one or more of water, methanol, or ethanol.

5. The method of claim 1, wherein forming the plurality of bead precursors comprises one or more of:
forming the particles of ceramic precursors in the mixture into aggregated particles by a granulation process, wherein the aggregated particles correspond to the bead precursors;
coating a plurality of organic scaffold beads with the mixture, wherein the organic scaffold beads comprise walnut shell or polystyrene beads;
depositing the mixture into a plurality of mold forms, wherein the mold forms comprise graphite, molybdenum, a non-reactive metal, or a non-reactive ceramic;
forming droplets from the mixture, wherein the mixture comprises a suspension, an emulsion, or a slurry comprising the ceramic precursors suspended in a solvent, and processing the droplets using a freeze drying process or a spray drying process, wherein freeze dried droplets or spray dried droplets correspond to the bead precursors; or
forming aggregates of the mixture in a plasma source, wherein the aggregates of the mixture correspond to the bead precursors.

6. The method of claim 1, wherein the bead precursors comprise about 20% to about 99% slag by weight, wherein the bead precursors comprise about 1 to about 80% fly ash by weight, wherein the bead precursors comprise 0 to about 50% organic materials by weight, and wherein the organic materials comprise one or more of cellulose, walnut shells, or polystyrene.

7. The method of claim 1, wherein the bead precursors comprise green bodies of the ceramic precursors; and wherein the ceramic precursors in the green bodies chemically react during the heating to form a ceramic material.

8. The method of claim 1, wherein heating the bead precursors comprises heating the bead precursors in a reactive atmosphere, wherein the reactive atmosphere comprises one or more of N₂, O₂, or CO₂, and wherein the chemical reaction forms one or more of a nitride-based ceramic, or an oxide-based ceramic from the ceramic precursors and the reactive atmosphere.

9. The method of claim 1, wherein heating the bead precursors includes:
heating the bead precursors to between about 1200° C. and about 1750° C.;
heating the bead precursors to between about 250° C. and about 350° C. prior to heating the bead precursors to greater than about 1200° C.;
sintering the bead precursors;
annealing the bead precursors;
melting the bead precursors; or
exposing the bead precursors to a heated plasma.

10. The method of claim 1, wherein heating the bead precursors above a melting temperature of the mixture generates molten beads that exhibits a surface tension sufficient to cause the molten beads to form into or take on spherical shapes.

11. The method of claim 1, wherein heating the bead precursors includes:
heating the bead precursors using an inductive heating technique;
heating the bead precursors using a conductive heating technique; or
heating the bead precursors using a radiative heating technique.

12. The method of claim 1, wherein the ceramic beads are further characterized by one or more of:
porosities of about 1% to about 99%;
hollow cores characterized by diameters of about 0.01 mm to about 1 mm;
sphericities of about 0.5 to about 1.0;
specific gravities of about 1.0 to about 1.5;
specific gravities of about 1.0 to about 2.0;
specific gravities of about 2.0 to about 2.5;
specific gravities of about 2.5 to about 3.0;
diametral strengths greater than about 150 MPa;
diametral strengths greater than about 200 MPa;
a uniform size distribution, wherein the uniform size distribution corresponds to a standard deviation of the diameters of the ceramic beads being less than 10% of an average or median diameter of the ceramic beads; or
a non-uniform size distribution.

13. The method of claim 1, wherein the ceramic beads comprise one or more of a SiAlON ceramic, an oxide ceramic, a nitride ceramic, or an oxynitride ceramic.

14. The method of claim 1, further comprising coating the ceramic beads with an organic coating to form a plurality of coated ceramic beads.

15. The method of claim 14, wherein the organic coating comprises a phenolic polymer or a polyurethane polymer.

16. The method of claim 14, wherein the plurality of coated ceramic beads are characterized by diametral strengths greater than about 150 MPa.

17. The method of claim 14, wherein the plurality of coated ceramic beads are characterized by diametral strengths greater than about 300 MPa.

18. The method of claim 1, further comprising passing portions of the ceramic beads through one or more sieves each characterized by a different mesh size to sort the ceramic beads by diameter.

19. The method of claim 18, wherein a first sieve of the one or more sieves has a mesh size of about 10 to about 100.

20. The method of claim 19, wherein a second sieve of the one or more sieves has a mesh size of about 20 to about 140.
